(19) United States
(12) Patent Application Publication
(10) Pub. No.: US 2026/0330496 A1
(43) Pub. Date: Oct. 22, 2026

(54) SYSTEM AND METHOD FOR CLOSED-LOOP BEHAVIORAL QUALIFICATION, COMPLIANCE GATING, AND ENGAGEMENT VERIFICATION IN DIGITAL MEDIA CAMPAIGNS

(71) Applicant: PETER MELI, BOCA RATON, FL (US)

(72) Inventor: PETER MELI, BOCA RATON, FL (US)

(21) Appl. No.: 19/438,443

(22) Filed: Dec. 31, 2025

Related U.S. Application Data
(60) Provisional application No. 63/792,381, filed on Apr. 22, 2025.
(60) Provisional application No. 63/818,574, filed on Jun. 5, 2025.

(51) Int. Cl. G06Q 30/0242; G06N 3/092; G06Q 30/0241; H04L 9/32

(52) U.S. Cl. CPC G06Q 30/0243; G06Q 30/0248; H04L 9/3247; G06N 3/092

(57) ABSTRACT

A closed-loop behavioral qualification and enforcement system for digital advertising which implements pre-spend waste prevention is disclosed. A pre-spend qualification engine computes behavioral qualification scores (BQS) from behavioral signals received from multiple sources. A compliance gateway implements non-bypassable enforcement, blocking unqualified requests before budget commitment or generating cryptographic authorization tokens for qualified requests. Engagement verification beacons capture post-activation interactions without cookies or personally identifiable information. A reconciliation engine performs signature-based reconciliation, while a feedback pipeline propagates qualified attribution scores (QAS) values and fraud detection outcomes back to BQS parameters, The BQS Unity Framework orchestrates all operations through a single unified metric rather than multiple independent variables. All enforcement decisions are recorded in an immutable ledger with append-only logs and cryptographic signatures enabling third-party validation. The system demonstrates technical scalability through certain aspects of embodiments of the present invention.

### CROSS-REFERENCE TO RELATED APPLICATIONS AND PRIORITY CLAIMS

This non-provisional patent application claims priority to, U.S. Provisional Patent Application Ser. No. 63/792,381 titled, “AVATAR-DRIVEN ADVERTISING & SPONSORSHIP SYSTEM”, filed Apr. 22, 2025 and U.S. Provisional Patent Application Ser. No. 63/818,574 titled, “SYSTEM AND METHOD FOR CLOSED-LOOP BEHAVIORAL QUALIFICATION AND ACTIVATION VERIFICATION OF DIGITAL MEDIA CAMPAIGNS”, filed Jun. 5, 2025. The entire disclosures of the aforementioned patent applications are incorporated by reference as if fully stated herein.

### FIELD OF THE INVENTION

The present invention relates generally to digital advertising verification systems that enforce compliance before budget commitment. More particularly, it pertains to closed-loop enforcement architectures that combine behavioral-signal analysis, cryptographic attestation, distributed-ledger recording, and recursive policy optimization to prevent advertising waste through pre-spend qualification rather than post-spend detection.

Aspects of embodiments of the present invention function as an integrated enforcement proxy operating within the digital advertising transaction workflow to govern bid authorization, behavioral verification, and continuous feedback optimization across demand-side platforms and programmatic advertising exchanges. The disclosed closed-loop enforcement architecture establishes a technical foundation for cryptographically-attested qualification, enforcement, and feedback mechanisms that extend the Behavioral Qualification Score (BQS) Unity Framework disclosed in related Parent application Ser. No. 19/404,365. In related future embodiments, the cryptographically-attested enforcement framework disclosed herein may be implemented among autonomous software agents operating under identical qualification-enforcement-feedback interdependencies, thereby supporting AI-driven attestation and adaptive-learning continuity.

### BACKGROUND OF THE INVENTION

The digital advertising industry faces a persistent and escalating waste problem. Industry estimates place annual global advertising waste-arising from fraud, bot traffic, viewability failures, brand safety violations, and misattributed conversions—at approximately $280 billion, representing roughly 35% of total digital advertising spend. This waste manifests in multiple forms:
Invalid Traffic (IVT): Sophisticated bot networks and automated scripts generate impressions and clicks that appear legitimate to traditional detection systems.
Viewability Fraud: Advertisements served in non-viewable placements, hidden iframes, or pixel-stuffed containers.
Domain Spoofing: Fraudulent publishers misrepresenting inventory sources to command premium pricing.
Attribution Gaming: Manipulation of conversion tracking through click injection, cookie stuffing, and last-click attribution abuse.
Brand Safety Violations: Advertisements appearing alongside objectionable content despite targeting safeguards.

### Limitations of Post-Spend Detection Systems

Current industry solutions—including those offered by Integral Ad Science (IAS), DoubleVerify, HUMAN Security (formerly White Ops), Pixalate, and TrafficGuard—operate primarily through post-spend detection and remediation. These systems share common architectural limitations:
Reactive Architecture: Fraud is detected after budget has been committed and impressions served, resulting in refund negotiations, credit disputes, and irrecoverable waste.
Centralized Rule Sets: Static heuristics and manually-tuned thresholds that cannot adapt to rapidly evolving fraud techniques.
Mutable Audit Trails: Detection results stored in traditional databases that can be modified or disputed, creating trust gaps between advertisers and verification providers.
Identity-Dependent Tracking: Reliance on cookies, device IDs, and cross-site tracking that conflicts with privacy regulations (GDPR, CCPA) and browser policies.
Isolated Feedback Loops: Post-campaign analysis feeds into future campaign planning but does not dynamically adjust qualification criteria during active campaigns.
The fundamental problem: By the time fraud is detected, money has already been spent. Advertisers may receive credits or refunds, but the opportunity cost-advertising budget that could have reached genuine audiences—is permanently lost.

### The Behavioral Qualification Gap

While post-spend detection systems identify fraudulent traffic after the fact, they fail to address a critical upstream question: How do we prevent unqualified traffic from entering the advertising ecosystem in the first place?

The related Parent application Ser. No. 19/404,365, titled, “HYBRID AI-DRIVEN ADVERTISING & SPONSORSHIP SYSTEM WITH REAL-TIME DECISIONING AND ENFORCEMENT ARCHITECTURE” (hereinafter, “the Omnibus Application”) discloses a Behavioral Qualification Score (BQS) computation engine that addresses this gap through multi-dimensional scoring of user cohorts based on loyalty signals, intent strength, contextual relevance, and fraud indicators. The BQS computation engine generates unified BQS scores that synthesize these factors into a single governing metric coordinated through the BQS Unity Framework.

However, the Omnibus Application's BQS framework, while solving the qualification problem through BQS computation, does not address the enforcement problem: How do we ensure that only qualified traffic—as determined by BQS scores—receives advertising budget allocation through compliance gateway enforcement? How do we create verifiable proof through cryptographic audit records that enforcement decisions were made correctly? How do we continuously improve qualification criteria based on verified outcomes through reconciliation engine feedback?

### The Need for Cryptographically-Attested Closed-Loop Enforcement

Accordingly, there remains a need for a system that:
Prevents Waste Before It Occurs: Blocks unqualified bid requests at the pre-auction stage through compliance gateway, before budget commitment, rather than detecting fraud after impressions are served.
Creates Immutable Audit Trails: Records enforcement decisions in append-only logs with tamper-evident hash-chain verification through immutable ledger that cannot be disputed or modified retroactively.
Operates Privacy-Natively: Functions without cookies, persistent identifiers, or personally identifiable information (PII) through behavioral fingerprints and privacy-preserving techniques, ensuring compliance with global privacy regulations enforced through consent module.
Adapts in Real-Time: Continuously refines qualification thresholds and enforcement criteria through feedback system based on verified post-engagement outcomes from reconciliation outputs, creating a closed-loop optimization system via BQS Unity Optimizer.
Provides Cryptographic Proof: Generates verifiable cryptographic authorization tokens through token generator using Ed25519 signing that prove each authorized transaction met qualification requirements at the time of enforcement.

Aspects of embodiments of the present invention address these needs through a cryptographically-attested closed-loop enforcement architecture that operationalizes the behavioral qualification scores generated by the Omnibus Application's BQS computation engine, creating a unified system wherein qualification, enforcement through compliance gateway, verification through reconciliation engine, and optimization through feedback system are functionally interdependent components coordinated by the BQS Unity Framework: pre-spend behavioral governance preventing advertising waste before budget commitment.

### SUMMARY OF THE INVENTION

The present invention provides a closed-loop behavioral qualification and enforcement system for digital advertising that prevents waste through pre-spend qualification via signature-based reconciliation engine, cryptographic attestation through token generator, immutable ledger recording, and recursive policy optimization via feedback system. The system operates as an enforcement proxy positioned between demand-side platforms and programmatic advertising exchanges, blocking unqualified bid requests before budget commitment while continuously refining enforcement criteria through reconciliation engine based on verified outcomes from reconciliation outputs.

The invention operationalizes the Behavioral Qualification Score (BQS) framework disclosed in the related Omnibus Application through cryptographically-attested closed-loop enforcement architecture that validates qualification predictions against actual engagement outcomes, creating functionally interdependent components coordinated by the BQS Unity Framework.

### Unified Scoring Governance Architecture

The invention operates through the BQS Unity Framework disclosed in the Omnibus Application, where all enforcement decisions are governed by unified BQS scores generated by pre-spend qualification engine that synthesize multi-dimensional signals into a single metric coordinated by BQS Unity Coordination Engine:

BQS=f(User engagement, Model efficiency, Enforcement strictness, Content relevance)×BQS Weighting Factors

This unified approach eliminates the complexity of managing multiple independent variables while maintaining sophisticated multi-dimensional optimization coordinated through BQS Unity Framework. The BQS scores are computed by the Omnibus Application's BQS computation engine and consumed by this present application's enforcement proxy and reconciliation engine, creating functional interdependence between the applications.

The BQS computation operates entirely on behavioral signals processed through signal aggregation modules and contextual factors without requiring personally identifiable information, thereby ensuring compliance with global privacy regulations enforced through consent module supporting GDPR, CCPA, and other frameworks.

### Four Integrated Functional Components

Aspects of embodiments of the present invention contemplate integrated functional components that create a technically interdependent closed-loop architecture coordinated through BQS Unity Framework:

### Component 1: Signature-Based Reconciliation and Verification

The system performs signature-based reconciliation of post-engagement outcomes through engagement beacons deployed across advertising channels. Engagement beacons capture beacon events including interaction types, timestamps, and context, transmitting data asynchronously through asynchronous transmission to collection servers.

Engagement beacons generate cryptographic nonces through nonce-based cryptographic signing for replay prevention. Event batching aggregates multiple interaction events before network transmission, while exponential backoff retry mechanisms handle failed transmissions.

Reconciliation engine receives engagement verification data from beacon data systems and generates behavioral fingerprints using one-way hash functions comprising SHA-256 hashing, SHA-3 algorithms, or BLAKE2 algorithms. The reconciliation engine compares behavioral fingerprints against cohort signatures stored in cache storage using similarity metrics comprising cosine distance or Jaccard index, determining reconciliation confidence through match results.

Qualified attribution score generator computes attribution scores based on attribution confidence, detecting deviations between pre-qualification scores and post-engagement outcomes. The deviation calculator identifies systematic prediction errors and generates feedback signals for qualification refinement through BQS parameter updates.

The reconciliation system implements non-PII matching by correlating engagement events across touchpoints using beacon correlation matrix tracking multiple conversion paths, implementing multi-touch attribution without personally identifiable information through privacy-preserving techniques comprising differential privacy, k-anonymity enforcement, or ephemeral identifier expiration.

Event chaining creates sequential linking through Merkle tree structure with SHA-256 hashing, providing cryptographic integrity verification for the reconciliation process and feeding into immutable ledger.

### Component 2: Enforcement Proxy Architecture with Pre-Spend Compliance

The system implements enforcement proxy gateway comprising a compliance gateway that intercepts incoming bid requests before auction processing. The compliance gateway retrieves BQS scores from pre-spend qualification engine (disclosed in the Omnibus Application) and evaluates requests through gating logic processor executing decision tree against qualification policies from policy rules engine.

Policy rules engine maintains advertiser-defined thresholds and brand safety requirements. Fraud signal interface receives real-time fraud scores from fraud detection clusters. Gating logic processor executes parallel evaluation through decision tree comprising BQS threshold check, fraud score validation, and policy compliance verification.

For qualified requests passing all evaluation criteria, token generator produces cryptographic authorization tokens comprising:
Transaction hash using SHA-256 cryptographic hashing uniquely identifying the authorized request
The BQS score value that justified authorization
Computation version identifier ensuring provenance of the scoring algorithm
Digital signature using Ed25519 signing proving the token was issued by an authorized compliance gateway
Expiration timestamp limiting token validity to prevent replay attacks

Unqualified requests are blocked through blocking notifications before budget commitment, preventing waste at the source through pre-spend enforcement. In-memory rule caching stores frequently accessed policy configurations for low-latency evaluation.

The enforcement proxy operates transparently to both demand-side platforms and advertising exchanges, maintaining compatibility with existing programmatic infrastructure while enforcing mandatory pre-spend qualification requirements.

This cryptographic attestation creates verifiable proof that each authorized transaction met qualification requirements enforced through compliance gateway, enabling dispute-free reconciliation via immutable ledger and audit verification through verification API providing third-party validation of log integrity.

### Component 3: Enhanced Fraud Detection System

Enhanced fraud detection system identifies and prevents fraudulent advertising activity through multi-layered analysis integrated with enforcement proxy. Comprehensive data collection layer aggregates bid streams, user interactions, device fingerprints, and network patterns for holistic fraud analysis.

Behavioral analysis module processes user interaction patterns, timing sequences, and network characteristics. Pattern recognizer extracts features for a fraud scoring engine that employs ensemble methods comprising isolation forest, gradient boosting, and neural networks.

The fraud scoring engine computes fraud probability scores through ensemble methods combining multiple detection algorithms. Suppression controller generates fraud suppression signals implementing bid blocking, rate limiting, or value reduction based on fraud scores exceeding configurable thresholds.

The fraud detection system implements distributed fraud detection infrastructure comprising multiple detection nodes processing subset streams in parallel. A cohorting engine forms fraud cohorts through clustering analysis based on behavioral similarity.

Anomaly detection algorithms identify suspicious patterns through statistical methods and machine learning. Cross-tenant analytics identify fraud patterns spanning multiple advertiser accounts through differential privacy with privacy budget manager adding calibrated statistical noise.

All fraud detection events generate audit entries through cryptographic audit generator creating tamper-proof records stored in immutable ledger with hash chain verification, feeding comprehensive audit system.

### Component 4: Immutable Audit Architecture

The system records all enforcement decisions, fraud detection events, and reconciliation outcomes in immutable ledger through append-only logs with event storage and no deletion capability. This creates tamper-evident distributed ledger verification that validates enforcement decisions and provides cryptographically verifiable audit trails.

All enforcement decisions generate cryptographically signed audit records through Ed25519 signing producing digital signatures. Each audit record captures actor identity, timestamps, event types, and operational context.

Merkle tree builder creates tamper-evident record chains through event chaining using SHA-256, creating hierarchical hash structures that enable efficient verification of record integrity. Any modification to historical records would require recomputing the entire hash chain, making tampering mathematically detectable.

A verification API exposes interfaces enabling third-party validation of log integrity without requiring access to sensitive operational data. External auditors can independently verify that enforcement decisions were made according to stated policies and that no retroactive modifications occurred.

The immutable ledger implements log replication distributing log copies across geographically separated availability zones, ensuring crash-consistent recording with fault tolerance. Multi-zone replication prevents single points of failure while maintaining append-only consistency guarantees.

Compliance reporting interfaces generate regulatory audit reports through report generation, demonstrating adherence to compliance requirements for advertisers, regulators, and third-party auditors.

### Component 5: Closed-Loop Feedback and Optimization

Feedback system implements recursive policy optimization by collecting verified outcome data from reconciliation outputs including QAS values, fraud signals, and engagement metrics. This creates a closed-loop learning system that continuously improves qualification accuracy based on verified post-engagement outcomes.

Model updates compute performance metrics comparing predicted BQS values against actual engagement outcomes, identifying systematic prediction errors through deviation analysis. Reinforcement learning and policy gradient methods apply adaptive algorithms to optimize enforcement parameters.

BQS Unity Optimizer generates parameter adjustment recommendations coordinating BQS enforcement weight, efficiency factor, enforcement level, and unity balance. The optimizer adjusts weighting coefficients propagated to the Omnibus Application's BQS computation engine to improve future prediction accuracy through model parameters that minimize prediction error.

Qualification thresholds undergo recalibration analyzing false positive and false negative rates through threshold recalibration logic. Fraud models undergo retraining incorporating newly identified attack patterns to maintain detection accuracy as fraud techniques evolve.

Updated parameters propagate through feedback loop to achieve continuous improvement. Real-time adaptation ensures convergent optimization through optimization cycle coordinated by BQS Unity Framework, maintaining system-wide consistency across all enforcement components.

### Functional Interdependence and Unity

The five components create a technically interdependent system wherein:
Signature-based reconciliation validates behavioral predictions through post-engagement verification using engagement beacons and behavioral fingerprints
Enforcement proxy blocks unqualified requests through compliance gateway before budget commitment based on BQS scores from the Omnibus Application
Fraud detection system generates fraud probability scores that modulate enforcement thresholds through suppression controller
Immutable ledger creates cryptographically verifiable audit trails through append-only logs and Merkle tree verification
Feedback system continuously refines BQS parameters through closed-loop learning via BQS Unity Optimizer

Removal of any functional component causes enforcement accuracy to degrade below operational thresholds, demonstrating the unified nature of the invention:
Without signature-based reconciliation, the system cannot validate predictions or generate learning signals
Without enforcement proxy, unqualified traffic reaches exchanges despite inadequate BQS scores
Without fraud detection, sophisticated attacks evade behavioral qualification
Without immutable ledger, enforcement decisions cannot be verified or trusted
Without closed-loop feedback, the system cannot adapt to evolving fraud patterns

This functional interdependence establishes unified closed-loop enforcement as the single inventive concept: all system decisions—from initial qualification through enforcement, verification, and optimization—are orchestrated by the BQS Unity Framework, creating consistent and reproducible decision-making across all operational layers coordinated between the Omnibus Application (qualification) and this present application (enforcement).

### Technical Advantages Over Prior Art

The invention provides numerous advantages over post-spend detection systems:

Pre-Spend Prevention vs. Post-Spend Detection: Waste is blocked before budget commitment through enforcement proxy rather than identified after spending occurs, eliminating opportunity cost and refund disputes through mandatory pre-auction qualification.

Cryptographic Immutability: SHA-256 hashing, Ed25519 digital signatures, and Merkle tree builder create mathematically verifiable proof of enforcement decisions through immutable ledger that cannot be disputed or retroactively modified.

Real-Time Adaptation: BQS Unity Optimizer updates policy coefficients recursively based on verified outcomes from reconciliation outputs, enabling the system to respond to emerging fraud patterns through continuous improvement without manual intervention.

Privacy-Native Operation: The system functions entirely on behavioral fingerprints and contextual factors processed through non-PII matching without requiring cookies, persistent device identifiers, or personally identifiable information, ensuring compliance with consent module enforcing GDPR, CCPA, and emerging privacy frameworks.

Distributed Enforcement Consistency: Compliance gateway enforcement decisions remain consistent across geographically dispersed gateway instances through log replication across availability zones, preventing arbitrage or enforcement gaps.

Multi-Vector Fraud Detection: Enhanced fraud detection system generates fraud probability scores through ensemble methods combining isolation forest, gradient boosting, and neural network pattern recognition, analyzing temporal patterns, geographic patterns, and behavioral consistency-achieving higher accuracy than single-model detection systems.

Signature-Based Reconciliation: Reconciliation engine validates engagement authenticity through one-way hash functions and similarity metrics without exposing individual user data, enabling privacy-preserving verification through behavioral fingerprints matched against cohort signatures.

### Cross-Patent Coordination Through BQS Unity Framework

The present invention and the related the Omnibus Application (the Omnibus Application) share a single inventive concept—pre-spend behavioral qualification preventing digital advertising waste—achieved through unified scoring governance coordinated by BQS Unity Framework:

the Omnibus Application establishes the BQS computation engine that generates unified BQS scores through BQS Unity Coordination Engine applying BQS Weighting Factors to synthesize multi-dimensional behavioral signals.

This present application operationalizes that framework through enforcement proxy, signature-based reconciliation engine, immutable ledger, and feedback system that validate predictions and recursively optimize the unified BQS metric.

The functional interdependence between the Omnibus Application and This present application is established through coordinated data flows:
BQS scores generated by the Omnibus Application's pre-spend qualification engine serve as policy inputs to this present application's compliance gateway
Verified post-engagement outcomes recorded through the reconciliation engine generate feedback signals
Feedback signals recursively refine BQS Weighting Factors propagated back to the Omnibus Application's BQS Unity Coordination Engine

This coordinated dependency maintains distinct claim scope while establishing unity: Parent 2 operationalizes the Omnibus Application outputs without duplicating the Omnibus Application's claim scope. Removal of either the BQS computation framework (the Omnibus Application) or the closed-loop enforcement mechanism (this present application) causes the overall system's waste prevention accuracy to degrade below operational thresholds.

An aspect of an embodiment of the present invention contemplates a closed-loop behavioral verification and reconciliation system for digital advertising, comprising: (a) a signature-based reconciliation engine configured to receive engagement verification data from beacon data systems, generate behavioral fingerprints using one-way hash functions, compare said fingerprints against cohort signatures using similarity metrics, and determine reconciliation confidence through match results; (b) a qualified attribution score generator configured to compute attribution scores, detect deviations between pre-qualification scores and post-engagement outcomes, and generate feedback signals for qualification refinement; (c) a non-PII matching system configured to correlate engagement events through beacon correlation matrix implementing multi-touch attribution using privacy-preserving techniques; and (d) engagement verification beacons configured to capture beacon events and transmit data asynchronously through asynchronous transmission with cryptographic nonces for replay prevention.

An aspect of an embodiment of the present invention contemplates a pre-spend enforcement and audit infrastructure comprising: (a) an enforcement proxy gateway with compliance gateway configured to intercept incoming bid requests, retrieve BQS scores, evaluate through gating logic processor, authorize qualified requests by generating cryptographic authorization tokens through token generator, and block unqualified requests through blocking notifications; (b) a verified transaction logging system comprising immutable ledger configured to record enforcement decisions in append-only logs, generate digital signatures through Ed25519 signing, create tamper-evident chains through Merkle tree builder, and expose verification interfaces through verification API; and (c) an enhanced fraud detection system configured to aggregate behavioral signals, perform anomaly detection through pattern recognizer, execute fraud scoring through fraud scoring engine employing ensemble methods, and generate suppression signals through suppression controller.

An aspect of an embodiment of the present invention contemplates a performance-optimized machine learning system comprising: (a) an asynchronous API architecture configured to expose non-blocking endpoints through qualification engine and beacon service, implement circuit breaker mechanisms, and maintain correlation identifiers; (b) high-performance data structures configured to store behavioral qualification state in tenant data stores, implement distributed caching through weighted fair queuing, and utilize interval-tree structure; (c) a machine learning behavioral analysis system comprising ML-based assessment configured to analyze reconciliation outcomes, compute recalibration recommendations through recalibration trigger, apply reinforcement learning through Q-learning algorithm, and update fraud models through retraining; and (d) a closed-loop feedback pipeline comprising feedback system configured to collect verified outcome data from reconciliation outputs, compute performance metrics through model updates, generate parameter adjustments through BQS Unity Optimizer, and propagate updated parameters through model parameters.

In an aspect of an embodiment of the present invention, the cryptographic authorization tokens may comprise: transaction hashes using SHA-256 hashing; digital signatures using Ed25519 signing; expiration timestamps limiting token validity; and combinations thereof.

In an aspect of an embodiment of the present invention, the immutable ledger implements: Ed25519 digital signature generation with key rotation schedules; Merkle tree construction creating hierarchical hash structures with SHA-256; multi-zone replication through log replication distributing log copies across availability zones; and append-only storage with no deletion capability.

In an aspect of an embodiment of the present invention, the enhanced fraud detection system employs ensemble methods through fraud scoring engine comprising: isolation forest algorithms detecting anomalous behavioral patterns; gradient boosting classifiers identifying fraud through iterative refinement; neural network pattern recognizers detecting complex fraud signatures; and combinations aggregating predictions from multiple detection algorithms.

In an aspect of an embodiment of the present invention, the system implements distributed fraud detection infrastructure comprising: multiple detection nodes processing subset streams in parallel; cohorting engine forming fraud cohorts through clustering analysis; and cross-tenant analytics identifying fraud patterns through differential privacy.

In an aspect of an embodiment of the present invention, the real-time consent and privacy management engine implements: opt-in flow processors capturing granular consent; opt-out flow processors providing immediate revocation with cascade deletion; jurisdiction detection logic determining applicable regulations supporting GDPR, CCPA, and other frameworks; and multi-stage policy enforcement applying privacy constraints across data ingestion, processing, and output stages.

In an aspect of an embodiment of the present invention, the closed-loop feedback pipeline comprising feedback system implements convergent optimization through optimization cycle ensuring: parameter adjustments through model parameters stabilize within bounded iteration counts; local optimizations propagate through real-time adaptation to achieve global performance improvements; and boundary condition enforcement prevents extreme parameter values that would destabilize system operation.

In an aspect of an embodiment of the present invention, the invention is embodied as a computer-implemented method for closed-loop behavioral qualification and enforcement comprising: (a) executing signature-based reconciliation through reconciliation system; (b) computing qualified attribution scores through QAS generator; (c) performing non-PII matching through beacon correlation matrix; (d) capturing engagement verification through beacons; (e) enforcing pre-spend qualification through compliance gateway; (f) logging verified transactions through immutable ledger; (g) detecting fraud through fraud enforcement architecture; (h) managing consent through consent module; (i) implementing asynchronous API processing through API interaction sequence; (j) optimizing data structures; (k) executing machine learning behavioral analysis; and (l) optimizing through closed-loop feedback system.

In an aspect of an embodiment of the present invention, the invention is embodied as a non-transitory computer-readable storage medium storing instructions that, when executed by one or more processors, cause the processors to perform the operations disclosed herein.

The foregoing summary describes certain aspects of embodiments of the present invention and is not intended to limit the scope of the invention, which is defined solely by the appended claims. Various modifications, alternative constructions, and equivalents may be employed without departing from the true spirit and scope of the invention as coordinated through the BQS Unity Framework spanning the Omnibus Application (qualification) and Parent 2 (enforcement) applications.

### DEFINITIONS AND TERMINOLOGY

For purposes of the present disclosure, the following terms shall have the meanings set forth below. These definitions are intended to harmonize terminology across related applications and shall not be construed as limiting unless expressly recited in the claims.

### Core System Architecture Terms

Closed-Loop Enforcement: A system architecture wherein pre-spend behavioral qualification, compliance gating, engagement verification, signature-based reconciliation, and feedback optimization are unified through the BQS Unity Framework, such that post-engagement outcomes from reconciliation outputs directly modulate future BQS computation weights and qualification thresholds, creating a convergent optimization cycle through optimization cycle that prevents waste before budget commitment rather than detecting it after spend.

Behavioral Qualification Score (BQS): A real-time unified metric computed from multi-dimensional behavioral signals according to the formula:

BQS=f(User engagement, Model efficiency, Enforcement strictness, Content relevance)×BQS Weighting Factors.

where User engagement include loyalty indicators and engagement history, Model efficiency encompasses routing decisions, Enforcement strictness reflect fraud detection and compliance needs, and Content relevance indicates contextual alignment, with the score serving as the single governing metric for all system decisions coordinated by BQS Unity Coordination Engine.

BQS Unity Framework: The architectural principle embodied in BQS Unity Framework wherein all system operations—qualification, gating through compliance gateway, verification through reconciliation engine, reconciliation through reconciliation system, and feedback through feedback system—are orchestrated through a single unified BQS metric rather than multiple independent variables, ensuring consistent and reproducible decision-making across all operational layers while maintaining sophisticated multi-dimensional optimization through BQS weighting factors.

Qualified Attribution Score (QAS): A post-engagement confidence metric generated by qualified attribution score generator derived from reconciling pre-qualification scores with verified engagement outcomes, incorporating fraud-weighted adjustments, temporal consistency validation, and contextual coherence verification, with significant deviations triggering automatic recalibration through recalibration trigger of BQS computation weights and qualification thresholds.

Ephemeral Behavioral Fingerprint: A cryptographically hashed representation generated as behavioral fingerprints of user interaction patterns using one-way hash functions comprising SHA-256 hashing, capturing normalized engagement sequences (scroll depth percentiles, logarithmic dwell time buckets, encoded click patterns, categorical gesture tokens) with automatic expiration, ensuring privacy compliance through privacy-preserving techniques while maintaining attribution fidelity through beacon correlation matrix without cookies, device IDs, or personally identifiable information.

### Enforcement and Gating Components

Compliance Gateway: A mandatory enforcement proxy gateway comprising compliance gateway operating inline between demand-side platforms and programmatic exchanges, configured to intercept incoming bid requests, evaluate them through gating logic processor against BQS thresholds and fraud probability scores, physically block bids through blocking notifications where BQS falls below configurable requirements from policy rules engine, and generate cryptographic authorization tokens through token generator as immutable proof of pre-spend enforcement, maintaining low-latency processing compatible with real-time bidding.

Pre-Spend Gating: The process of enforcing BQS-based qualification and fraud suppression before bid submission to advertising exchanges through compliance gateway, preventing budget allocation to impressions with insufficient BQS values that fall below minimum behavioral fidelity thresholds through non-bypass able transaction-layer blocking via enforcement proxy, as distinguished from post-spend detection systems that identify waste after economic damage has occurred.

BQS Threshold Enforcement: The mechanism whereby bid authorization, impression delivery, and campaign activation are determined exclusively by comparing computed BQS values against configurable qualification thresholds that define minimum behavioral fidelity requirements for bid authorization through BQS threshold check, with thresholds dynamically adjusting through closed-loop learning via feedback system and BQS Unity Optimizer.

Engagement Verification Beacon: Lightweight, privacy-compliant measurement instruments embodied as engagement beacons deployed within ad creatives, landing pages, or application environments through client-side integration, generating cryptographic nonces through nonce-based cryptographic signing, capturing beacon events including interaction types, timestamps, and context without PII, and transmitting batched events through event batching asynchronously via asynchronous transmission, creating a provable chain of custody from BQS qualification through enforcement token to engagement proof via reconciliation engine.

### Fraud Detection and Suppression

Fraud Probability Score: A composite metric generated as fraud scores through ensemble methods via fraud scoring engine combining isolation forest, gradient boosting, and neural network pattern recognition, with the resulting score serving as an input to BQS computation where elevated fraud probability increases the enforcement weight, thereby tightening BQS threshold requirements through fraud-weighted adjustments applying multiplicative factors proportional to fraud probability.

BQS-Modulated Suppression: A subsystem implemented through suppression controller implementing graduated enforcement actions based on how fraud probability affects BQS values, including immediate bid blocking when BQS falls below critical thresholds, progressive rate limiting as BQS approaches boundaries, and proportional value reduction, with all actions generating cryptographically signed audit entries through cryptographic audit generator stored in immutable ledger.

Differential Attribution Cohorting: A privacy-preserving fraud detection methodology employing differential privacy with privacy budget manager adding bounded noise injection, enabling cross-tenant pattern detection through cross-tenant analytics and secure computation while preventing individual user identification, with detected patterns feeding back through feedback system to adjust BQS fraud input weights via BQS Unity Optimizer.

### Reconciliation and Feedback Systems

Reconciliation Engine: A subsystem embodied as reconciliation system comprising signature-based reconciliation engine that matches post-engagement behavioral fingerprints against cohort signatures stored in cache storage using similarity metrics comprising cosine distance or Jaccard index, determining through match results whether engagements originated from users whose BQS met qualification requirements, with match confidence directly influencing future qualification threshold calibration through feedback loop.

Signature-Based Reconciliation: The process of cryptographically verifying that post-engagement behaviors align with pre-qualification BQS levels through one-way hash functions comparison, probabilistic matching using similarity metrics, and cryptographic chaining via event chaining through Merkle tree structure with SHA-256 hashing, producing tamper-evident, third-party verifiable attribution records through verification API without relying on persistent identifiers.

BQS Feedback Optimization: The systematic propagation of reconciliation outcomes from reconciliation outputs, attribution scores via QAS values, and fraud signals back into the BQS Unity Framework, enabling continuous refinement of BQS computation weights and threshold calibration through reinforcement learning and policy gradient methods achieving rapid convergence via continuous improvement.

### BQS Computation and Optimization

BQS Weight Coefficients: Adaptive parameters embodied as BQS weighting factors that determine the relative influence of each input factor (User attributes, Model efficiency, Enforcement requirements, Content relevance) in the BQS computation, with weights continuously optimized through BQS Unity Optimizer coordinating BQS enforcement weight, efficiency factor, enforcement level, and unity balance based on verified engagement outcomes to improve qualification accuracy through model parameters minimizing prediction error.

BQS Threshold Calibration: The dynamic adjustment of qualification thresholds based on operational feedback from reconciliation outputs, where high attribution confidence relaxes thresholds to reduce friction, low-confidence attribution tightens thresholds for protection through BQS threshold control, and fraud detection through fraud scores immediately elevates threshold requirements, with recalibration analyzing false positive and false negative rates.

System-Wide BQS Convergence: The state wherein changes to BQS weighting factors and qualification thresholds stabilize across all integrated subsystems within bounded iteration counts through optimization cycle, ensuring that local optimizations in fraud detection, qualification scoring, or enforcement policy propagate globally through real-time adaptation via the unified scoring framework coordinated by BQS Unity Framework.

### Multi-Tenant and Orchestration Terms

Cryptographically Isolated Pipeline: A tenant-specific processing environment embodied in tenant isolated pipelines secured through dedicated encryption keys implementing hardware-generated key management, hierarchical key derivation, row-level security with tenant predicates, and tenant isolation verification while maintaining BQS computation consistency across tenants through orchestration layer.

Federated BQS Learning: A cross-tenant model improvement mechanism embodied as federated learning wherein only encrypted model gradient exchange shares BQS weight gradients, with differential privacy noise injection through privacy budget manager preventing gradient inversion, enabling platform-wide BQS optimization while maintaining absolute data isolation between tenants through cryptographic namespace separation.

Multi-Tenant BQS Orchestration: The management of concurrent advertiser accounts with cryptographic data separation through tenant data stores, dynamic resource allocation through resource manager allocating compute resources based on service tier weighting managed by SLA management monitoring current load, and cross-tenant analytics through privacy-preserving aggregation using differential privacy, all while maintaining consistent BQS computation logic across tenants through multi-tenant orchestration layer.

### Audit and Compliance Infrastructure

Audit Generator: A cryptographic logging subsystem embodied as cryptographic audit generator creating immutable, tamper-evident records stored in immutable ledger with hash chain verification of all BQS-based enforcement decisions, employing digital signatures through Ed25519 signing with key rotation, cryptographic hash chaining via Merkle tree builder with event chaining using SHA-256, append-only logs with event storage and no deletion capability, and extended retention through log replication distributing log copies across availability zones for compliance.

BQS Enforcement Token: A cryptographically signed authorization credential embodied as cryptographic authorization tokens generated by token generator containing bid identifier, BQS value, component scores, timestamp, and validity period, with digital signature using Ed25519 signing, serving as mathematically verifiable proof that BQS-based pre-spend gating through compliance gateway was applied at transaction time.

### Performance and Latency Specifications

Low-Latency BQS Processing: The operational constraint for BQS computation and enforcement compatible with programmatic real-time bidding requirements maintaining end-to-end processing latency below 200 milliseconds at the 99th percentile, achieved through distributed caching of BQS values in cache storage, parallel processing of BQS computation inputs, and optimized policy evaluation through in-memory rule caching while maintaining decision accuracy.

Rapid Enforcement Response: The processing capability for compliance gateway operations evaluating BQS thresholds through gating logic processor, achieved through in-memory rule caching, multi-threaded evaluation executing decision tree, and circuit breaker mechanisms detecting failure patterns that default to cached decision paths with recent results under load, ensuring minimal incremental overhead.

Real-Time BQS Matching: The performance constraint for sponsorship and personalization operations based on BQS values, achieved through precomputed embeddings stored in cache storage, parallel evaluation, early termination upon confidence satisfaction through match results, and fallback hierarchies through resilience subsystem implementing progressive degradation for timeout scenarios.

### Privacy and Compliance Terminology

Privacy by Design Compliance: The architectural principle wherein BQS computation occurs on ephemeral behavioral fingerprints without cookies, device IDs, or PII through privacy-preserving techniques, with automatic data expiration via ephemeral identifier expiration, geographic generalization, and no cross-session linkage maintaining k-anonymity enforcement, exceeding requirements of global privacy regulations enforced through consent module supporting GDPR, CCPA, and other frameworks.

Consent-Gated BQS Qualification: The enforcement mechanism implemented through consent module whereby absence of user consent sets BQS to zero regardless of other inputs, triggering automatic bid blocking through blocking notifications, with granular consent management through opt-in flows, jurisdiction-specific policy application through jurisdiction-specific logic, cascade deletion upon revocation through immediate revocation via opt-out mechanisms, and consent status history in cryptographic audit records generating audit trail.

### Integration and Unified Platform Terms

BQS Unity and Platform Integration: The property whereby all subsystems operate through the single BQS metric coordinated by BQS Unity Framework, demonstrating that each component (qualification through pre-spend qualification engine, enforcement through compliance gateway, verification through reconciliation engine, reconciliation through reconciliation system, feedback through feedback system) contributes to and is governed by unified BQS optimization via BQS Unity Optimizer, establishing the foundation for privacy-compliant, fraud-resistant digital advertising through single-metric orchestration.

Cross-Component BQS Dependencies: The technical interdependencies wherein upstream components provide behavioral signals that determine BQS computation inputs processed through signal aggregation modules, enforcement components apply BQS thresholds through compliance gateway for gating decisions via gating logic processor, verification components validate BQS-based predictions through reconciliation engine comparing against match results, and feedback components optimize BQS weights through BQS Unity Optimizer, creating a unified system where all operations are orchestrated through the single governing metric coordinated by BQS Unity Framework rather than multiple independent variables.

Unified Platform Integration Through BQS: Each referenced component from the Omnibus Application either provides essential inputs to BQS computation via pre-spend qualification engine or consumes BQS-based outputs from the closed-loop enforcement system comprising enforcement proxy, reconciliation system, and feedback system claimed herein. The unified scoring through the BQS Unity Framework ensures that changes in any the Omnibus Application subsystem necessarily affect BQS computation weights or qualification thresholds, which then propagate to Parent 2 enforcement mechanisms through compliance gateway and vice versa through feedback signals, demonstrating unity of invention across all platform components. These dependencies establish technical interdependence between the Omnibus Application and Parent 2 applications, wherein the BQS Unity Framework serves as the single orchestrating mechanism ensuring all inventions operate as a unified inventive concept under PCT Rule 13.2.

Behavioral Fidelity Threshold: A configurable minimum qualification score value embodied in qualification thresholds that defines the boundary between qualified and unqualified bid requests in the pre-spend gating process through compliance gateway. The behavioral fidelity threshold represents the minimum acceptable BQS level required for a bid request to proceed through the Compliance Gateway to advertising exchange submission. Behavioral fidelity thresholds are established by advertisers through advertiser-defined thresholds, campaign operators, or policy rules engine and are dynamically adjusted through closed-loop feedback via feedback system based on reconciliation outcomes from reconciliation outputs, fraud signals, and attribution confidence metrics. The term “behavioral fidelity” denotes the degree to which observed behavioral signals processed through behavioral fingerprints align with authentic, non-fraudulent user engagement patterns as quantified through the BQS computation framework coordinated by BQS Unity Framework.

Hybrid Machine-Learning Architecture: A rules-based and machine-learning combined framework embodied through ensemble methods comprising rules-based assessment and ML-based assessment used for computing behavioral qualification scores, providing the technical basis for autonomous agent attestation systems disclosed in continuation-in-part applications.

Note: All thresholds, targets, and metrics referenced herein represent illustrative embodiments and should not be construed as limiting the scope of the claimed invention unless expressly recited in the claims. Alternative implementations may employ different values while maintaining the fundamental BQS-governed closed-loop enforcement architecture coordinated through BQS Unity Framework. Specific model configurations (e.g., anomaly detection methods through pattern recognizer, classification parameters via fraud scoring engine, neural network architectures) are provided by way of example and not limitation.

Where definitions are harmonized with related applications (the Omnibus Application: Hybrid AI-Driven Advertising & Sponsorship System with Real-Time Decisioning and Enforcement Architecture), terms shall have consistent meaning across the unified platform to ensure examination as a single inventive concept under the BQS Unity Framework.

Note: All thresholds, targets, and metrics referenced herein represent illustrative embodiments and should not be construed as limiting the scope of the claimed invention unless expressly recited in the claims. Alternative implementations may employ different values while maintaining the fundamental BQS-governed closed-loop enforcement architecture coordinated through BQS Unity Framework. Specific model configurations (e.g., anomaly detection methods through pattern recognizer, classification parameters via fraud scoring engine, neural network architectures) are provided by way of example and not limitation.

“Module”—In an aspect of an embodiment of the present invention, the term represents a self-contained hardware or software computational unit containing processors, memory, and executable code operable to perform the functions described. Sub-blocks represent elements or sub-modules executing defined functions under the control of the parent module. In an aspect of an embodiment of the present invention, each system block labeled as Engine, Module, Controller, Gateway, Proxy, Service, or Manager in the accompanying Figures constitutes a ‘module’ as that term is defined herein.

In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, module components may also, in an operational context, be components of other modules.

In a further aspect of an embodiment of the present invention, steps, processes, operations or methods undertaken by the modules, systems and/or system components, as discussed above, may be implemented by execution, on one or more servers or processors configured to perform a predefined set of basic operations in response to receiving a corresponding basic instruction selected from a predefined native instruction set of codes. This native instruction set of codes or machine language instruction codes may be built into servers/processors of system components. As such, different operations contemplated by the disclosure above, may be made possible by the selection of machine codes from specific machine language instruction codes. Additional complex operations may be made possible by the combination of different sets of machine language instruction codes.

Further aspects of embodiments of the present invention contemplate the use of non-transitory computer programmable product and computer-implemented methods for the implementation of the different processes outlined in this application, claims, and drawings. The same may be found installed on any or all of the components discussed in this application including, without limitation, the mobile device(s), registries, etc.

Yet further aspects of embodiments of the present invention contemplate execution of computer code resident on devices, system of devices, and communication media such as wide area networks, the internet etc. enabling the contemplated transactions.

Other terms used herein should be given their plain and ordinary meaning as understood by a person of ordinary skill in the art at the time of the invention, unless explicitly defined otherwise. Where industry-standard definitions exist (e.g., IAB specifications, W3C standards), such definitions may be consulted for context. In the event of conflict with external definitions, the definitions provided herein shall control for purposes of claim interpretation, prosecution, and enforcement. The definitions provided herein are intended to clarify usage within this specification and should not be construed as limiting the scope of the claims unless explicitly recited therein.

All defined terms may be implemented in hardware, software, firmware, or any combination thereof, and may be distributed across multiple physical or logical components without departing from the scope of the invention.

Where definitions are harmonized with related applications (such as the Omnibus Application), terms shall have consistent meaning across the unified platform to ensure examination as a single inventive concept under the BQS Unity Framework pursuant to relevant patent office rules.

An aspect of an embodiment of the present invention contemplates a closed-loop behavioral verification and reconciliation system for digital advertising, comprising: a signature-based reconciliation engine, a qualified attribution score generator configured to: detect deviations between pre-qualification scores and post-engagement outcomes received from said signature-based reconciliation engine, and generate feedback signals for qualification refinement, a non-PII matching system, and engagement verification beacons, where the closed-loop behavioral verification and reconciliation system is configured to validate engagements against pre-qualification requirements and propagates said feedback signals through a feedback loop to update said pre-qualification scores, and enforces qualification requirements based on said updated pre-qualification scores, thereby achieving continuous improvement through deterministic recalibration.

In an aspect of an embodiment of the present invention, the signature-based reconciliation engine may be configured to perform any one or a combination of the following operations: receive engagement verification data from beacon data systems, generate behavioral fingerprints using one-way hash functions, compare the fingerprints against cohort signatures stored in cache storage using similarity metrics comprising any one of cosine distance or Jaccard index, and determine reconciliation confidence through match results.

In an aspect of an embodiment of the present invention, the qualified attribution score generator may be configured to perform any one or a combination of the following operations: compute attribution scores based on attribution confidence, detect deviations between pre-qualification scores and post-engagement outcomes, and generate feedback signals for qualification refinement through BQS parameter updates.

In an aspect of an embodiment of the present invention, the non-PII matching system may be configured to perform any one or a combination of the following operations: correlate engagement events across touchpoints using beacon correlation matrix tracking multiple conversion paths, implement multi-touch attribution without personally identifiable information, and utilize privacy-preserving techniques comprising any one of differential privacy, k-anonymity enforcement, ephemeral identifier expiration.

In an aspect of an embodiment of the present invention, the engagement verification beacons may be configured to perform any one or a combination of the following operations: capture beacon events including interaction types, timestamps, and context, transmit data asynchronously through asynchronous transmission to collection servers, and generate cryptographic nonces through nonce-based cryptographic signing for replay prevention.

In an aspect of an embodiment of the present invention, the system validates engagements against pre-qualification requirements and propagates feedback signals through feedback loop achieving continuous improvement for continuous scoring refinement.

In an aspect of an embodiment of the present invention, the signature-based reconciliation engine may be configured to receive engagement verification data comprising behavioral interaction patterns captured without any one of: personally identifiable information, device identifiers, persistent cookies.

In an aspect of an embodiment of the present invention, the signature-based reconciliation engine may be configured to generate behavioral fingerprints using one-way hash functions, where the one-way hash functions comprise any one of: SHA-256 hashing, SHA-3 algorithms, BLAKE2 algorithms.

In an aspect of an embodiment of the present invention, the signature-based reconciliation engine may be configured to compare generated behavioral fingerprints against cohort signatures stored in cache storage using similarity metrics, where the similarity metrics comprise of any one of: cosine distance calculations, Jaccard index calculations, Euclidean distance measurements, weighted combinations.

In an aspect of an embodiment of the present invention, the signature-based reconciliation engine may be configured to generate behavioral fingerprints, where the behavioral fingerprints are configured to capture normalized engagement sequences comprising any one or combinations of: scroll depth patterns, dwell time distributions, interaction velocities, gesture classifications.

In an aspect of an embodiment of the present invention, the qualified attribution score generator may be further configured to apply any one of: fraud-weighted adjustments receiving multiplicative factors proportional to fraud probability, temporal consistency validation analyzing timing patterns between pre-qualification and engagement events, contextual coherence verification assessing alignment between expected context and actual engagement environment.

In an aspect of an embodiment of the present invention, the engagement verification beacons may be configured to be implemented through client-side integration comprising any one of: JavaScript tags embedded within web-based advertising content, mobile software development kits integrated within native applications, server postbacks transmitting engagement confirmations through API endpoints.

In an aspect of an embodiment of the present invention, the engagement verification beacons may be configured to perform any one of: event batching aggregating multiple interaction events before network transmission, exponential backoff retry mechanisms handling failed transmissions through progressively delayed retry attempts, session key derivation generating encryption keys from enforcement tokens.

In an aspect of an embodiment of the present invention, the non-PII matching system may be configured to implement any one of: differential privacy mechanisms with a privacy budget manager adding calibrated statistical noise to aggregated behavioral patterns, k-anonymity enforcement suppressing reporting of behavioral cohorts containing fewer than a minimum threshold number of users, ephemeral identifier expiration removing correlation capability after predefined retention windows.

In an aspect of an embodiment of the present invention, the signature-based reconciliation engine may be configured to store reconciliation events in event chaining through Merkle tree structure with SHA-256 hashing.

In an aspect of an embodiment of the present invention, the feedback signals generated through the feedback loop comprise any one of: BQS weighting factor adjustments indicating changes to relative importance of behavioral signal dimensions, threshold calibration recommendations through qualification thresholds indicating modifications to minimum qualification requirements, fraud detection sensitivity adjustments indicating changes to anomaly detection parameters.

In an aspect of an embodiment of the present invention, the signature-based reconciliation engine may be configured to receive engagement verification data from beacon data systems, where the engagement verification data comprises multi-touch interaction sequences tracked through a beacon correlation matrix across multiple advertising exposures without maintaining persistent identifiers between sessions.

An aspect of an embodiment of the present invention also contemplates a pre-spend enforcement and audit infrastructure system for digital advertising operating in conjunction with a behavioral qualification system, comprising: an enforcement proxy gateway comprising a compliance gateway configured to receive behavioral qualification scores from said behavioral qualification system, a verified transaction logging system, an enhanced fraud detection system, a real-time consent and privacy management engine, where the system prevents advertising waste before budget commitment through mandatory enforcement of said behavioral qualification scores via the compliance gateway and creates immutable audit trails through cryptographic audit records demonstrating regulatory compliance.

In an aspect of an embodiment of the present invention, the enforcement proxy gateway may be configured to perform any one or a combination of the following operations: intercept incoming bid requests before auction processing, retrieve behavioral qualification scores (BQS scores) from a pre-spend qualification engine, evaluate requests through a gating logic processor executing decision tree against qualification policies from a policy rules engine, authorize qualified requests by generating cryptographically signed authorization tokens through token generator producing cryptographic authorization tokens, and block unqualified requests through blocking notifications before budget commitment.

In an aspect of an embodiment of the present invention, the verified transaction logging system comprising the immutable ledger may be configured to perform any one or a combination of the following operations: record enforcement decisions in append-only logs with event storage and no deletion capability, generate cryptographically signed audit records through Ed25519 signing producing digital signatures, create tamper-evident record chains through Merkle tree builder with event chaining using SHA-256, and expose verification interfaces through verification API enabling third-party validation of log integrity.

In an aspect of an embodiment of the present invention, the enhanced fraud detection system may be configured to perform any one or a combination of the following operations: aggregate behavioral signals from behavioral analysis module processing user interaction patterns, timing sequences, and network characteristics, perform real-time anomaly detection through a pattern recognizer, execute multi-vector fraud analysis through fraud scoring engine employing isolation forest, gradient boosting, and neural networks, compute fraud probability scores through ensemble methods, and generate fraud suppression signals through suppression controller implementing bid blocking, rate limiting, or value reduction.

In an aspect of an embodiment of the present invention, the real-time consent and privacy management engine may be configured to perform any one or a combination of the following operations: enforce jurisdiction-specific privacy policies through jurisdiction-specific logic supporting GDPR, CCPA, and other frameworks, manage user consent preferences through opt-in flows and opt-out mechanisms with immediate revocation, implement consent-gated qualification logic through policy enforcement at data ingestion, data processing, and data output stages, and execute cascade deletion processes.

In an aspect of an embodiment of the present invention, the system prevents advertising waste before budget commitment through mandatory enforcement of qualification requirements via compliance gateway and creates immutable audit trails through cryptographic audit records demonstrating regulatory compliance.

In an aspect of an embodiment of the present invention, the compliance gateway of the system may be configured to generate cryptographically signed authorization tokens, where the cryptographic authorization tokens comprise any one or combinations of: transaction hashes generated using SHA-256 cryptographic hashing, digital signatures generated using Ed25519 signing elliptic curve cryptography, expiration timestamps limiting token validity periods.

In an aspect of an embodiment of the present invention, the enforcement proxy gateway of the system may be configured to implement any one of: a policy rules engine maintaining advertiser-defined thresholds and brand safety requirements, a fraud signal interface receiving real-time fraud scores from fraud detection clusters, a gating logic processor executing parallel evaluation through a decision tree with a BQS threshold check, fraud score validation and policy compliance verification, an in-memory rule caching system storing frequently accessed policy configurations.

In an aspect of an embodiment of the present invention, the verified transaction logging system may be configured to implement any one of: Ed25519 digital signature generation with key rotation schedules, Merkle tree construction creating hierarchical hash structures with SHA-256, multi-zone replication through log replication distributing log copies across geographically separated availability zones, append-only storage with no deletion capability.

In an aspect of an embodiment of the present invention, the enhanced fraud detection system may be configured to employ ensemble methods through a fraud scoring engine comprising any one of: isolation forest code configured to detect anomalous behavioral patterns, gradient boosting classifiers identifying fraud through iterative refinement, neural network pattern recognizers configured to detect complex fraud signatures, combinations aggregating predictions from multiple detection code.

In an aspect of an embodiment of the present invention, the enhanced fraud detection system may be configured to implement distributed fraud detection infrastructure comprising any one of: multiple detection nodes configured to process subset streams in parallel, a cohorting engine configured to form fraud cohorts through clustering analysis based on behavioral similarity, cross-tenant analytics where the cross-tenant analytics identify fraud patterns spanning multiple advertiser accounts through differential privacy.

In an aspect of an embodiment of the present invention, the real-time consent and privacy management engine may be configured to implement operation of any one of: opt-in flow processors capturing granular consent by data categories, opt-out flow processors providing immediate revocation with cascade deletion capabilities, jurisdiction detection logic determining applicable privacy regulations based on user location, or multi-stage policy enforcement applying privacy constraints across data ingestion, processing, and output stages.

In an aspect of an embodiment of the present invention, the enforcement proxy gateway comprising the compliance gateway may be configured to implement graduated enforcement through a suppression controller comprising any one of: complete bid blocking for requests with qualification scores below minimum acceptance thresholds, proportional rate limiting for requests with marginal qualification scores, bid value reduction for borderline requests.

In an aspect of an embodiment of the present invention, all enforcement decisions, fraud detection events, and consent management actions of the system may be configured to generate audit records through conflict event logging and audit trail comprising administrative user identifiers from actor identity, timestamps, event types, and digital signatures.

In an aspect of an embodiment of the present invention, the system may additionally include compliance reporting interfaces configured to perform any one of: generating regulatory audit reports through report generation demonstrating adherence to compliance requirements, exporting audit data to external auditors in standardized formats, providing third-party verification APIs enabling independent auditors to validate system operation through third-party validation.

An aspect of an embodiment of the present invention, contemplates a performance-optimized machine learning system for closed-loop behavioral qualification in digital advertising, comprising: an asynchronous API architecture, high-performance data structures, a machine learning behavioral analysis system, and a closed-loop feedback pipeline, where the system maintains operational responsiveness while continuously improving qualification accuracy through closed-loop learning and optimization framework achieving continuous improvement.

In an aspect of an embodiment of the present invention, the asynchronous API architecture may be configured to perform any one or a combination of the following operations: expose non-blocking communication endpoints through qualification engine and a beacon service, implement asynchronous request processing with POST/api/v2/qualify and POST/api/v2/beacon, maintain correlation identifiers for request tracing, and provide circuit breaker mechanisms detecting failure patterns with traffic redirected to backup systems.

In an aspect of an embodiment of the present invention, the high-performance data structures may be configured to perform any one or a combination of the following operations: store behavioral qualification state in tenant data stores with low-level security, implement distributed caching layers through weighted fair queuing, utilize interval-tree structure for efficient conflict detection, and maintain event buffers through event batching for streaming data processing,

In an aspect of an embodiment of the present invention, the machine learning behavioral analysis system comprising ML-based assessment may be configured to perform any one or a combination of the following operations: analyze reconciliation outcomes through the reconciliation engine to identify qualification errors, compute policy recalibration recommendations through recalibration trigger, apply reinforcement learning algorithms through reinforcement updater and Q-learning algorithm for policy optimization, and update fraud detection models through fraud models retraining incorporating attack patterns.

In an aspect of an embodiment of the present invention, the closed-loop feedback pipeline comprising feedback system may be configured to perform any one or a combination of the following operations: collect verified outcome data from reconciliation outputs including QAS values, fraud signals, and engagement metrics, compute performance metrics through model updates, generate parameter adjustment recommendations through BQS Unity Optimizer coordinating BQS enforcement weight, efficiency factor, enforcement level, and unity balance, and propagate updated parameters through model parameters to distributed enforcement components.

In an aspect of an embodiment of the present invention, the performance-optimized machine learning system maintains operational responsiveness while continuously improving qualification accuracy through closed-loop learning and optimization framework achieving continuous improvement.

In an aspect of an embodiment of the present invention, the asynchronous API architecture may be configured to implement any one of: service mesh integration through orchestration layer providing mutual TLS authentication between services, rate limiting mechanisms through weighted fair queuing enforcing per-tenant request quotas, API versioning strategies supporting backward-compatible endpoint evolution, automatic service discovery with resource manager allocating compute resources and load balancing.

In an aspect of an embodiment of the present invention, the high-performance data structures may comprise any one of: hash tables, interval trees, bloom filters, sparse vector representations, ring buffers.

In an aspect of an embodiment of the present invention, the machine learning behavioral analysis system may be configured to implement any one of: reinforcement learning, Q-learning code, ensemble model updating through ensemble methods, neural network architectures.

In an aspect of an embodiment of the present invention, the closed-loop feedback pipeline may be configured to implement any one of: model updater modules, threshold recalibration logic analyzing false positive and false negative rates through qualification thresholds, fraud model retraining pipelines, federated learning coordination aggregating model gradients [through differential privacy from multiple gateway instances.

In an aspect of an embodiment of the present invention, the high-performance data structures are configured to implement multi-tier cache hierarchies comprising any one of: first-level caches maintaining frequently accessed qualification scores in processor cache memory, second-level caches storing broader qualification score sets through cache storage in application memory, distributed cache clusters replicating qualification data through log replication across multiple nodes, or persistent storage backing caches through tenant data stores with durable qualification score records.

In an aspect of an embodiment of the present invention, the asynchronous API architecture may be configured to implement graceful degradation through a resilience subsystem comprising any one of: cached decision paths with recent results returning pre-computed enforcement decisions during primary system failure, circuit breakers detecting failure patterns and automatically redirecting traffic to backup systems, or progressive degradation disabling ML scoring and real-time processing while maintaining static rules fallback.

In an aspect of an embodiment of the present invention, the machine learning behavioral analysis system may be configured to receive inputs from any one of: signature-based reconciliation engines providing match results, qualified attribution score generators providing attribution confidence assessments, fraud detection systems providing fraud scores and anomaly detection signals from detection nodes, or consent management engines providing consent status compliance status.

In an aspect of an embodiment of the present invention, the closed-loop feedback pipeline comprising feedback system may be configured to implement convergent optimization through an optimization cycle where the cycle enables any one of: parameter adjustments through model parameters stabilized within bounded iteration counts, local optimizations in individual system components propagate through real-time adaptation to achieve global performance improvements, or boundary condition enforcement through BQS threshold control prevents extreme parameter values that would destabilize system operation.

In an aspect of an embodiment of the present invention, the performance-optimized machine learning system may include performance monitoring subsystems comprising SLA management configured to perform any one of: tracking processing latency through current load across all system components, identifying performance bottlenecks through distributed tracing using correlation identifiers, or triggering automatic optimization responses through resource manager when latency approaches operational thresholds.

Another aspect of an embodiment of the present invention contemplates a computer-implemented method for closed-loop behavioral qualification and enforcement in digital advertising, comprising, executing, on at least one processor configured to perform a predefined set of basic operations in response to receiving a corresponding basic computer executable instruction selected from a predefined native instruction set of codes, steps of: executing signature-based reconciliation through a reconciliation system, computing qualified attribution scores through a QAS generator, performing non-PII matching by correlating engagement events, capturing engagement verification through beacons, and enforcing pre-spend qualification through compliance gateway.

In another aspect of an embodiment of the present invention, the step of executing signature-based reconciliation through reconciliation system may be implemented by any one or a combination of the following steps: receiving engagement verification data from beacon data system, generating behavioral fingerprints using one-way hash functions, comparing the fingerprints against cohort signatures using similarity metrics, and determining reconciliation confidence through match results.

In another aspect of an embodiment of the present invention, the step of computing qualified attribution scores through QAS generator may be based on any one or a combination of: attribution confidence, detecting deviations between pre-qualification scores and post-engagement outcomes, and generating feedback signals through feedback loop for qualification refinement.

In another aspect of an embodiment of the present invention, the step of performing non-PII matching may be done by correlating engagement events through a beacon correlation matrix across multiple conversion paths implementing multi-touch attribution without personally identifiable information, where the process may use privacy-preserving techniques comprising differential privacy.

In another aspect of an embodiment of the present invention, the step of capturing engagement verification may be done through beacons by capturing beacon events and transmitting data asynchronously through asynchronous transmission, while generating cryptographic nonces through nonce-based cryptographic signing for replay prevention.

In another aspect of an embodiment of the present invention, the step of enforcing pre-spend qualification through the compliance gateway may be done by any one or a combination of: intercepting incoming bid requests before auction processing, retrieving BQS scores from a pre-spend qualification engine, evaluating requests through gating logic processor against qualification policies from policy rules engine, authorizing qualified requests through token generator generating cryptographic authorization tokens, and blocking unqualified requests through blocking notifications before budget commitment.

In another aspect of an embodiment of the present invention, the computer-implemented method for closed-loop behavioral qualification and enforcement in digital advertising may include the step of logging verified transactions through an immutable ledger, which may be implemented by any one or a combination of: recording enforcement decisions in append-only logs, generating digital signatures through Ed25519 signing, creating tamper-evident chains through Merkle tree builder with event chaining, and exposing verification interfaces through a verification API.

In another aspect of an embodiment of the present invention, the computer-implemented method for closed-loop behavioral qualification and enforcement in digital advertising may include the step of detecting fraud through fraud enforcement architecture, where this fraud detection may be done by any one or a combination of: aggregating behavioral signals from behavioral analysis module, performing anomaly detection through pattern recognizer, executing multi-vector analysis through fraud scoring engine employing isolation forest, gradient boosting, and neural networks, computing fraud probability scores, and generating suppression signals through a suppression controller.

In another aspect of an embodiment of the present invention, the computer-implemented method for closed-loop behavioral qualification and enforcement in digital advertising may include the step of managing consent and privacy through consent module may be done by any one or a combination of: enforcing jurisdiction-specific policies through jurisdiction-specific logic, managing consent through opt-in flows and opt-out mechanisms, implementing consent-gated qualification through policy enforcement, and executing cascade deletion processes.

In another aspect of an embodiment of the present invention, the computer-implemented method for closed-loop behavioral qualification and enforcement in digital advertising may include the step of implementing asynchronous API processing through API interaction sequence, where the API processing may be done by any one or a combination of: exposing non-blocking endpoints through a qualification engine and a beacon service, processing requests asynchronously, maintaining correlation identifiers, and providing circuit breaker mechanisms.

In another aspect of an embodiment of the present invention, the computer-implemented method for closed-loop behavioral qualification and enforcement in digital advertising may include the step of optimizing data structure performance, where this optimizing step may be done by any one or a combination of: storing qualification state(s) in tenant data stores, implementing distributed caching through weighted fair queuing, utilizing an interval-tree structure for policy access, and maintaining event buffers through event batching.

In another aspect of an embodiment of the present invention, the computer-implemented method for closed-loop behavioral qualification and enforcement in digital advertising may include the step of executing machine learning behavioral analysis, where this step may be done by any one or a combination of: analyzing reconciliation outcomes from reconciliation outputs to identify qualification errors within policy-defined tolerance thresholds, computing recalibration recommendations through a recalibration trigger subject to governance constraints, applying reinforcement learning through reinforcement updater and Q-learning bounded by advertiser-defined policy rules, and updating fraud models through retraining constrained by regulatory compliance requirements.

In another aspect of an embodiment of the present invention, the computer-implemented method for closed-loop behavioral qualification and enforcement in digital advertising may include the step of optimizing through a closed-loop feedback system, where this optimization may be done by any one or a combination of: collecting verified outcome data from reconciliation outputs, computing performance metrics through model updates, generating parameter adjustments through BQS Unity Optimizer, and propagating updated parameters through model parameters.

In another aspect of an embodiment of the present invention, the computer-implemented method for closed-loop behavioral qualification and enforcement in digital advertising validates engagements against pre-qualification requirements, prevents advertising waste before budget commitment, creates immutable audit trails, and maintains operational responsiveness while continuously improving qualification accuracy.

In another aspect of an embodiment of the present invention, the computer-implemented method enables any one or more of: engagement validation against pre-qualification requirements, advertising waste prevention before budget commitment, creation of immutable audit trail, maintenance of operational responsiveness while continuously improving qualification accuracy.

In another aspect of an embodiment of the present invention, the signature-based reconciliation execution may be by use of one-way hash functions, where the one-way hash functions comprise any one of: SHA-256 hashing, SHA-3 algorithms, or BLAKE2 algorithms.

In another aspect of an embodiment of the present invention, the signature-based reconciliation execution may be by comparing generated behavioral fingerprints against cohort signatures using similarity metrics, where the similarity metrics comprise any one of: cosine distance, Jaccard index, Euclidean distance measurements, or weighted combinations thereof.

In another aspect of an embodiment of the present invention, the step of enforcing pre-spend qualification through compliance gateway may be implemented by authorizing qualified requests through a token generator generating cryptographic authorization tokens, where the cryptographic authorization tokens comprise any one or a combination of: transaction hashes using SHA-256, digital signatures using Ed25519 signing, expiration timestamps.

In another aspect of an embodiment of the present invention, the executed multi-vector analysis through the fraud scoring engine comprises ensemble methods which comprise of any one of or combinations of: isolation forest code, gradient boosting classifiers, neural network pattern recognizers.

In another aspect of an embodiment of the present invention, the privacy-preserving techniques comprise any one of: differential privacy mechanisms with a privacy budget manager, k-anonymity enforcement, or ephemeral identifier expiration.

In another aspect of an embodiment of the present invention, the computer-implemented method for closed-loop behavioral qualification and enforcement in digital advertising may include policy-constrained reinforcement learning computer-implemented methods, where the reinforcement learning computer-implemented methods comprise of any one of computer-implemented methods directed to: policy gradient methods operating within advertiser-defined optimization boundaries, Q-learning functionality with scoring parameters bounded by governance rules, or ensemble model updating through ensemble methods subject to regulatory compliance constraints.

In another aspect of an embodiment of the present invention, the distributed caching comprises multi-tier cache hierarchies with cache storage, log replication across availability zones, and tenant data stores.

In another aspect of an embodiment of the present invention, the feedback signals through the feedback loop comprise any one of: BQS weighting factors adjustments, qualification thresholds calibration recommendations, or fraud detection sensitivity adjustments.

In another aspect of an embodiment of the present invention, the pre-spend qualification enforcement through the compliance gateway comprises graduated enforcement through a suppression controller, where the graduated enforcement comprises any one of: bid blocking, rate limiting, or value reduction.

A further aspect of an embodiment of the present invention contemplates a computer program product comprising a non-transitory computer readable medium having computer executable instructions stored therein to perform operations for closed-loop behavioral qualification and enforcement in digital advertising comprising executing, on at least one processor configured to perform a predefined set of basic operations in response to receiving a corresponding basic computer executable instruction selected from a predefined native instruction set of codes, computer readable program code for: executing signature-based reconciliation through a reconciliation system, computing qualified attribution scores through a QAS generator, performing non-PII matching by correlating engagement events, capturing engagement verification through beacons, and enforcing pre-spend qualification through a compliance gateway.

In a further aspect of an embodiment of the present invention, the computer program product further comprises computer readable program code for enabling any one or more of: engagement validation against pre-qualification requirements, advertising waste prevention before budget commitment, creation of immutable audit trail, maintenance of operational responsiveness while continuously improving qualification accuracy.

In a further aspect of an embodiment of the present invention, the computer program product further comprises computer readable program code for logging verified transactions through an immutable ledger, detecting fraud through fraud enforcement architecture, managing consent and privacy through consent module, implementing asynchronous API processing through API interaction sequence, optimizing data structure performance, executing machine learning behavioral analysis, and optimizing through closed-loop feedback system.

In a further aspect of an embodiment of the present invention, the logging of verified transactions through an immutable ledger may be implemented by execution of computer readable program code for any one or a combination of: recording enforcement decisions in append-only logs, generating digital signatures through Ed25519 signing, creating tamper-evident chains through Merkle tree builder with event chaining, and exposing verification interfaces through verification API, where the aforesaid computer readable program code may be resident on the computer program product.

In a further aspect of an embodiment of the present invention, the operation of detecting fraud through fraud enforcement architecture may be implemented by execution of computer readable program code for any one or a combination of: aggregating behavioral signals from behavioral analysis module, performing anomaly detection through pattern recognizer, executing multi-vector analysis through fraud scoring engine employing isolation forest, gradient boosting, and neural networks, computing fraud probability scores, and generating suppression signals through suppression controller, where the aforesaid computer readable program code may be resident on the computer program product.

In a further aspect of an embodiment of the present invention, the operation of managing consent and privacy through consent module may be implemented by execution of computer readable program code for any one or a combination of: enforcing jurisdiction-specific policies through jurisdiction-specific logic, managing consent through opt-in flows and opt-out mechanisms, implementing consent-gated qualification through policy enforcement, and executing cascade deletion processes, where the aforesaid computer readable program code may be resident on the computer program product.

In a further aspect of an embodiment of the present invention, the operation of implementing asynchronous API processing through API interaction sequence may be implemented by execution of computer readable program code for any one or a combination of: exposing non-blocking endpoints through qualification engine and beacon service, processing requests asynchronously, maintaining correlation identifiers, and providing circuit breaker mechanisms, where the aforesaid computer readable program code may be resident on the computer program product.

In a further aspect of an embodiment of the present invention, the operation of optimizing data structure performance may be implemented by execution of computer readable program code for any one or a combination of: storing qualification state in tenant data stores, implementing distributed caching through weighted fair queuing, utilizing interval-tree structure for policy access, and maintaining event buffers through event batching, where the aforesaid computer readable program code may be resident on the computer program product.

In a further aspect of an embodiment of the present invention, the operation of executing machine learning behavioral analysis may be implemented by execution of computer readable program code for any one or a combination of: analyzing reconciliation outcomes from reconciliation outputs to identify qualification errors within policy-defined tolerance thresholds, computing recalibration recommendations through a recalibration trigger subject to governance constraints, applying reinforcement learning through reinforcement updater and Q-learning bounded by advertiser-defined policy rules, and updating fraud models through retraining constrained by regulatory compliance requirements, where the aforesaid computer readable program code may be resident on the computer program product.

In a further aspect of an embodiment of the present invention, the operation of optimizing through closed-loop feedback system may be implemented by execution of computer readable program code for any one or a combination of: collecting verified outcome data from reconciliation outputs, computing performance metrics through model updates, generating parameter adjustments through BQS Unity Optimizer, and propagating updated parameters through model parameters, where the aforesaid computer readable program code may be resident on the computer program product.

In a further aspect of an embodiment of the present invention, the computer readable program code for signature-based reconciliation execution comprises computer readable code for one-way hash functions, where the one-way hash functions comprise any one of: SHA-256 hashing, SHA-3 algorithms, or BLAKE2 algorithms.

In a further aspect of an embodiment of the present invention, the computer readable program code for signature-based reconciliation execution comprises computer readable code for comparing generated behavioral fingerprints against cohort signatures using similarity metrics, where the similarity metrics comprise any one of: cosine distance, Jaccard index, Euclidean distance measurements, or weighted combinations thereof.

In a further aspect of an embodiment of the present invention, the computer readable program code for enforcing pre-spend qualification through compliance gateway comprises computer readable code for authorizing qualified requests through a token generator generating cryptographic authorization tokens, where the cryptographic authorization tokens comprise any one or a combination of: transaction hashes using SHA-256, digital signatures using Ed25519 signing, expiration timestamps.

In a further aspect of an embodiment of the present invention, the computer readable program code for detecting fraud through fraud enforcement architecture comprises computer readable program code for executing multi-vector analysis through a fraud scoring engine.

In a further aspect of an embodiment of the present invention, the computer readable program code for detecting fraud comprises computer readable program code for ensemble methods which comprise computer readable program code for any one or combinations of: isolation forest code, gradient boosting classifiers, neural network pattern recognizers.

In a further aspect of an embodiment of the present invention, the computer readable program code for privacy-preserving techniques comprises computer readable program code executable for implementation of any one of: differential privacy mechanisms with a privacy budget manager, k-anonymity enforcement, or ephemeral identifier expiration.

In a further aspect of an embodiment of the present invention, the computer program product for closed-loop behavioral qualification and enforcement in digital advertising may include computer readable program code for policy-constrained reinforcement learning, where the reinforcement learning code comprises of computer readable program code directed to any one of: policy gradient methods operating within advertiser-defined optimization boundaries, Q-learning functionality with scoring parameters bounded by governance rules, or ensemble model updating through ensemble methods subject to regulatory compliance constraints.

In a further aspect of an embodiment of the present invention, the computer readable program code for distributed caching comprises computer readable program code for multi-tier cache hierarchies with cache storage, log replication across availability zones, and tenant data stores.

In a further aspect of an embodiment of the present invention, the computer readable program code for feedback signals through the feedback loop comprise computer readable program code for any one of: BQS weighting factors adjustments, qualification thresholds calibration recommendations, or fraud detection sensitivity adjustments.

In a further aspect of an embodiment of the present invention, the computer readable program code for pre-spend qualification enforcement through the compliance gateway comprises computer readable code for graduated enforcement through a suppression controller, where the graduated enforcement comprises any one of: bid blocking, rate limiting, or value reduction.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 illustrates a system-wide architecture of the closed-loop enforcement platform according to aspects of embodiments of the present invention.

FIG. 2 illustrates an end-to-end closed-loop workflow showing the sequential process stages according to aspects of embodiments of the present invention.

FIG. 3 illustrates an API sequence diagram demonstrating interaction between DSPs, compliance gateway, qualification engine, beacon service, and reconciliation engine according to aspects of embodiments of the present invention.

FIG. 4 illustrates a pre-spend compliance gateway architecture showing different components according to aspects of embodiments of the present invention.

FIG. 5 illustrates a closed-loop enforcement system architecture according to aspects of embodiments of the present invention.

FIG. 6 illustrates a real-time sponsorship matching engine according to aspects of embodiments of the present invention.

FIG. 7 illustrates a conflict-free bidding middleware showing exclusivity rule sets according to aspects of embodiments of the present invention.

FIG. 8 illustrates a multi-tenant orchestration engine architecture according to aspects of embodiments of the present invention.

FIG. 9 illustrates enterprise fraud detection clusters with distributed detection nodes according to aspects of embodiments of the present invention.

FIG. 10 illustrates an engagement verification beacon deployment architecture showing multiple integration methods according to aspects of embodiments of the present invention.

FIG. 11 illustrates a signature-based reconciliation engine showing behavioral fingerprint generation according to aspects of embodiments of the present invention.

FIG. 12 illustrates a qualified attribution score generator architecture according to aspects of embodiments of the present invention.

FIG. 13 illustrates a dynamic user segmentation module showing real-time tier assignment according to aspects of embodiments of the present invention.

FIG. 14 illustrates a cross-platform loyalty synchronization engine according to aspects of embodiments of the present invention.

FIG. 15 illustrates a consent and privacy management module architecture according to aspects of embodiments of the present invention.

FIG. 16 illustrates a closed-loop feedback cycle showing reconciliation outputs according to aspects of embodiments of the present invention.

FIG. 17 illustrates an audit cryptography subsystem architecture according to aspects of embodiments of the present invention.

FIG. 18 illustrates a fallback and graceful degradation subsystem according to aspects of embodiments of the present invention.

### DETAILED DESCRIPTION OF THE INVENTION

The present invention provides a cryptographically-attested closed-loop behavioral verification and reconciliation system for digital advertising that prevents waste through pre-spend behavioral qualification, mandatory compliance gating, engagement verification, signature-based reconciliation, and recursive policy optimization. The system operates as middleware positioned between demand-side platforms (DSPs) and advertising exchanges, implementing the BQS Unity Framework wherein all operations are orchestrated through a single unified metric rather than multiple independent variables.

Current industry verification solutions rely primarily on post-spend detection and remediation, employing rule-based heuristics that identify waste after budget commitment. By implementing pre-spend gating coupled with cryptographic attestation, signature-based reconciliation, and closed-loop feedback, the present invention transforms digital advertising from reactive detection to proactive prevention.

Global Operating Principles: Throughout this system, BQS serves as the single orchestration metric-fraud detection, consent status, reconciliation outcomes, and all enforcement decisions modulate BQS rather than operating as independent variables. All behavioral data processing uses ephemeral, pseudonymous identifiers without cookies, device identifiers, or personally identifiable information. Cryptographic operations employ Ed25519 signatures and SHA-256 hashing in preferred embodiments, with standard or post-quantum alternatives permitted (detailed in Alternative Embodiments section). Reference numerals in the drawings correspond to elements described in this specification.

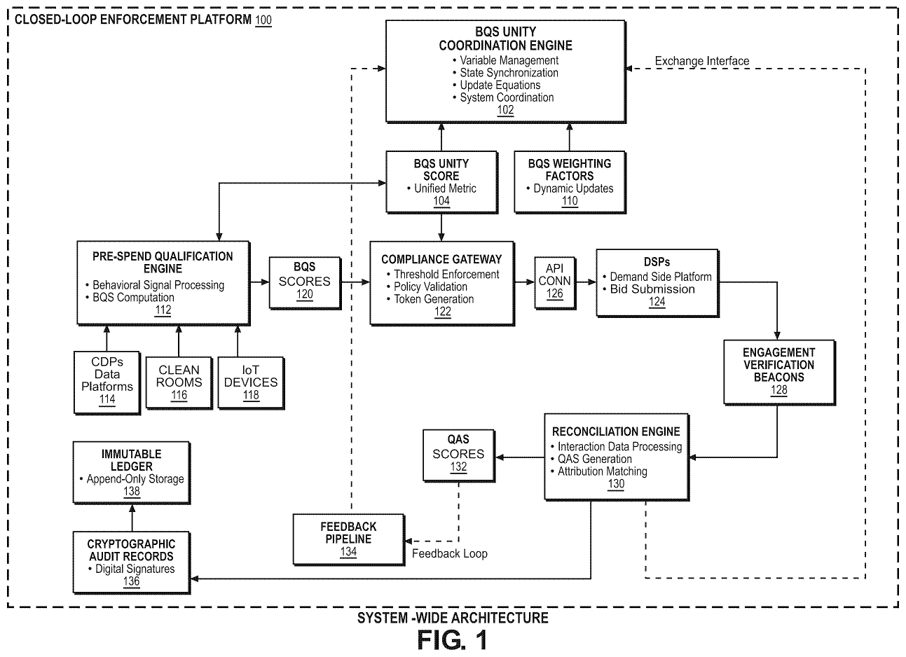

Referring now to FIG. 1, a closed-loop enforcement platform 100, is shown according to aspects of embodiments of the present invention. Closed-loop enforcement platform [100] comprises 18 interconnected elements implementing the BQS Unity Framework for pre-spend behavioral qualification and closed-loop verification. Platform [100] contains BQS Unity Coordination Engine [102], pre-spend qualification engine [112], and immutable ledger [138], orchestrating all operations through a single unified BQS metric rather than multiple independent variables.

BQS Unity Coordination Engine [102] manages variable management, state synchronization, and system coordination, receiving behavioral signals from pre-spend qualification engine [112] and outputting BQS Unity Score [104] and BQS Weighting Factors [110]. The BQS is computed according to the formula:

BQS=f(User engagement, Model efficiency, Enforcement strictness, Content relevance)×BQS Weighting Factors.

BQS Unity Score [104] serves as the single orchestration value, receiving from engine [102] and outputting to BQS scores [120] and compliance gateway [126] via connection [122]. BQS Weighting Factors [110] implement dynamic updates based on reconciliation outcomes and fraud detection signals, receiving from engine [102] and outputting to exchange interface [124].

Pre-spend qualification engine [112] processes behavioral signals from CDPs [114], clean rooms [116], and IoT devices [118], computing BQS values [120] that feed compliance gateway [126] and outputting to BQS Unity Coordination Engine [102]. BQS scores [120] represent computed qualification values, receiving from engine [112] and outputting to compliance gateway [126] for pre-spend enforcement gating.

Compliance gateway [126] implements mandatory pre-spend enforcement through threshold enforcement, policy validation, and token generation, receiving BQS scores [120] and BQS Unity Score [104] via connection [122], either generating cryptographic authorization tokens for qualified requests or blocking unqualified requests before budget commitment per claims 13(a), 15, 20, 33(e), 43(e). Exchange interface [124] manages interactions with advertising exchanges, receiving from BQS Weighting Factors [110] and outputting to DSPs [128]. DSPs [128] submit bid requests receiving enforcement decisions from compliance gateway [126] and exchange interface [124], submitting bids with embedded tokens and outputting winning bids to reconciliation engine [140].

Reconciliation engine [140] performs interaction data processing, QAS generation, and attribution matching, receiving engagement data from DSPs [128], generating QAS scores [132] through signature-based reconciliation comparing behavioral fingerprints [1102] against cohort signatures [1110] using similarity metrics [1114], detecting deviations [1202] between pre-qualification scores [1204] and post-engagement outcomes [1206], implementing claims 1(a), 13, 23, 33(a), 43(a). QAS scores [132] receive attribution confidence from reconciliation engine and output to feedback pipeline [134].

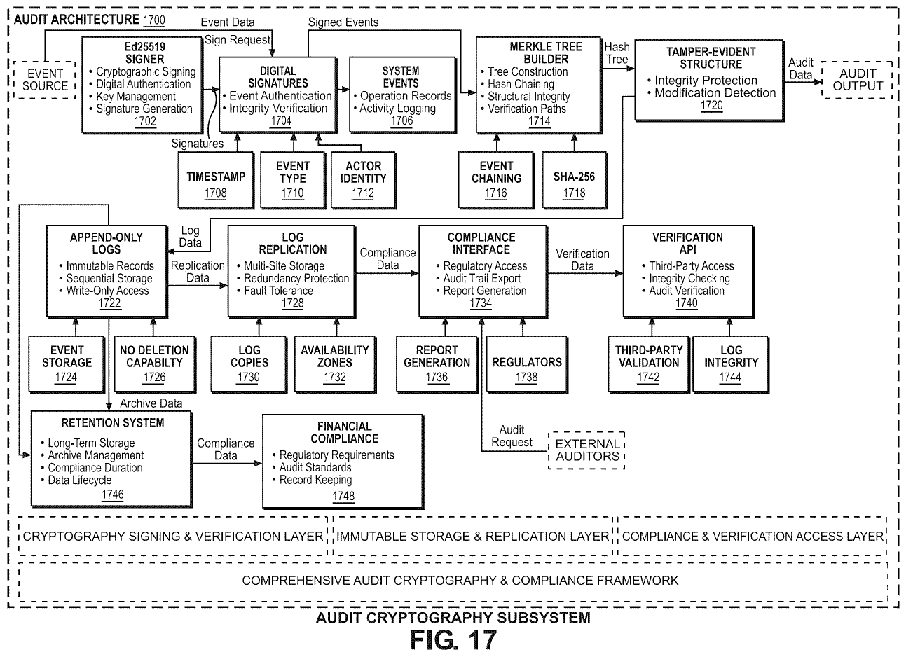

Feedback pipeline propagates reconciliation results, receiving QAS scores [132] and outputting parameter updates to immutable ledger [138], implementing continuous improvement [1242] per aspects of embodiments of the present invention. Immutable ledger implements append-only storage with digital signatures and cryptographic hash chaining, receiving from feedback pipeline [134] and outputting cryptographic audit records [136], using (referring now to audit cryptography subsystem architecture 1700 shown in FIG. 17) append-only logs [1722], event chaining [1716] through Merkle tree builder [1714] with SHA-256 [1718].

Platform [100] with BQS Unity Coordination Engine [102] implements a unified BQS framework. Pre-spend qualification engine [112] with compliance gateway [126] implements a pre-spend enforcement and audit infrastructure system, a performance-optimized machine learning system, and computer-implemented methods and computer readable program product associated therein. Reconciliation engine [140] implements signature-based reconciliation per aspects of embodiments of the present invention. Feedback pipeline [134] implements closed-loop feedback per aspects of embodiments of the present invention. Immutable ledger [138] with cryptographic audit records [136] implements verified transaction logging per aspects of embodiments of the present invention. The closed-loop enforcement platform system demonstrates functional interdependence where all components contribute to a unified BQS framework.

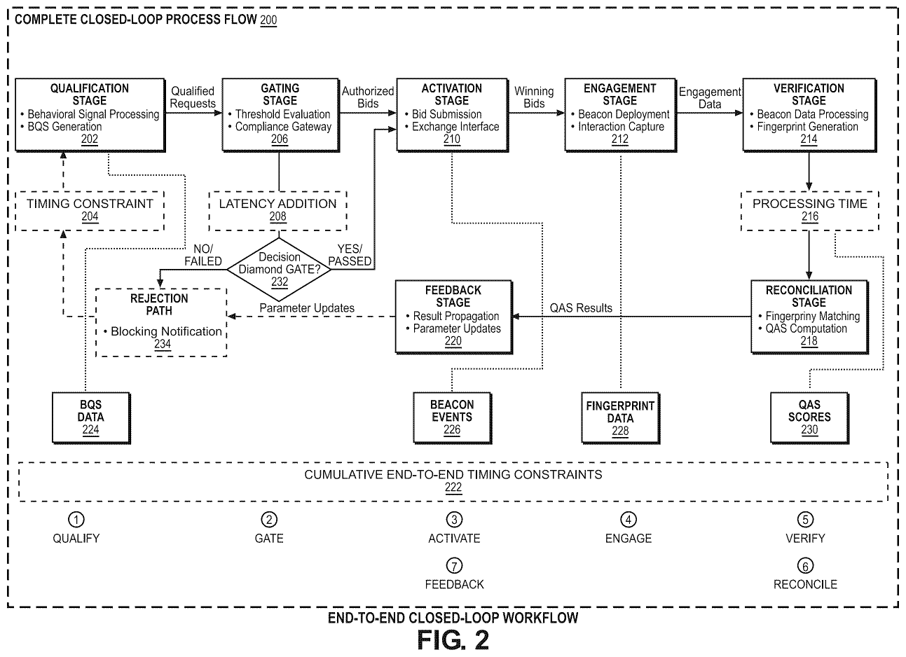

Referring now to FIG. 2, an end-to-end closed-loop workflow [200] showing sequential process stages, is shown according to aspects of embodiments of the present invention. Closed-loop process flow [200] comprises sequential stages demonstrating pre-spend prevention, cryptographic attestation, signature-based reconciliation, 1 and feedback optimization, implementing the preventive processing paradigm where qualification occurs before spend commitment.

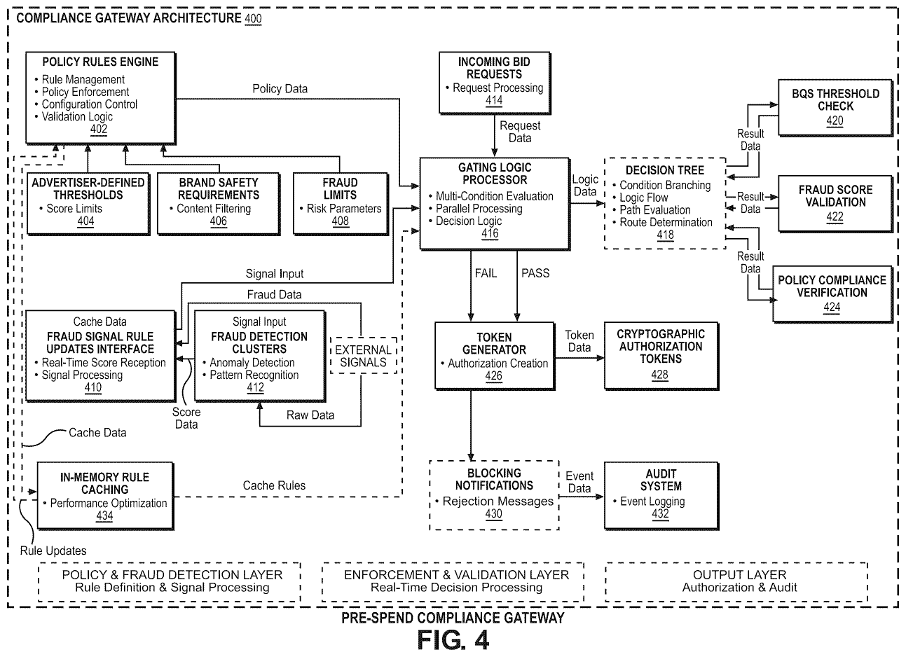

Qualification stage [202] performs behavioral signal processing generating BQS scores through pre-spend qualification engine [112] (FIG. 1) with low-latency processing per aspects of embodiments of the present invention, outputting qualified requests to gating stage [206] and receiving blocking notifications from feedback stage [220] via rejection path. Timing constraint [204] ensures BQS computation completes within real-time bidding constraints. Gating stage [206] evaluates BQS scores against qualification thresholds [1620] through compliance gateway [126] with gating logic processor [416] (FIG. 4), outputting authorized bids to activation stage [210] or routing failed requests to rejection path, physically blocking unqualified requests through blocking notifications [430] (FIG. 4) per aspects of embodiments of the present invention. Latency condition [208] maintains minimal overhead per aspects of embodiments of the present invention.

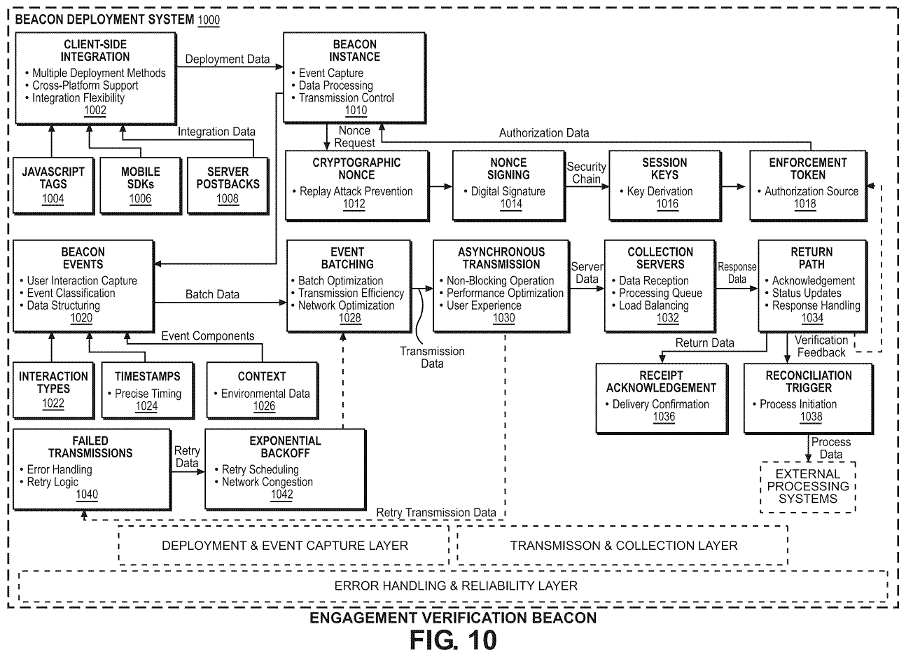

Activation stage [210] submits bids with embedded cryptographic authorization tokens [428] generated through token generator [426] (both referring to FIG. 4), outputting winning bids to engagement stage [212]. Engagement stage [212] deploys engagement verification beacons [1010] capturing beacon events [1020] including interaction types [1022], timestamps [1024], and context [1026](referring to FIG. 10), outputting engagement data to verification stage [214].

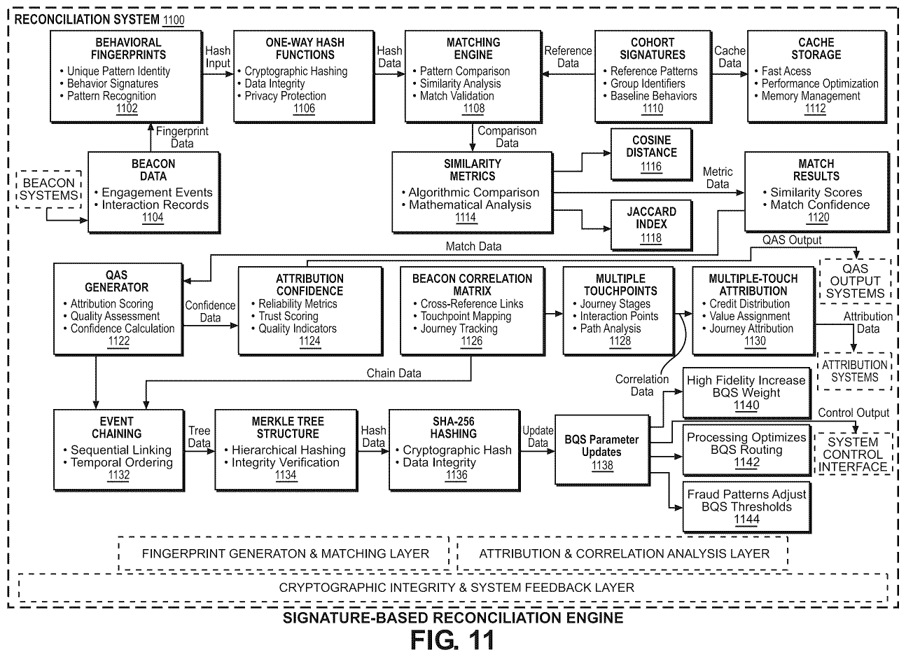

Verification stage [214] processes beacon data [1104] generating behavioral fingerprints [1102] through one-way hash functions [1106](referring to FIG. 11) per aspects of embodiments of the present invention, outputting fingerprint data to reconciliation stage [218]. Processing time [216] maintains bounded latency. Reconciliation stage [218] implements signature-based reconciliation through reconciliation engine [1100] comparing fingerprints [1102] against cohort signatures [1110] using similarity metrics [1114] comprising cosine distance [1116] or Jaccard index [1118], generating QAS values through qualified attribution score generator [1122], detecting deviations [1202] between pre-qualification scores [1204] and post-engagement outcomes [1206](referring to FIGS. 11 & 12), outputting QAS results to feedback stage [220].

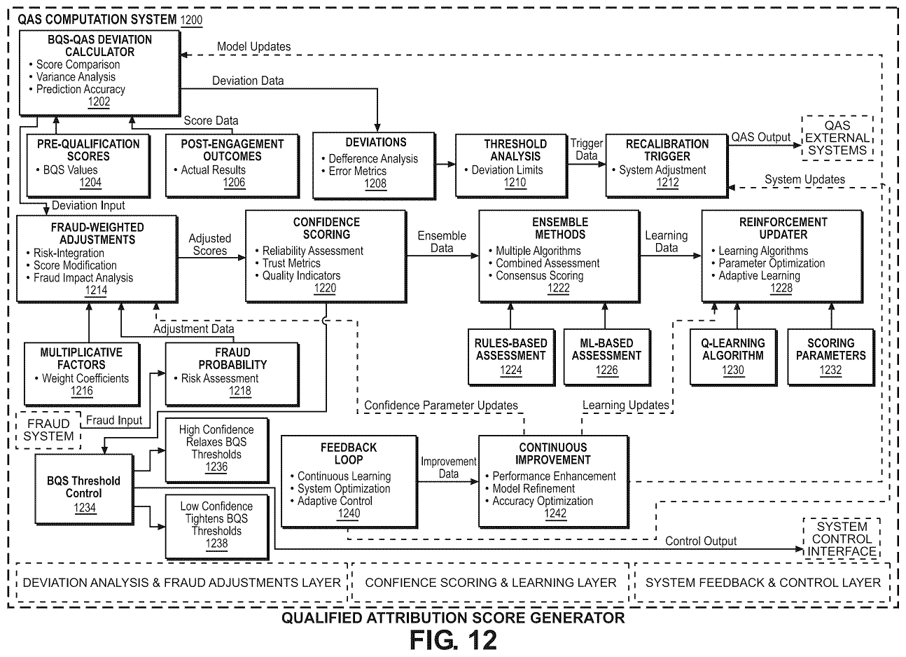

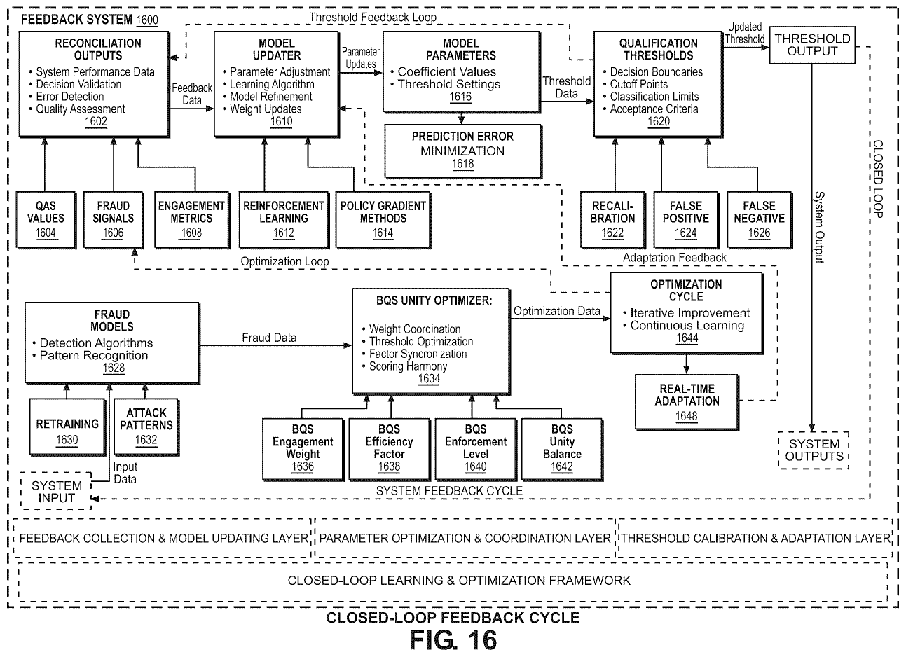

Feedback stage [220]propagates reconciliation outcomes through feedback loop [1240], updating BQS weighting factors [110](FIG. 1) and qualification thresholds [1620](FIG. 16) through BQS parameter updates [1138](FIG. 11), implementing continuous improvement [1242](FIG. 12) per aspects of embodiments of the present invention. Cumulative end-to-end timing constraint [222] ensures complete closed-loop operates within real-time bounds. Phase markers \textcircled{1}-\textcircled{8} identify workflow progression from QUALIFY through RECONCILE to FEEDBACK.

Sequential stages implement complete method flow per aspects of embodiments of the present invention. Qualification stage [202] with gating stage [206] implements pre-spend enforcement per aspects of embodiments of the present invention. Engagement stage [212] with verification stage [214] implements engagement verification beacons per aspects of embodiments of the present invention. Reconciliation stage [218] implements signature-based reconciliation per aspects of embodiments of the present invention. Feedback stage [220] implements closed-loop feedback per aspects of embodiments of the present invention, while Timing constraints [204], [208], [216], [222] support low-latency processing per aspects of embodiments of the present invention.

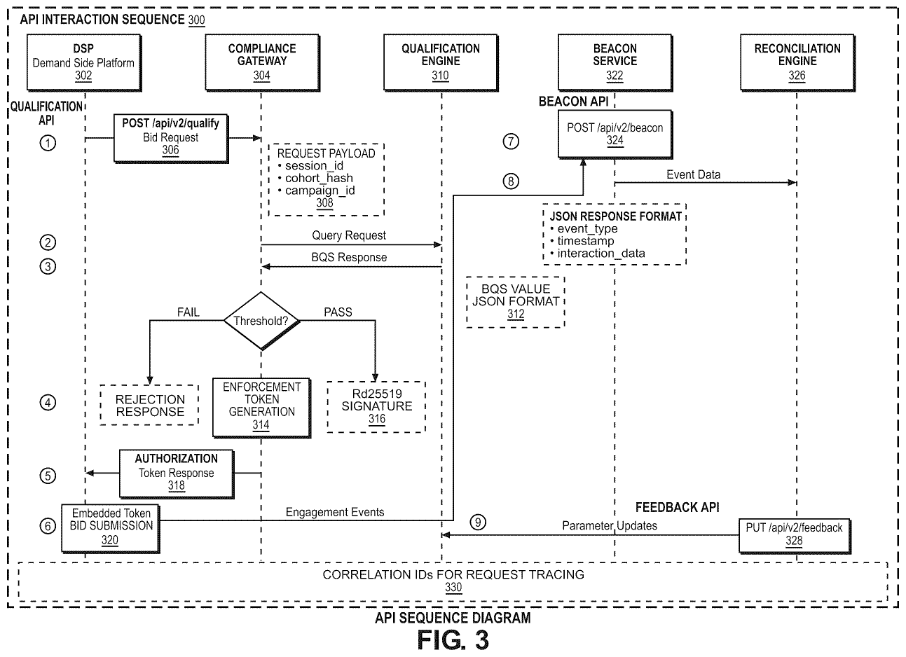

Referring to FIG. 3, an API interaction sequence [300] demonstrating interaction between DSPs, compliance gateway, qualification engine, beacon service, and reconciliation engine is shown according to aspects of embodiments of the present invention. API interaction sequence [300] comprises elements demonstrating middleware integration through asynchronous API architecture exposing non-blocking communication endpoints.

DSP [302] initiates POST/api/v2/qualify [306] requests to compliance gateway [304], receives authorization [318] responses with cryptographic authorization tokens [428](FIG. 4) or rejection responses, and outputs bid submissions [320] with embedded tokens. Compliance gateway [304] receives bid requests [306], outputs request payload [308] to qualification engine [310], executes THRESHOLD decision comparing BQS values against qualification thresholds [1620], generates enforcement token [314] with Ed25519 signature [316] on PASS path or outputs rejection response on FAIL path, implementing mandatory pre-spend gating per aspects of embodiments of the present invention.

Qualification engine [310] computes BQS scores [120](FIG. 1) through pre-spend qualification engine [112](FIG. 1) components, receiving request payload [308] and outputting BQS response to compliance gateway [304] and BQS value JSON format [312] to beacon service [322]. Enforcement token generation [314] creates cryptographic authorization tokens through token generator [426] with Ed25519 signature [316] per aspects of embodiments of the present invention. Authorization [318] returns tokens to DSP [302], while embedded token [320] enables downstream verification that pre-spend gating was applied.

Beacon service [322] receives BQS value JSON format [312] from qualification engine [310] and POST/api/v2/beacon [324] engagement events captured through JavaScript tags [1004], mobile SDKs [1006], or server postbacks [1008], outputting event data to reconciliation engine [326], implementing Claims 1(d), 13(b), 33(d), 43(d). Reconciliation engine [326] implements signature-based reconciliation [1100] comparing behavioral fingerprints [1102] against cohort signatures [1110], computing QAS values through qualified attribution score generator [1122](referring to FIG. 11), detecting deviations [1202](FIG. 12), and outputting PUT /api/v2/feedback [328] parameter updates implementing feedback loop [1240](FIG. 12) per aspects of embodiments of the present invention.

Correlation identifiers [330] span entire workflow [300] enabling end-to-end observability, propagating through all API calls linking pre-spend qualification decisions with post-engagement outcomes and feedback updates. Sequence markers \textcircled{1}-\textcircled{9} demonstrate complete API interaction from qualification through feedback. Alternative embodiments may use gRPC, message-queue RPC, WebSocket connections, or other remote procedure mechanisms per aspects of embodiments of the present invention.

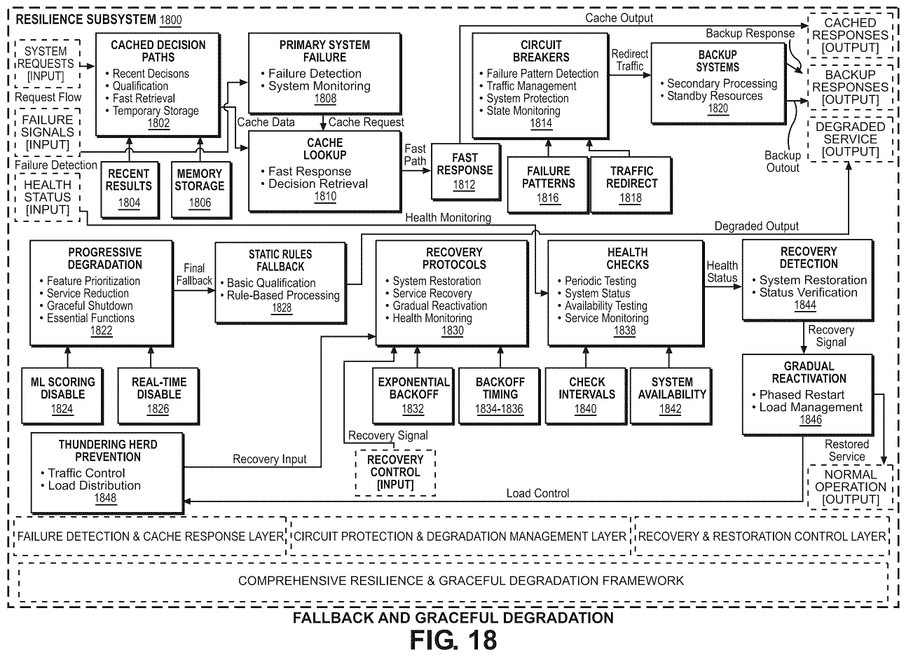

API interaction sequence [300] implements asynchronous API architecture per aspects of embodiments of the present invention with circuit breaker mechanisms [1814](FIG. 18). Compliance gateway [304] with qualification engine [310] implements enforcement proxy gateway per aspects of embodiments of the present invention. Enforcement token generation [314] with Ed25519 signature [316] implements cryptographic authorization tokens per aspects of embodiments of the present invention. Beacon service [322] implements engagement verification per aspects of embodiments of the present invention. Reconciliation engine [326] with feedback API [328] implements signature-based reconciliation and closed-loop feedback per aspects of embodiments of the present invention. Correlation identifiers [330] enable end-to-end traceability supporting system observability and audit verification.

Referring now to FIG. 4, a pre-spend compliance gateway architecture [400] showing different components is shown according to aspects of embodiments of the present invention. Compliance gateway architecture [400] comprises seventeen (17) elements organized in three layers implementing mandatory pre-spend gating through policy enforcement, fraud detection integration, real-time decision logic, and cryptographic token generation.

### Policy & Fraud Detection Layer

Policy rules engine [402] manages rule management and policy enforcement, receiving from advertiser-defined thresholds [404] and brand safety requirements [406], outputting policy data to fraud limits [408] and gating logic processor [416], implementing configurable enforcement per aspects of embodiments of the present invention. Advertiser-defined thresholds [404] specify minimum BQS requirements, outputting cache data to fraud signal interface [410]. Brand safety requirements [406] specify content filtering rules inputting to policy rules engine [402]. Fraud limits [408] define risk parameters receiving from policy rules engine [402] and outputting to gating logic processor [416].

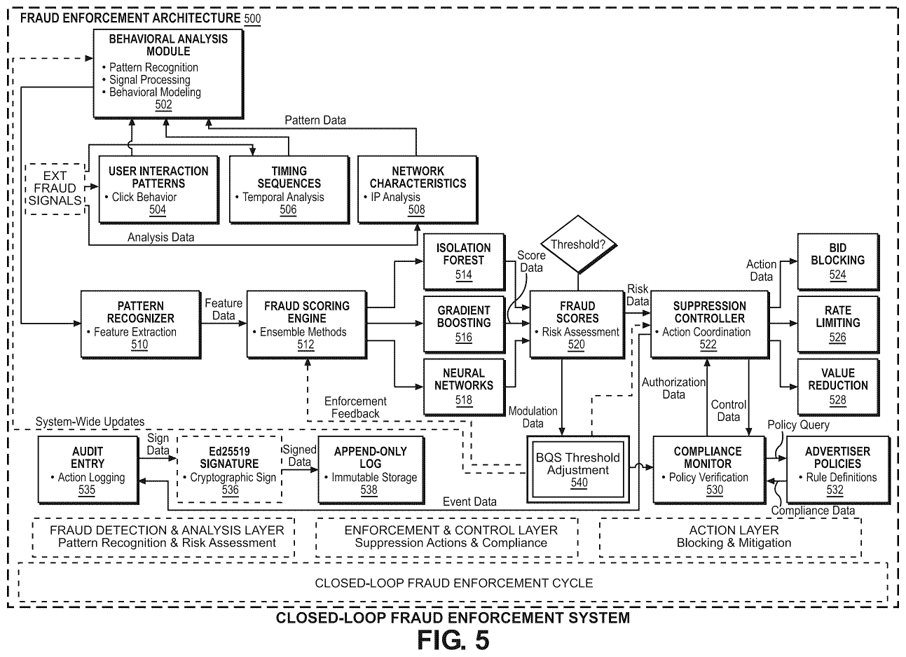

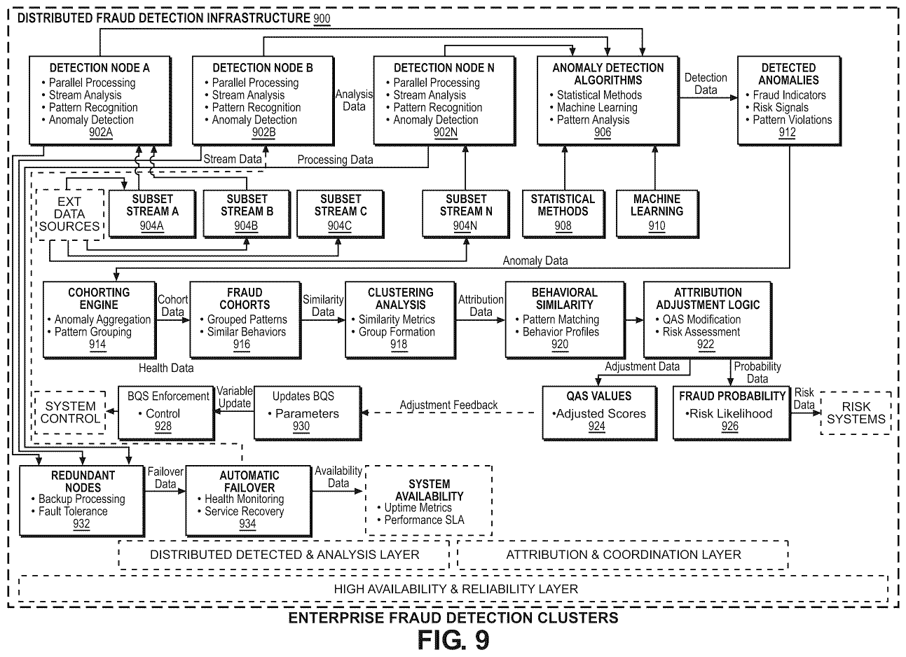

Fraud signal interface [410] performs real-time score reception, receiving from advertiser-defined thresholds [404] and outputting score data to fraud detection clusters [412]. Fraud detection clusters [412] implement anomaly/outlier rules with pattern recognition, receiving from fraud signal interface [410], comprising distributed detection nodes [902A-N](FIG. 9) employing isolation forest [514], gradient boosting [516], and neural networks [518](referring to FIG. 5), outputting fraud data to gating logic processor [416] and to in-memory rule caching [434], implementing ensemble methods per aspects of embodiments of the present invention. In-memory rule caching [434] maintains cached decision paths [1802] with recent results [1804](FIG. 18) supporting low-latency operation per aspects of embodiments of the present invention.

### Enforcement & Validation Layer

Incoming bid requests [414] output request data to gating logic processor [416]. Gating logic processor [416] performs multi-condition evaluation, receiving request data from incoming bid requests [414] and inputs from policy rules engine [402], fraud limits [408], fraud detection clusters [412], and external signals, outputting logic data to decision tree [418], outputting YES to token generator [426] or FAIL to blocking notifications [430]. Decision tree [418] implements parallel evaluation executing simultaneous BQS threshold check [420], fraud score validation [422], and policy compliance verification [424], receiving from gating logic processor [416] and outputting result data to the three validation paths. This parallel processing maintains low-latency while implementing comprehensive multi-criteria gating per aspects of embodiments of the present invention.

Token generator [426] creates cryptographically signed authorization tokens, receiving YES from gating logic processor [416] and outputting token data to cryptographic authorization tokens [428], implementing token generation through Ed25519 signing [1702](FIG. 17) per aspects of embodiments of the present invention. Cryptographic authorization tokens [428] contain transaction hashes using SHA-256 [1718] and digital signatures [1704], receiving from token generator [426], serving as verifiable proof Blocking notifications [430] comprise rejection messages, receiving FAIL from gating logic processor [416], outputting event data to audit system [432], implementing pre-spend blocking before budget commitment.

### Output Layer

Audit system [432] performs event logging, receiving blocking notifications [430], generating cryptographically signed audit records [136] through Ed25519 signing [1702], writing to immutable ledger [138] with append-only logs [1722](referring to FIGS. 1 & 17), and implementing verified transaction logging per aspects of embodiments of the present invention.

Compliance gateway architecture [400] implements enforcement proxy gateway [126] per aspects of embodiments of the present invention. Fraud detection clusters [412] implement enhanced fraud detection system [500] per aspects of embodiments of the present invention with ensemble methods per aspects of embodiments of the present invention. Gating logic processor [416] with decision tree [418] implements parallel evaluation. Token generator [426] with cryptographic authorization tokens [428] implements aspects of embodiments of the present invention. Audit system [432] implements aspects of embodiments of the present invention. The architecture demonstrates mandatory pre-spend enforcement through non-bypassable transaction-layer blocking.

Referring now to FIG. 5, a closed-loop enforcement system architecture [500] is shown according to aspects of embodiments of the present invention. Fraud enforcement architecture [500] comprises twenty-three (23) elements organized in three layers implementing the CLOSED-LOOP FRAUD ENFORCEMENT CYCLE wherein fraud detection directly adjusts the unified BQS metric per aspects of embodiments of the present invention.

### Fraud Detection & Analysis Layer

Behavioral analysis module [502] performs pattern recognition, receiving external fraud signals and outputting pattern data to user interaction patterns [504], timing sequences [506], network characteristics [508], and pattern recognizer [510], implementing multi-vector fraud analysis per aspects of embodiments of the present invention. User interaction patterns [504] capture click behavior receiving from behavioral analysis module [502] and external fraud signals, outputting feature data to pattern recognizer [510]. Timing sequences [506] perform temporal analysis receiving from behavioral analysis module [502]. Network characteristics [508] perform IP analysis receiving from behavioral analysis module [502]. Pattern recognizer [510] extracts features receiving from user interaction patterns [504] and outputting to fraud scoring engine [512].

Fraud scoring engine [512] implements ensemble methods [1222](FIG. 12) combining isolation forest [514], gradient boosting [516], and neural networks [518], receiving from pattern recognizer [510], outputting system-wide updates to the three algorithms and neural feedback to neural networks [518]. Isolation forest [514] implements anomaly detection outputting to THRESHOLD decision. Gradient boosting [516] implements iterative classification outputting score data to fraud scores [520]. Neural networks [518] implement deep learning outputting event data to append-only log [538].

Audit entry [534] performs action logging outputting sign data to Ed25519 signature [536]. Ed25519 signature [536] generates digital signatures [1704](FIG. 17) receiving from audit entry [534] and outputting signed data to append-only log [538] per aspects of embodiments of the present invention. Append-only log [538] implements immutable storage receiving from neural networks [518] and Ed25519 signature [536], using append-only logs [1722] with event chaining [1716] and SHA-256 [1718], implementing immutable ledger [138](referring to FIGS. 1 & 17) per aspects of embodiments of the present invention.

### Enforcement & Control Layer

Fraud scores [520] represent risk assessment receiving score data from gradient boosting [516], outputting to THRESHOLD decision and risk data to suppression controller [522]. THRESHOLD decision evaluates fraud scores against fraud limits [408], routing to suppression controller [522] or BQS threshold adjustment [540]. Suppression controller [522] performs action coordination implementing graduated enforcement per aspects of embodiments of the present invention receiving from fraud scores [520], outputting control data to compliance monitor [530] and action data to bid blocking [524], rate limiting [526], and value reduction [528].

Compliance monitor [530] performs policy verification receiving from suppression controller [522], exchanging policy query and compliance data with advertiser policies [532]. BQS threshold adjustment [540] receives from THRESHOLD decision, tightening qualification thresholds [1620](FIG. 16) system-wide, implementing unified scoring governance per aspects of embodiments of the present invention, demonstrating functional interdependence wherein fraud adjusts the single BQS metric through feedback loop [1240](FIG. 12).

### Action Layer

Bid blocking [524], rate limiting [526], and value reduction [528] implement graduated enforcement actions, receiving action data from suppression controller [522]. Fraud enforcement architecture [500] implements enhanced fraud detection system per aspects of embodiments of the present invention. Behavioral analysis module [502] implements multi-vector fraud analysis per aspects of embodiments of the present invention. Fraud scoring engine [512] with ensemble methods combining isolation forest [514], gradient boosting [516], and neural networks [518] implements aspects of embodiments of the present invention. Suppression controller [522] with graduated enforcement comprising bid blocking [524], rate limiting [526], and value reduction [528] implements aspects of embodiments of the present invention. BQS threshold adjustment [540] implements aspects of embodiments of the present invention, demonstrating functional interdependence. The architecture demonstrates closed-loop fraud enforcement wherein detection continuously optimizes prevention through feedback loop [1240](FIG. 12).

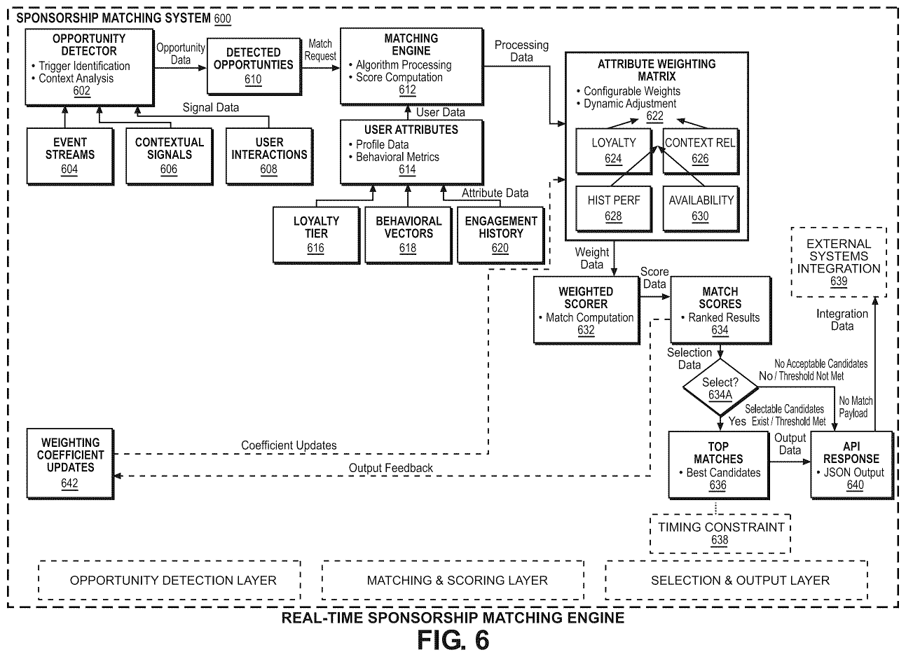

Referring now to FIG. 6, a real-time sponsorship matching engine or system [600] is shown according to aspects of embodiments of the present invention. Sponsorship matching system [600] comprises twenty-one (21) elements organized in three layers representing an optional embodiment demonstrating platform extensibility. This system provides enhanced behavioral qualification inputs contributing to User attributes in BQS formula per aspects of embodiments of the present invention.

### Opportunity Detection Layer

Opportunity detector [602] performs trigger identification, receiving signal data from event streams [604], contextual signals [606], and user interactions [608], outputting opportunity data to detected opportunities [610]. Detected opportunities [610] represent identified sponsorship-eligible impressions outputting match request to matching engine [612].

### Matching & Scoring Layer

Matching engine [612] performs algorithm processing, receiving match request from detected opportunities [610], retrieving user attributes [614], and outputting processing data to attribute weighting matrix [622]. User attributes [614] contain profile data comprising loyalty tier [616], behavioral vectors [618], and engagement history [620], receiving from matching engine [612] and outputting attribute data to the three sub-components which input to attribute weighting matrix [622].

Attribute weighting matrix [622] implements configurable weights with sub-components loyalty [624], context rel [626], hist perf [628], and availability [630], receiving processing data from matching engine [612], inputs from user attributes components, and coefficient updates from weighting coefficient updates [642], outputting weight data to weighted scorer [632] via availability [630]. Weighted scorer [632] performs match computation, receiving weight data from availability [630] and outcome feedback from weighting coefficient updates [642], outputting score data to match scores [634]. Weighting coefficient updates [642] implement continuous learning outputting coefficient updates to attribute weighting matrix [622] and outcome feedback to weighted scorer [632], implementing reinforcement learning [1612](FIG. 16).

### Selection & Output Layer

Match scores [634] represent ranked results outputting selection data to top matches [636]. Top matches [636] represent best candidates constrained by timing constraint [638] outputting to API response [640]. API response [640] generates JSON output receiving from top matches [636] and outputting to external systems integration.

Sponsorship matching system [600] represents optional embodiment not required for Claims 1-52 but demonstrating platform extensibility. When present, match scores contribute to User attributes in BQS formula per aspects of embodiments of the present invention. Weighting coefficient updates [642] implement reinforcement learning [1612](FIG. 16). The system demonstrates how domain-specific modules integrate with unified BQS framework without structural changes to core mechanisms, illustrating architectural flexibility supporting multi-vertical deployment.

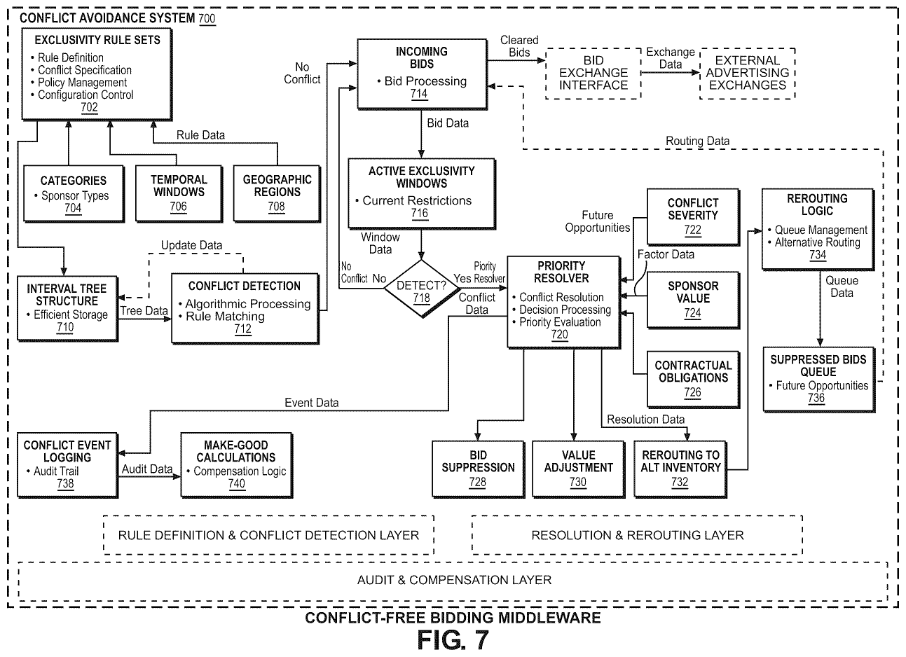

Referring now to FIG. 7, a conflict-free bidding middleware [700] showing exclusivity rule sets, is shown according to aspects of embodiments of the present invention. Conflict avoidance system [700] comprises twenty-four (24) elements organized in three layers representing an optional embodiment demonstrating platform flexibility for multi-sponsor environments. This system enforces exclusivity rules preventing simultaneous competing sponsor delivery, with conflict resolution decisions recorded alongside enforcement tokens providing auditable resolution.

### Rule Definition & Conflict Detection Layer

Exclusivity rule sets [702] perform rule definition and policy management, outputting rule data to categories [704], temporal windows [706], geographic regions [708], and interval-tree structure [710], defining category conflicts, temporal exclusions, and geographic restrictions. Categories [704] specify sponsor types receiving from exclusivity rule sets [702] and outputting to interval-tree structure [710]. Temporal windows [706] define time-based exclusivity periods receiving from exclusivity rule sets [702] and outputting to conflict detection [712]. Geographic regions [708] define location-based boundaries receiving from exclusivity rule sets [702].

Interval-tree structure [710] implements efficient storage for exclusivity rules receiving from categories [704], storing constraints in hierarchical tree format enabling logarithmic-time conflict queries, outputting tree data to conflict detection [712], implementing efficient conflict detection per aspects of embodiments of the present invention. Conflict detection [712] performs algorithmic processing receiving from interval-tree structure [710] and temporal windows [706], evaluating bids against active exclusivity windows using interval tree queries, outputting to conflict detect decision point [718].

Incoming bids [714] receive no conflict signal from conflict detect decision point [718] and window data from active exclusivity windows [716], outputting cleared bids to bid exchange interface. Active exclusivity windows [716] track current restrictions outputting window data to incoming bids [714]. Conflict detect decision point [718] routes no conflict (green path) to incoming bids [714] or conflict data (red path) to priority resolver [720]. Bid exchange interface outputs to external advertising exchanges, which output future opportunities to conflict severity [722].

### Resolution & Rerouting Layer

Priority resolver [720] performs conflict resolution receiving conflict data from conflict detect decision point [718], outputting resolution data to bid suppression [728] and value adjustment [730], outputting factor data to sponsor value [724]. Conflict severity [722] assesses conflict impact receiving from external advertising exchanges and inputting to sponsor value [724]. Sponsor value [724] evaluates sponsor relationship importance receiving from priority resolver [720] and conflict severity [722], outputting to contractual obligations [726] and rerouting to alt inventory [732]. Contractual obligations [726] define commitments receiving from sponsor value [724] and outputting to rerouting to alt inventory [732].

Bid suppression [728] implements complete blocking receiving from priority resolver [720] and outputting to make-good calculations [740]. Value adjustment [730] implements bid value reduction receiving from priority resolver [720]. Rerouting to alt inventory [732] identifies alternative opportunities receiving from sponsor value [724] and contractual obligations [726], outputting to rerouting logic [734]. Rerouting logic [734] manages queue and alternative routing receiving from rerouting to alt inventory [732] and outputting to suppressed bids queue [736].

### Audit & Compensation Layer

Conflict event logging [738] provides audit trail outputting to make-good calculations [740]. Make-good calculations [740] perform compensation logic receiving from bid suppression [728] and conflict event logging [738].

When present, conflict event logging [738] generates cryptographically signed audit records [136] stored in immutable ledger [138](FIG. 1) per aspects of embodiments of the present invention. The system demonstrates how exclusivity constraints integrate with BQS Unity Framework: conflict resolution outcomes can modulate BQS parameters through feedback loop [1240](FIG. 12). The middleware prevents simultaneous competing sponsor delivery while maintaining closed-loop optimization.

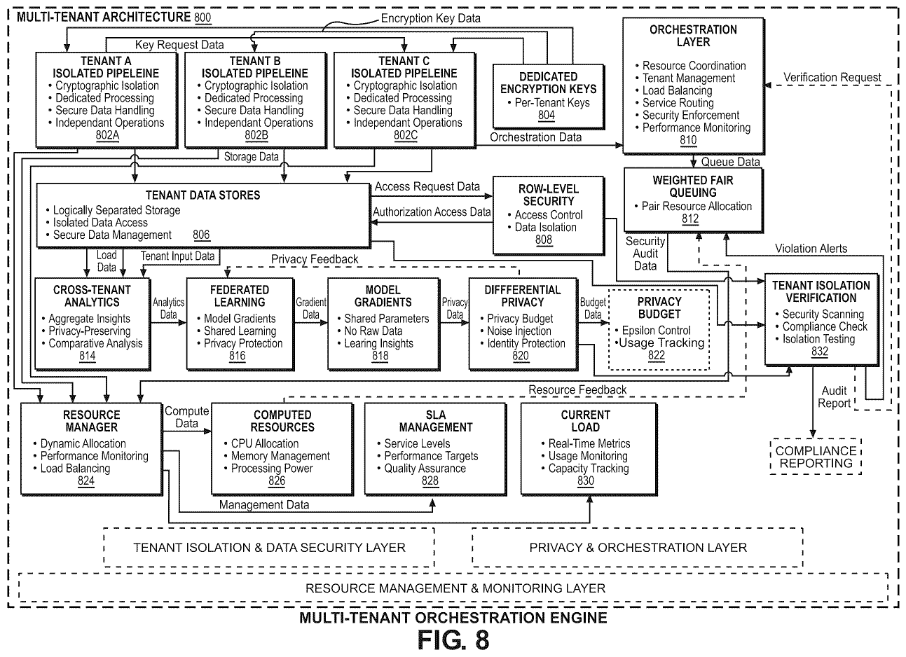

Referring now to FIG. 8, a multi-tenant orchestration engine architecture [800] according to aspects of embodiments of the present invention. Multi-tenant architecture [800] comprises nineteen (19) elements organized in three layers implementing cryptographically isolated processing for multiple advertisers sharing common infrastructure while maintaining absolute data separation, enabling platform-level optimization signals to propagate through BQS Unity Framework without compromising tenant privacy.

### Tenant Isolation & Data Security Layer

Tenant A isolated pipeline [802A], Tenant B isolated pipeline [802B], and Tenant C isolated pipeline [802C] implement cryptographic isolation with dedicated processing, each outputting storage data to tenant data stores [806] and key request data to dedicated encryption keys [804], maintaining absolute cryptographic separation per tenant. Dedicated encryption keys [804] provide per-tenant keys using AES-256 encryption, receiving from tenant isolated pipelines and outputting to orchestration layer [810]. Tenant data stores [806] implement logically separated storage receiving from tenant isolated pipelines, outputting tenant input data to federated learning [816] and access request data to row-level security [808]. Row-level security [808] enforces access control receiving from tenant data stores [806], implementing database-level isolation enforcement.

### Privacy & Orchestration Layer

Orchestration layer [810] performs resource coordination receiving from dedicated encryption keys [804] and outputting to weighted fair queuing [812], implementing service mesh integration with mutual TLS authentication and API versioning per aspects of embodiments of the present invention. Weighted fair queuing [812] implements resource allocation receiving from orchestration layer [810] and outputting to privacy budget manager [822], enforcing per-tenant request quotas per aspects of embodiments of the present invention.

Cross-tenant analytics [814] perform aggregate insights outputting to federated learning [816] and resource manager [824], implementing differential attribution cohorting per aspects of embodiments of the present invention. Federated learning [816] implements shared learning receiving from tenant data stores [806] and cross-tenant analytics [814], outputting to model gradient exchange [818], implementing aspects of embodiments of the present invention. Model gradient exchange [818] aggregates model gradients receiving from federated learning [816], outputting privacy feedback to differential privacy [820] and resource coordination to privacy budget manager [822].

Differential privacy [820] implements privacy budget and noise injection receiving from model gradient exchange [818] and outputting to privacy budget manager [822], implementing aspects of embodiments of the present invention with epsilon-delta differential privacy. Privacy budget manager [822] implements epsilon control receiving from weighted fair queuing [812], model gradient exchange [818], and differential privacy [820], outputting validation to tenant isolation verification [832]. Tenant isolation verification [832] performs security scanning receiving from privacy budget manager [822] and outputting to compliance reporting.

### Resource Management & Monitoring Layer

Resource manager [824] performs dynamic allocation receiving from cross-tenant analytics [814] and outputting to compute resources [826], implementing aspects of embodiments of the present invention with autoscaling. Compute resources [826] provide CPU allocation receiving from resource manager [824] and outputting to SLA management [828]. SLA management [828] tracks performance metrics receiving from compute resources [826] and outputting to current load [830]. Current load [830] displays system utilization receiving from SLA management [828].

Multi-tenant architecture [800] implements enterprise-scale deployment. Tenant isolated pipelines [802A-C] with dedicated encryption keys [804] implement aspects of embodiments of the present invention. Tenant data stores [806] with row-level security [808] implement aspects of embodiments of the present invention within the performance-optimized machine learning system for closed-loop behavioral qualification, the computer-implemented method and computer program product associated with the closed-loop behavioral qualification and enforcement in digital advertising. The architecture demonstrates scalability while maintaining absolute tenant isolation through cryptographic separation.

Referring now to FIG. 9, an enterprise fraud detection infrastructure [900] with distributed detection nodes, is shown according to aspects of embodiments of the present invention. Distributed fraud detection infrastructure [900] comprises twenty-seven (27) elements organized in three layers implementing scalable fraud detection across parallel nodes enabling horizontal scaling while maintaining low-latency per aspects of embodiments of the present invention, with each node generating fraud probability scores [520](FIG. 5).

### Distributed Detection & Analysis Layer

External data sources output to subset streams [904A], [904B], [904C], [904N] partitioning data across detection nodes. Detection node A [902A], detection node B [902B], and detection node N [902N] implement parallel processing with stream analysis and pattern recognition, receiving from external data sources via their respective subset streams, outputting stream processing data to subset stream C [904C] for cross-node coordination, and outputting analysis data to anomaly detection algorithms [906]. The nodes operate independently enabling workload distribution and elastic scaling.

Anomaly detection algorithms [906] implement statistical methods and machine learning, receiving analysis data from detection nodes, aggregating findings to compute ensemble fraud scores, outputting detection data to detected anomalies [912] and distributing to statistical methods [908] and machine learning [910], combining isolation forest [514], gradient boosting [516], and neural networks [518](FIG. 5) per aspects of embodiments of the present invention. Statistical methods [908] implement traditional anomaly detection per aspects of embodiments of the present invention. Machine learning [910] implements adaptive pattern recognition through reinforcement learning [1612] and model retraining [1630](FIG. 16) per aspects of embodiments of the present invention.

Detected anomalies [912] represent fraud indicators receiving from anomaly detection algorithms [906] and outputting to cohorting engine [914], fraud cohorts [916], and clustering analysis [918]. Cohorting engine [914] performs anomaly aggregation receiving from detected anomalies [912], outputting cohort data to fraud cohorts [916] and health data to BQS enforcement control [928], implementing aspects of performance-optimized machine learning system for closed-loop behavioral qualification and an enhanced fraud detection system with differential attribution cohorting per aspects of embodiments of the present invention. Fraud cohorts [916] represent grouped patterns receiving from cohorting engine [914] and outputting to clustering analysis [918]. Clustering analysis [918] implements similarity metrics receiving from detected anomalies [912] and fraud cohorts [916], outputting to behavioral similarity [920], implementing aspects of performance-optimized machine learning system for closed-loop behavioral qualification and an enhanced fraud detection system using cosine distance [1116] and Jaccard index [1118](referring to FIG. 11).

### Attribution & Coordination Layer

Behavioral similarity [920] represents pattern matching receiving from clustering analysis [918] and outputting to attribution adjustment logic [922]. Attribution adjustment logic [922] performs QAS modification receiving from behavioral similarity [920], outputting adjustment data to QAS values [924] and probability data to fraud probability [926], implementing aspects of performance-optimized machine learning system for closed-loop behavioral qualification and an enhanced fraud detection system applying multiplicative factors [1216](FIG. 12) per aspects of embodiments of the present invention. QAS values [924] represent adjusted scores receiving from attribution adjustment logic [922] and outputting adjustment feedback to updates BQS parameters [930]. Fraud probability [926] represents risk likelihood receiving from attribution adjustment logic [922] and outputting to risk systems.

BQS enforcement control [928] receives from cohorting engine [914] and outputs variable update to updates BQS parameters [930], implementing unified scoring governance per aspects of embodiments of the present invention tightening qualification thresholds [1620] system-wide when elevated fraud is detected. Updates BQS parameters [930] receives from BQS enforcement control [928] and QAS values [924], propagating fraud insights to BQS weighting factors [110] and qualification thresholds [1620] through feedback mechanism [1240](referring to FIGS. 1, 12 & 16) per aspects of embodiments of the present invention, demonstrating functional interdependence wherein fraud detection feeds into the unified BQS framework.

### High Availability & Reliability Layer

Redundant nodes [932] maintain hot standby detection nodes outputting failover data to automatic failover [934]. Automatic failover [934] implements health monitoring receiving from redundant nodes [932], detecting failures through health checks [1838] and redirecting traffic [1818] to redundant nodes per aspects of embodiments of the present invention, outputting to system availability, using circuit breakers [1814] detecting failure patterns [1816](referring to FIG. 18).

Distributed fraud detection infrastructure [900] implements enterprise-scale fraud detection. Detection nodes [902A-N]processing subset streams [904A], [904B], [904C], [904N] implement aspects of embodiments of the present invention with horizontal scaling. Anomaly detection algorithms [906] combining statistical methods [908] and machine learning [910] implement different aspects of embodiments of the present invention. Cohorting engine [914]forming fraud cohorts [916] through clustering analysis [918] based on behavioral similarity [920] implements aspects of embodiments of the present invention. Attribution adjustment logic [922] modifying QAS values [924] based on fraud probability [926] implements aspects of embodiments of the present invention. BQS enforcement control [928] with updates BQS parameters [930] implements aspects of embodiments of the present invention demonstrating functional interdependence per aspects of embodiments of the present invention. Redundant nodes [932] with automatic failover [934] implement fault tolerance. The infrastructure demonstrates closed-loop fraud enforcement: detection continuously optimizes prevention through feedback loop [1240](FIG. 12).

Referring now to FIG. 10, an engagement verification beacon deployment architecture [1000] showing multiple integration methods is shown, according to aspects of embodiments of the present invention. Beacon deployment system [1000] comprises twenty-three (23) elements organized in three layers implementing engagement verification beacons [1010] that capture granular interaction signals without personally identifiable information.

### Deployment & Event Capture Layer

The client-side integration [1002] provides multiple deployment methods with cross-platform support, outputting deployment data to beacon instance [1010] and integration data to JavaScript tags [1004], mobile SDKs [1006], and server postbacks [1008]. JavaScript tags [1004] enable web-based deployment, mobile SDKs [1006] enable native application integration, and server postbacks [1008] provide event server capabilities outputting to beacon events [1020].

Beacon instance [1010] performs event capture, data processing, and transmission control, receiving deployment data from client-side integration [1002] and outputting nonce request to cryptographic nonce [1012]. Cryptographic nonce [1012] prevents replay attacks, receiving nonce request from beacon instance [1010] and outputting to nonce-based cryptographic signing [1014]. The signing [1014] generates digital signatures outputting signature chain to session keys [1016], which derive keys from enforcement token [1018] creating unbroken cryptographic chain from pre-qualification through engagement verification.

Beacon events [1020] capture user interaction data including interaction types [1022], timestamps [1024], and context [1026], receiving from server postbacks [1008] and outputting event components to the three sub-elements and batch data to event batching [1028]. Context [1026] additionally outputs data transmission data to exponential backoff [1042] for retry coordination.

### Transmission & Collection Layer

Event batching [1028] optimizes transmission efficiency, receiving batch data from beacon events [1020] and outputting transmission data to asynchronous transmission [1030]. Asynchronous transmission [1030] implements non-blocking operation, receiving from event batching [1028], outputting service data to collection servers [1032], and coordinating with exponential backoff [1042] for error handling.

Collection servers [1032] provide data reception with processing queue and load balancing, receiving service data from asynchronous transmission [1030] and outputting response data to return path [1034]. Return path [1034] handles acknowledgment and status updates, receiving response data from collection servers [1032] and enforcement token data from enforcement token [1018], outputting verified feedback to receipt acknowledgment [1036] and return data to reconciliation trigger [1038]. Reconciliation trigger [1038] initiates downstream processing, outputting to external processing systems.

### Error Handling & Reliability Layer

Failed transmissions [1040] implement error handling with retry logic, outputting retry data to exponential backoff [1042]. Exponential backoff [1042] schedules retries with progressively delayed attempts, receiving retry data from failed transmissions [1040] and coordination inputs from context [1026] and asynchronous transmission [1030], ensuring reliable delivery.

Layer annotations: DEPLOYMENT & EVENT CAPTURE LAYER contains client-side integration [1002], JavaScript tags [1004], mobile SDKs [1006], server postbacks [1008], beacon instance [1010], cryptographic nonce [1012], nonce-based cryptographic signing [1014], session keys [1016], enforcement token [1018], beacon events [1020], interaction types [1022], timestamps [1024], and context [1026]. TRANSMISSION & COLLECTION LAYER contains event batching [1028], asynchronous transmission [1030], collection servers [1032], return path [1034], receipt acknowledgment [1036], reconciliation trigger [1038], and external processing systems. ERROR HANDLING & RELIABILITY LAYER contains failed transmissions [1040] and exponential backoff [1042]. [00303][0220] Beacon deployment system [1000] implements engagement verification beacons [1010] per aspects of embodiments of the present invention. Client-side integration [1002] with JavaScript tags [1004], mobile SDKs [1006], and server postbacks [1008] implements certain aspects of embodiments of the present invention. Cryptographic nonce [1012] with nonce-based signing [1014] and session keys [1016] creates cryptographic chain per aspects of embodiments of the present invention. Beacon events [1020] capture interaction types [1022], timestamps [1024], and context [1026] without PII implementing privacy by design. Event batching [1028] with asynchronous transmission [1030] implements aspects of embodiments of the present invention. Exponential backoff [1042] ensures reliable delivery per aspects of embodiments of the present invention. The system captures granular engagement data enabling signature-based reconciliation while maintaining privacy through ephemeral identifiers and cryptographic attestation chains.

Referring now to FIG. 11, a signature-based reconciliation engine [1100] showing behavioral fingerprint generation according to aspects of embodiments of the present invention. Reconciliation system [1100] comprises twenty-six (26) elements organized in three layers implementing signature-based reconciliation that validates post-engagement behaviors against pre-qualification BQS levels.

### Fingerprint Generation & Matching Layer

Behavioral fingerprints [1102] generate unique pattern identities from beacon data, outputting fingerprint data to beacon data [1104] and hash input to one-way hash functions [1106]. Beacon data [1104] receives engagement events from beacon data systems and fingerprint data from behavioral fingerprints [1102]. One-way hash functions [1106] implement cryptographic hashing with SHA-256 per aspects of embodiments of the present invention, receiving hash input from behavioral fingerprints [1102] and outputting hash data to matching engine [1108].

Matching engine [1108] performs pattern comparison and similarity analysis, receiving hash data from one-way hash functions [1106], outputting reference data to cohort signatures [1110] and comparison data to similarity metrics [1114]. Cohort signatures [1110] maintain reference patterns and group identifiers, receiving reference data from matching engine [1108] and outputting cache data to cache storage [1112] for performance optimization per aspects of embodiments of the present invention.

Similarity metrics [1114] implement algorithmic comparison, receiving comparison data from matching engine [1108] and outputting to cosine distance [1116] and Jaccard index [1118] per aspects of embodiments of the present invention. Both cosine distance [1116] and Jaccard index [1118] output to match results [1120], which computes similarity scores and match confidence, receiving from both metrics and outputting match data to beacon correlation matrix [1126].

### Attribution & Correlation Analysis Layer

QAS generator [1122] performs attribution scoring and quality assessment, outputting confidence score to attribution confidence [1124]. Attribution confidence [1124] computes reliability metrics, receiving confidence score from QAS generator [1122] and outputting to beacon correlation matrix [1126]. Beacon correlation matrix [1126] implements cross-reference links and touchpoint mapping, receiving match data from match results [1120] and attribution data from attribution confidence [1124], outputting to multiple conversion paths [1128].

Multiple conversion paths [1128] tracks journey stages and interaction points, receiving from beacon correlation matrix [1126] and outputting to multi-touch attribution [1130]. Multi-touch attribution [1130] implements credit distribution and value assignment per aspects of embodiments of the present invention, receiving from multiple conversion paths [1128] and outputting to QAS output systems and attribution data to attribution systems, implementing aspects of embodiments of the present invention for non-PII matching.

### Cryptographic Integrity & System Feedback Layer

Event chaining [1132] implements sequential linking and temporal ordering, outputting trans data to Merkle tree structure [1134] and chain data to BQS parameter updates [1138]. Merkle tree structure [1134] creates hierarchical hashing with integrity verification, receiving trans data from event chaining [1132] and outputting hash data to SHA-256 hashing [1136]. SHA-256 hashing [1136] ensures cryptographic integrity per aspects of embodiments of the present invention, receiving hash data from Merkle tree structure [1134] and outputting signing data to BQS parameter updates [1138].

BQS parameter updates [1138] implement closed-loop feedback per aspects of embodiments of the present invention, receiving chain data from event chaining [1132] and signing data from SHA-256 hashing [1136], outputting to three optimization pathways: high fidelity increases BQS weight [1140], processing optimizes BQS routing [1142], and fraud patterns adjust BQS thresholds [1144]. High fidelity increases BQS weight [1140] outputs control data to system control interface demonstrating how accurate signals receive increased weighting. These pathways demonstrate comprehensive feedback wherein reconciliation outcomes directly optimize the unified BQS scoring system per aspects of embodiments of the present invention.

Layer annotations: FINGERPRINT GENERATION & MATCHING LAYER contains behavioral fingerprints [1102], beacon data [1104], one-way hash functions [1106], matching engine [1108], cohort signatures [1110], cache storage [1112], similarity metrics [1114], cosine distance [1116], Jaccard index [1118], match results [1120], and beacon data systems. ATTRIBUTION & CORRELATION ANALYSIS LAYER contains QAS generator [1122], attribution confidence [1124], beacon correlation matrix [1126], multiple conversion paths [1128], multi-touch attribution [1130], QAS output systems, and attribution systems. CRYPTOGRAPHIC INTEGRITY & SYSTEM FEEDBACK LAYER contains event chaining [1132], Merkle tree structure [1134], SHA-256 hashing [1136], BQS parameter updates [1138], high fidelity increases BQS weight [1140], processing optimizes BQS routing [1142], fraud patterns adjust BQS thresholds [1144], and system control interface.

Reconciliation system [1100] implements signature-based reconciliation engine per aspects of embodiments of the present invention. Behavioral fingerprints [1102] with one-way hash functions [1106] implement aspects of embodiments of the present invention using SHA-256. Similarity metrics [1114] with cosine distance [1116] and Jaccard index [1118] implement aspects of embodiments of the present invention. QAS generator [1122] with attribution confidence [1124] implements aspects of embodiments of the present invention. Multi-touch attribution [1130] implements non-PII matching per aspects of embodiments of the present invention, using privacy-preserving techniques per aspects of embodiments of the present invention. Event chaining [1132] with Merkle tree structure [1134] and SHA-256 hashing [1136] implement cryptographic integrity per aspects of embodiments of the present invention, while supporting distributed ledger [138]. BQS parameter updates [1138] with three optimization pathways implement closed-loop feedback, demonstrating functional interdependence wherein reconciliation continuously optimizes prevention through the unified BQS framework.

Referring now to FIG. 12, a qualified attribution score (QAS) generator architecture or computation system [1200] is shown according to aspects of embodiments of the present invention. QAS computation system [1200] comprises twenty-five (25) elements organized in three layers implementing qualified attribution score generation that reconciles pre-qualification BQS with verified engagement outcomes.

### Deviation Analysis & Fraud Adjustment Layer

BQS-QAS deviation calculator [1202] performs score comparison and variance analysis, outputting score data to pre-qualification scores [1204] and deviation data to post-engagement outcomes [1206], receiving feedback from BQS threshold control [1234]. Pre-qualification scores [1204] contain BQS values, receiving score data from deviation calculator [1202] and outputting deviation input to fraud-weighted adjustments [1214]. Post-engagement outcomes [1206] represent actual results, receiving deviation data from calculator [1202] and outputting to deviations [1208].

Deviations [1208] implement difference analysis and error metrics, receiving from post-engagement outcomes [1206] and outputting to threshold analysis [1210]. Threshold analysis [1210] evaluates deviation limits, receiving from deviations [1208] and outputting to recalibration trigger [1212]. Recalibration trigger [1212] initiates system adjustment when deviations exceed thresholds, receiving from threshold analysis [1210] and outputting to ensemble methods [1222], implementing automatic BQS weight adjustment.

Fraud-weighted adjustments [1214] integrate risk assessment into attribution scoring, receiving deviation input from pre-qualification scores [1204] and outputting adjustment data to multiplicative factors [1216] and fraud probability [1218], and adjusted scores to confidence scoring [1220]. Multiplicative factors [1216] apply weight coefficients, receiving adjustment data from fraud-weighted adjustments [1214] and fraud data from fraud system. Fraud probability [1218] assesses risk, receiving adjustment data from fraud-weighted adjustments [1214] and outputting confidence parameter updates to confidence scoring [1220] and BQS threshold control [1234], implementing fraud-weighted adjustments with multiplicative factors [1216].

BQS threshold control [1234] implements adaptive policy per aspects of embodiments of the present invention, receiving confidence parameter updates from fraud probability [1218], outputting feedback to BQS-QAS deviation calculator [1202], and outputting to high confidence relaxes BQS thresholds [1236] and low confidence tightens BQS thresholds [1238]. This dual-mode operation adjusts enforcement stringency based on verified outcomes per aspects of embodiments of the present invention.

### Confidence Scoring & Learning Layer

Confidence scoring [1220] performs reliability assessment, receiving adjusted scores from fraud-weighted adjustments [1214] and confidence parameter updates from fraud probability [1218], outputting model confidence and ensemble data to ensemble methods [1222], and system updates to rules-based assessment [1224] and ML-based assessment [1226]. Ensemble methods [1222] combine multiple algorithms for consensus scoring, receiving model confidence and ensemble data from confidence scoring [1220] and input from recalibration trigger [1212], outputting learning data to reinforcement updater [1228].

Rules-based assessment [1224] applies static logic, receiving system updates from confidence scoring [1220] and outputting to Q-learning algorithm [1230]. ML-based assessment [1226] provides model updates through machine learning, receiving system updates from confidence scoring [1220] and outputting to Q-learning algorithm [1230]. Reinforcement updater [1228] implements learning algorithm and parameter optimization, receiving learning data from ensemble methods [1222] and outputting to Q-learning algorithm [1230] and scoring parameters [1232].

Q-learning algorithm [1230] discovers optimal behavioral qualification thresholds, receiving from rules-based assessment [1224], ML-based assessment [1226], and reinforcement updater [1228], outputting to scoring parameters [1232]. Scoring parameters [1232] store optimized coefficients, receiving from reinforcement updater [1228] and Q-learning algorithm [1230], implementing Claims 26, 39, 49 for reinforcement learning with Q-learning [1230] and scoring parameters [1232].

### System Feedback & Control Layer

Feedback loop [1240] implements continuous learning and system optimization, outputting improvement data to continuous improvement [1242]. Continuous improvement [1242] performs performance improvement and model refinement, receiving improvement data from feedback loop [1240], outputting control data to system control interface and QAS output to QAS external systems. The feedback loop [1240] ensures continuous improvement [1242]propagating threshold adjustments to enforcement gateway affecting future qualifications, completing closed-loop cycle wherein post-engagement outcomes directly modulate pre-spend parameters through unified BQS framework.

Layer annotations: DEVIATION ANALYSIS & FRAUD ADJUSTMENT LAYER contains BQS-QAS deviation calculator [1202], pre-qualification scores [1204], post-engagement outcomes [1206], deviations [1208], threshold analysis [1210], recalibration trigger [1212], fraud-weighted adjustments [1214], multiplicative factors [1216], fraud probability [1218], BQS threshold control [1234], high confidence relaxes BQS thresholds [1236], low confidence tightens BQS thresholds [1238], and fraud system. CONFIDENCE SCORING & LEARNING LAYER contains confidence scoring [1220], ensemble methods [1222], rules-based assessment [1224], ML-based assessment [1226], reinforcement updater [1228], Q-learning algorithm [1230], and scoring parameters [1232]. SYSTEM FEEDBACK & CONTROL LAYER contains feedback loop [1240], continuous improvement [1242], QAS external systems, and system control interface.

QAS computation system [1200] implements qualified attribution score generator [1122] per aspects of embodiments of the present invention. BQS-QAS deviation calculator [1202] detects deviations [1202] between pre-qualification scores [1204] and post-engagement outcomes [1206] per aspects of embodiments of the present invention. Fraud-weighted adjustments [1214] with multiplicative factors [1216] based on fraud probability [1218] implement reduction of attribution confidence for high-risk engagements. Confidence scoring [1220] with ensemble methods [1222] combining rules-based [1224] and ML-based [1226] assessments implements aspects of embodiments of the present invention. Reinforcement updater [1228] with Q-learning algorithm [1230] and scoring parameters [1232] implements aspects of embodiments of the present invention. BQS threshold control [1234] with dual-mode operation implements adaptive policy: high confidence relaxes thresholds [1236] reducing friction, low confidence tightens thresholds [1238] increasing scrutiny. Feedback loop [1240] with continuous improvement [1242] implements closed-loop feedback and other aspects of embodiments of the present invention, while demonstrating functional interdependence where post-engagement QAS outcomes directly optimize pre-spend BQS parameters through the unified framework.

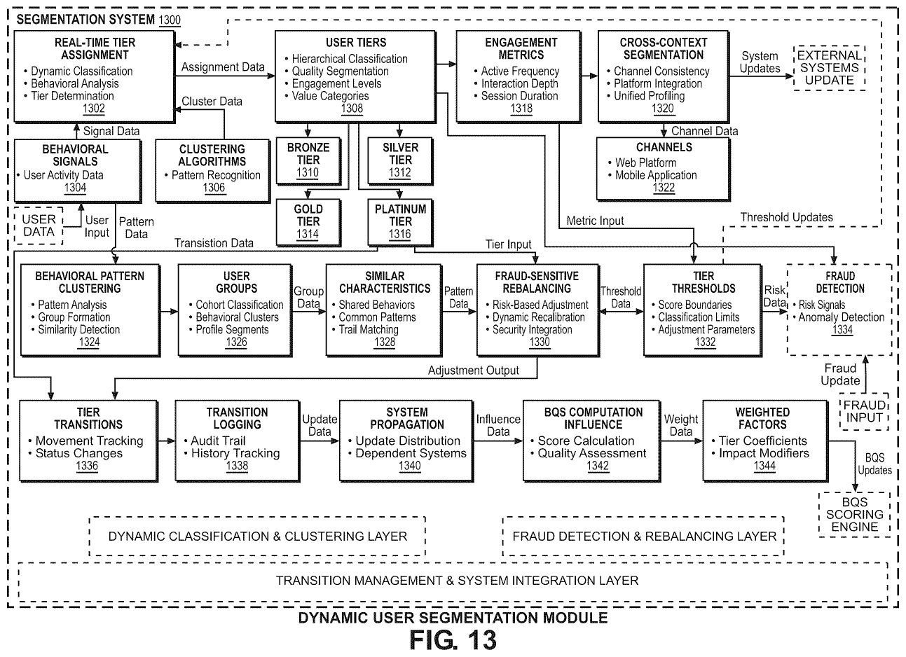

Referring now to FIG. 13, a dynamic user segmentation system [1300] showing real-time tier assignment, is shown according to aspects of embodiments of the present invention. Segmentation system [1300] comprises twenty-eight (28) elements organized in three layers implementing real-time tier assignment and behavioral clustering that feed BQS computation as normalized features, demonstrating how segmentation directly influences qualification scoring through closed-loop feedback.

### Dynamic Classification & Clustering Layer

Real-time tier assignment [1302] performs dynamic classification and behavioral analysis, receiving signal data from behavioral signals [1304] and outputting assignment data to clustering algorithms [1306] and cluster data to user tiers [1308]. Behavioral signals [1304] contain user activity data, receiving from user input data and outputting signal data to real-time tier assignment [1302] and pattern data to behavioral pattern clustering [1324].

Clustering algorithms [1306] implement pattern recognition, receiving assignment data from real-time tier assignment [1302] and outputting to user tiers [1308]. User tiers [1308] implement hierarchical classification across engagement levels, receiving cluster data from real-time tier assignment [1302] and input from clustering algorithms [1306], outputting tier data to engagement metrics [1318] and distributing to Bronze tier [1310], Silver tier [1312], Gold tier [1314], and Platinum tier [1316].

Bronze tier [1310] represents entry-level engagement, receiving from user tiers [1308] and outputting threshold updates to fraud-sensitive rebalancing [1330]. Silver tier [1312] and Gold tier [1314] represent intermediate engagement levels, receiving from user tiers [1308]. Platinum tier [1316] represents highest engagement, receiving from user tiers [1308] and outputting tier input to similar characteristics [1328].

Engagement metrics [1318] track activity frequency, interaction depth, and session duration, receiving tier data from user tiers [1308] and outputting to cross-context segmentation [1320]. Cross-context segmentation [1320] maintains channel consistency and platform integration, receiving from engagement metrics [1318], outputting system update to external systems update, and outputting channel data to channels [1322]. Channels [1322] represent web platform and mobile application, receiving channel data from cross-context segmentation [1320] and outputting media input to fraud-sensitive rebalancing [1330].

Behavioral pattern clustering [1324] performs pattern analysis and group formation, receiving pattern data from behavioral signals [1304] and outputting to user groups [1326]. User groups [1326] implement cohort classification and behavioral clusters, receiving from behavioral pattern clustering [1324] and outputting to similar characteristics [1328].

### Fraud Detection & Rebalancing Layer

Similar characteristics [1328] identify shared behaviors and common patterns, receiving tier input from Platinum tier [1316] and input from user groups [1326], outputting pattern data to fraud-sensitive rebalancing [1330]. Fraud-sensitive rebalancing [1330] implements risk-based adjustment and dynamic recalibration, receiving threshold updates from Bronze tier [1310], media input from channels [1322], and pattern data from similar characteristics [1328], outputting threshold data to tier thresholds [1332] and adjustment output to tier transitions [1336].

Tier thresholds [1332] define score boundaries and classification limits, receiving threshold data from fraud-sensitive rebalancing [1330] and outputting fraud signal to fraud detection modules [1334]. Fraud detection modules [1334] generate risk signals through anomaly detection, receiving fraud signal from tier thresholds [1332] and outputting fraud input to external fraud systems, demonstrating how segmentation integrates with fraud detection through BQS computation influence [1342].

### Transition Management & System Integration Layer

Tier transitions [1336] track movement and status changes, receiving adjustment output from fraud-sensitive rebalancing [1330] and outputting to transition logging [1338]. Transition logging [1338] maintains audit trail and history tracking, receiving from tier transitions [1336] and outputting to system propagation [1340]. System propagation [1340] distributes updates to dependent systems, receiving from transition logging [1338] and outputting influence data to BQS computation influence [1342].

BQS computation influence [1342] performs score calculation integrating segmentation data, receiving influence data from system propagation [1340] and outputting weight data to weighted factors [1344]. Weighted factors [1344] apply tier coefficients and impact modifiers, receiving weight data from BQS computation influence [1342] and outputting BQS updates to BQS scoring engine, implementing the User attributes component of BQS formula.

Layer annotations: DYNAMIC CLASSIFICATION & CLUSTERING LAYER contains real-time tier assignment [1302], behavioral signals [1304], clustering algorithms [1306], user tiers [1308], Bronze tier [1310], Silver tier [1312], Gold tier [1314], Platinum tier [1316], engagement metrics [1318], cross-context segmentation [1320], channels [1322], behavioral pattern clustering [1324], user groups [1326], user input data, and external systems update. FRAUD DETECTION & REBALANCING LAYER contains similar characteristics [1328], fraud-sensitive rebalancing [1330], tier thresholds [1332], and fraud detection modules [1334]. TRANSITION MANAGEMENT & SYSTEM INTEGRATION LAYER contains tier transitions [1336], transition logging [1338], system propagation [1340], BQS computation influence [1342], weighted factors [1344], and BQS scoring engine.

Segmentation system [1300] provides input to BQS User attributes component, demonstrating real-time behavioral adaptation. Real-time tier assignment [1302] with user tiers [1308] spanning Bronze [1310] through Platinum [1316] implements hierarchical classification based on engagement metrics [1318]. Fraud-sensitive rebalancing [1330] adjusts tier thresholds [1332] when fraud is detected [1334], demonstrating functional interdependence wherein segmentation directly influences BQS computation [1342] through closed-loop feedback. Weighted factors [1344] output BQS updates to BQS scoring engine, integrating segmentation insights into the unified BQS framework governing all enforcement decisions. The system demonstrates how domain-specific behavioral classification enhances qualification accuracy while maintaining unified orchestration through the single BQS metric.

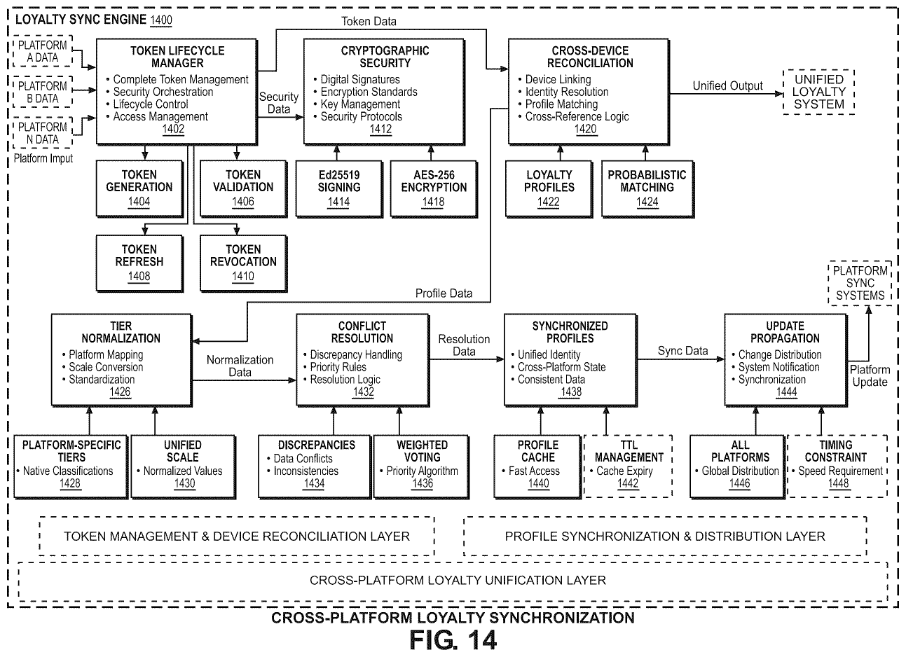

Referring now to FIG. 14, a cross-platform loyalty synchronization engine [1400], is shown according to aspects of embodiments of the present invention. Loyalty synchronization engine [1400] comprises twenty-seven (27) elements organized in three layers implementing token lifecycle management with cryptographic security, cross-device reconciliation, and update propagation ensuring consistent BQS evaluation across platforms.

### Token Management & Device Reconciliation Layer

Token lifecycle manager [1402] implements complete token management with security orchestration, receiving from platform data (two instances) and outputting security input to token generation [1404] and token validation [1406], and security data to cryptographic security [1412]. Token generation [1404] creates new tokens, receiving security input from token lifecycle manager [1402] and platform data. Token validation [1406] verifies token authenticity, receiving security input from token lifecycle manager [1402]. Token refresh [1408] and token revocation [1410] operate as standalone components managing token lifecycle events.

Cryptographic security [1412] implements digital signatures, encryption standards, and key management, receiving security data from token lifecycle manager [1402], outputting key data to Ed25519 signing [1414] and AES-256 encryption [1418], and outputting to cross-device reconciliation [1420]. Ed25519 signing [1414] generates digital signatures, receiving key data from cryptographic security [1412] and outputting profile data to AES-256 encryption [1418] and tier normalization [1426]. AES-256 encryption [1418] protects data in transit, receiving key data from cryptographic security [1412] and profile data from Ed25519 signing [1414].

Cross-device reconciliation [1420] implements device linking and identity resolution, receiving from cryptographic security [1412], outputting unified output to unified loyalty system, and distributing to loyalty profiles [1422] and probabilistic matching [1424]. This reconciliation maintains consistent loyalty state through privacy-preserving matching techniques enabling cross-device behavioral qualification without persistent identifiers.

### Profile Synchronization & Distribution Layer

Tier normalization [1426] performs platform mapping and scale conversion, receiving profile data from Ed25519 signing [1414], outputting normalization data to conflict resolution [1432], and distributing to platform-specific tiers [1428] and unified scale [1430]. Platform-specific tiers [1428] maintain native classifications, while unified scale [1430] provides normalized values enabling consistent BQS evaluation regardless of originating platform.

Conflict resolution [1432] handles discrepancy resolution through priority rules, receiving normalization data from tier normalization [1426], outputting resolution data to synchronized profiles [1438], and distributing to discrepancies [1434] and weighted voting [1436]. Synchronized profiles [1438] maintain unified identity and cross-platform state, receiving resolution data from conflict resolution [1432], outputting sync data to update propagation [1444], and distributing to profile cache [1440] and TTL management [1442] for performance optimization.

### Cross-Platform Loyalty Unification Layer

Update propagation [1444] implements change distribution and system notification, receiving sync data from synchronized profiles [1438], outputting platform update to platform sync systems, and distributing to all platforms [1446] and timing constraints [1448]. Timing constraints [1448] enforce speed requirements ensuring synchronization completes within acceptable latency maintaining real-time qualification capability.

Layer annotations: TOKEN MANAGEMENT & DEVICE RECONCILIATION LAYER contains token lifecycle manager [1402], token generation [1404], token validation [1406], token refresh [1408], token revocation [1410], cryptographic security [1412], Ed25519 signing [1414], AES-256 encryption [1418], cross-device reconciliation [1420], loyalty profiles [1422], probabilistic matching [1424], platform data (two instances), and unified loyalty system. PROFILE SYNCHRONIZATION & DISTRIBUTION LAYER contains tier normalization [1426], platform-specific tiers [1428], unified scale [1430], conflict resolution [1432], discrepancies [1434], weighted voting [1436], synchronized profiles [1438], profile cache [1440], and TTL management [1442]. CROSS-PLATFORM LOYALTY UNIFICATION LAYER contains update propagation [1444], all platforms [1446], timing constraints [1448], and platform sync systems.

Loyalty sync engine [1400] implements cryptographic security [1412] with Ed25519 signing [1414] and AES-256 encryption [1418]. Token lifecycle manager [1402] with token generation [1404], validation [1406], refresh [1408], and revocation [1410] implements complete lifecycle management. Cross-device reconciliation [1420] with probabilistic matching [1424] maintains consistent loyalty state without persistent identifiers supporting privacy-by-design. Tier normalization [1426] with conflict resolution [1432] ensures unified BQS evaluation regardless of platform entry point. Update propagation [1444] with timing constraints [1448] maintains synchronization within real-time constraints. The engine demonstrates how cross-platform identity resolution integrates with the BQS Unity Framework: synchronized profiles [1438] ensure consistent qualification scoring across web, mobile, and other channels, maintaining enforcement integrity in multi-platform environments.

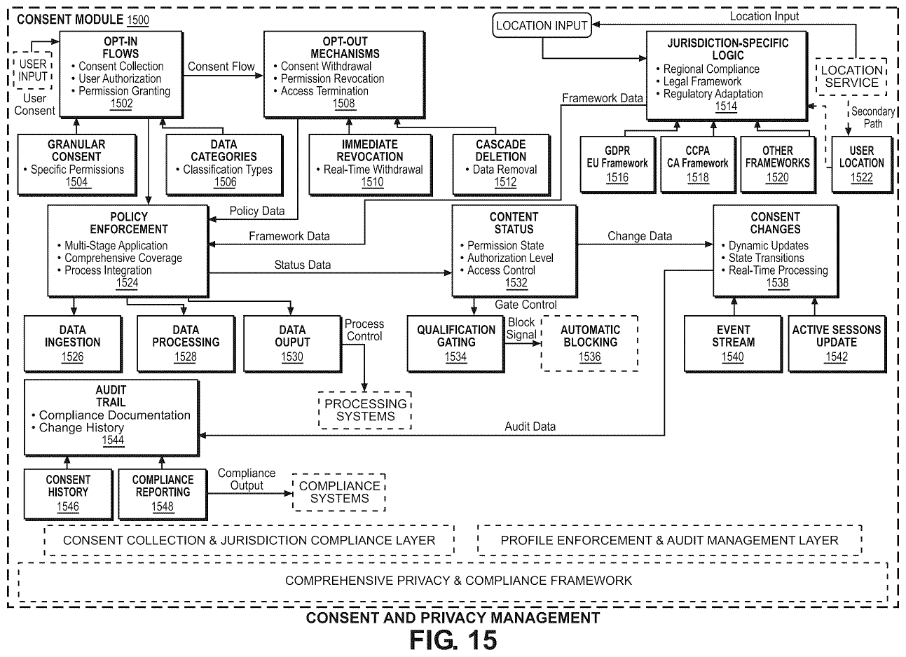

Referring to FIG. 15, a consent and privacy management module architecture [1500], is shown according to aspects of embodiments of the present invention. Consent module [1500] comprises twenty-eight (28) elements organized in two layers implementing opt-in/opt-out flows with jurisdiction-specific compliance, multi-stage policy enforcement, and consent-gated qualification.

### Consent Collection & Jurisdiction Compliance Layer

Opt-in flows [1502] implement user consent collection and authorization, receiving from user consent input and outputting consent flow to opt-out mechanisms [1508], and distributing to granular consent [1504] and data categories [1506]. Granular consent [1504] captures specific permissions, receiving from opt-in flows [1502]. Data categories [1506] define classification types, receiving from opt-in flows [1502] and outputting consent data to immediate revocation [1510].

Opt-out mechanisms [1508] enable consent withdrawal and permission revocation, receiving consent flow from opt-in flows [1502], outputting to immediate revocation [1510], and outputting withdrawal data to cascade deletion [1512] and policy enforcement [1524]. Immediate revocation [1510] implements real-time withdrawal, receiving consent data from data categories [1506] and input from opt-out mechanisms [1508]. Cascade deletion [1512] removes associated data, receiving withdrawal data from opt-out mechanisms [1508], implementing comprehensive data removal per GDPR/CCPA requirements.

Jurisdiction-specific logic [1514] implements regional compliance and legal framework adaptation, receiving from location input, outputting location input to policy enforcement [1524], outputting secondary path to location service feeding user location [1522], and distributing to GDPR [1516], CCPA [1518], and other frameworks [1520]. This jurisdiction detection enables dynamic policy selection based on user location [1522] ensuring compliance with applicable privacy regulations.

### Policy Enforcement & Audit Management Layer

Policy enforcement [1524] implements multi-stage application across data processing stages, receiving withdrawal data from opt-out mechanisms [1508] and location input from jurisdiction-specific logic [1514], outputting status data to consent status [1532], and distributing to data ingestion [1526], data processing [1528], and data output [1530]. This multi-stage enforcement ensures privacy constraints apply throughout the data lifecycle.

Consent status [1532] maintains permission state and authorization level, receiving status data from policy enforcement [1524], outputting change data to consent changes [1538] and gate control to qualification gating [1534]. Qualification gating [1534] implements consent-gated qualification, receiving audit control from data output [1530] and gate control from consent status [1532], outputting blockchain data to automatic blocking [1536] and process control to audit trail [1544]. Automatic blocking [1536] prevents processing when consent is absent, receiving blockchain data from qualification gating [1534].

Consent changes [1538] implement dynamic updates and state transitions, receiving change data from consent status [1532] and outputting to event stream [1540] and active sessions update [1542]. Event stream [1540]propagates consent changes in real-time, while active sessions update [1542] immediately applies revocations to ongoing sessions ensuring immediate effect per regulatory requirements.

Audit trail [1544] maintains compliance documentation and change history, receiving process control from qualification gating [1534] and outputting compliance data to consent history [1546] and compliance reporting [1548]. Consent history [1546] stores complete consent records, while compliance reporting [1548] generates regulatory reports outputting to compliance systems. Processing systems associate with audit trail [1544] via process control, enabling comprehensive audit of all consent-related decisions.

Layer annotations: CONSENT COLLECTION & JURISDICTION COMPLIANCE LAYER contains opt-in flows [1502], granular consent [1504], data categories [1506], opt-out mechanisms [1508], immediate revocation [1510], cascade deletion [1512], jurisdiction-specific logic [1514], GDPR [1516], CCPA [1518], other frameworks [1520], user location [1522], user consent input, location input, and location service. POLICY ENFORCEMENT & AUDIT MANAGEMENT LAYER contains policy enforcement [1524], data ingestion [1526], data processing [1528], data output [1530], consent status [1532], qualification gating [1534], automatic blocking [1536], consent changes [1538], event stream [1540], active sessions update [1542], audit trail [1544], consent history [1546], compliance reporting [1548], processing systems, and compliance systems. The COMPREHENSIVE PRIVACY & COMPLIANCE FRAMEWORK annotation spans entire system [1500].

Consent module [1500] implements real-time consent and privacy management engine [1500]. Opt-in flows [1502] with granular consent [1504] by data categories [1506] implement Claims 19, 33(h), 43(h). Opt-out mechanisms [1508] with immediate revocation [1510] and cascade deletion [1512] implement aspects of embodiments of the present invention. Jurisdiction-specific logic [1514] supporting GDPR [1516], CCPA [1518], and other frameworks [1520] implements aspects of embodiments of the present invention with dynamic policy selection based on user location [1522]. Policy enforcement [1524] across data ingestion [1526], processing [1528], and output [1530] implements multi-stage enforcement. Qualification gating [1534] with automatic blocking [1536] implements consent-gated qualification: absence of valid consent triggers automatic blocking before budget commitment. Audit trail [1544] with consent history [1546] and compliance reporting [1548] enables regulatory audit. The module demonstrates privacy-by-design where consent directly gates qualification decisions, integrating privacy compliance with the BQS Unity Framework through consent status [1532] modulating enforcement thresholds.

Referring now to FIG. 16, a closed-loop feedback cycle [1600] showing reconciliation outputs, is shown according to aspects of embodiments of the present invention. Feedback system [1600] comprises twenty-seven (27) elements organized in three layers implementing comprehensive closed-loop feedback demonstrating how reconciliation outcomes, fraud signals, and engagement metrics propagate through BQS Unity Framework.

### Feedback Collection & Model Updating Layer

Reconciliation outputs [1602] provide system performance data with decision validation and error detection, receiving from BQS Unity Optimizer [1634] and outputting feedback data to model updates [1610], and distributing to QAS values [1604], fraud signals [1606], and engagement metrics [1608]. These three components output to optimization loop feeding BQS Unity Optimizer [1634], creating the feedback pathway wherein verified outcomes directly inform parameter adjustments.

Model updates [1610] perform parameter adjustment with learning algorithm and model refinement, receiving feedback data from reconciliation outputs [1602], outputting parameter updates to model parameters [1616], and distributing to reinforcement learning [1612] and policy gradient methods [1614]. Reinforcement learning [1612] and policy gradient methods [1614] both output to BQS Unity Optimizer [1634], implementing adaptive learning.

Fraud models [1628] implement detection algorithms with pattern recognition, receiving from retraining [1630] and attack patterns [1632], and outputting fraud data to BQS Unity Optimizer [1634]. Retraining [1630] receives from system inputs, while system inputs also receives from system feedback cycle, creating continuous model improvement incorporating newly identified attack patterns [1632].

### Parameter Optimization & Coordination Layer

BQS Unity Optimizer [1634] implements weight coordination, threshold optimization, factor synchronization, and scoring harmony, comprising sub-components BQS enforcement weight [1636], BQS efficiency factor [1638], BQS enforcement level [1640], and BQS unity balance [1642]. The optimizer [1634] receives optimization loop inputs from QAS values [1604], fraud signals [1606], and engagement metrics [1608], receives fraud data from fraud models [1628], receives from reinforcement learning [1612] and policy gradient methods [1614], outputs adaptive feedback to model parameters [1616], and outputs optimization data to optimization cycle [1644]. This central orchestration implements managing interrelated adjustments while maintaining unified scoring.

Model parameters [1616] store coefficient values and threshold settings, receiving parameter updates from model updates [1610] and adaptive feedback from BQS Unity Optimizer [1634], outputting threshold data to qualification thresholds [1620] and to prediction error minimization [1618]. Prediction error minimization [1618] adjusts parameters to minimize prediction error [1618].

Optimization cycle [1644] implements iterative improvement and continuous learning, receiving optimization data from BQS Unity Optimizer [1634] and outputting to real-time adaptation [1648]. Real-time adaptation [1648] enables continuous parameter propagation, receiving from optimization cycle [1644] and outputting to system feedback cycle, implementing real-time adaptation [1648] ensuring system responsiveness.

### Threshold Calibration & Adaptation Layer

Qualification thresholds [1620] define decision boundaries and acceptance criteria, receiving threshold data from model parameters [1616], outputting updated to threshold output, and distributing to recalibration [1622], false positive [1624], and false negative [1626]. Threshold output receives updated from qualification thresholds [1620] and outputs to closed loop. Closed loop outputs to system outputs, which outputs to system feedback cycle, completing the threshold feedback loop (orange annotation) spanning reconciliation outputs [1602] to qualification thresholds [1620].

The optimization loop (purple dashed lines) flows from QAS values [1604], fraud signals [1606], and engagement metrics [1608] to BQS Unity Optimizer [1634]. The system feedback cycle (red dashed line) flows from system outputs through real-time adaptation [1648] to system inputs, creating the CLOSED-LOOP LEARNING & OPTIMIZATION FRAMEWORK spanning entire system [1600].

Layer annotations: FEEDBACK COLLECTION & MODEL UPDATING LAYER contains reconciliation outputs [1602], QAS values [1604], fraud signals [1606], engagement metrics [1608], model updates [1610], reinforcement learning [1612], policy gradient methods [1614], fraud models [1628], retraining [1630], attack patterns [1632], and system inputs. PARAMETER OPTIMIZATION & COORDINATION LAYER contains BQS Unity Optimizer [1634] with sub-components BQS enforcement weight [1636], BQS efficiency factor [1638], BQS enforcement level [1640], BQS unity balance [1642], model parameters [1616], prediction error minimization [1618], optimization cycle [1644], and real-time adaptation [1648]. THRESHOLD CALIBRATION & ADAPTATION LAYER contains qualification thresholds [1620], recalibration [1622], false positive [1624], false negative [1626], threshold output, closed loop, and system outputs. The CLOSED-LOOP LEARNING & OPTIMIZATION FRAMEWORK annotation spans entire system [1600].

Feedback system [1600] implements closed-loop feedback. Reconciliation outputs [1602] with QAS values [1604], fraud signals [1606], and engagement metrics [1608] feed model updates [1610] implementing comprehensive feedback. Reinforcement learning [1612] with policy gradient methods [1614] implements aspects of embodiments of the present invention. Fraud models [1628] with retraining [1630] incorporating attack patterns [1632] implements aspects of embodiments of the present invention. BQS Unity Optimizer [1634] managing BQS enforcement weight [1636], efficiency factor [1638], enforcement level [1640], and unity balance [1642] implements central orchestration maintaining unified scoring. Model parameters [1616] with prediction error minimization [1618] implements aspects of embodiments of the present invention. Optimization cycle [1644] with real-time adaptation [1648] implements aspects of embodiments of the present invention. Qualification thresholds [1620] with recalibration [1622] based on false positive [1624] and false negative [1626] rates implements threshold calibration balancing permissiveness against protection. The system demonstrates functional interdependence central to BQS Unity Framework: all components contribute to unified BQS metric through three interconnected feedback loops (threshold feedback, optimization loop, system feedback cycle) implementing System-Wide Convergence wherein changes stabilize across all subsystems within bounded iterations.

Referring now to FIG. 17, an audit cryptography subsystem architecture [1700], is shown according to aspects of embodiments of the present invention. Audit architecture [1700] comprises twenty-seven (27) elements organized in three layers implementing immutable, tamper-evident logging creating cryptographic proof that enforcement decisions followed stated policies.

### Cryptographic Signing & Verification Layer

Ed25519 signing [1702] implements cryptographic signing with digital authentication and key management, receiving from event source and outputting event data to digital signatures [1704]. Digital signatures [1704] provide event authentication and integrity verification, receiving event data from Ed25519 signing [1702], outputting system events to system events [1706], and distributing to timestamp [1708] and event type [1710].

System events [1706] capture operation records and activity logging, receiving system events from digital signatures [1704] and outputting to actor identity [1712]. Actor identity [1712] records administrative user identifiers, receiving from system events [1706] and outputting log data to Merkle tree builder [1714].

Merkle tree builder [1714] implements tree construction with hash chaining and structural integrity, receiving log data from actor identity [1712], outputting hash tree to tamper-evident structure [1720], and distributing to event chaining [1716] and SHA-256 [1718]. SHA-256 [1718] implements cryptographic hash, creating tamper-evident structure [1720] wherein any modification would break the cryptographic chain. Tamper-evident structure [1720] provides integrity protection and modification detection, receiving hash tree from Merkle tree builder [1714] and outputting audit data to audit output.

### Immutable Storage & Replication Layer

Append-only logs [1722] implement immutable records with sequential storage and write-only access, outputting replication data to log replication [1728] and archive to event storage [1724] and no deletion capability [1726]. Event storage [1724] maintains persistent records outputting to retention system. No deletion capability [1726] enforces immutability outputting to retention system, implementing append-only storage.

Log replication [1728] implements multi-site storage with redundancy protection and fault tolerance, receiving replication data from append-only logs [1722], outputting compliance access to compliance interface [1734], and distributing to log copies [1730] and availability zones [1732]. This replication across availability zones [1732] implements hierarchical ledger partitioning per Claims 12, 25. Retention system maintains long-term storage and archive management, receiving from event storage [1724] and no deletion capability [1726], outputting compliance data to financial compliance [1748].

### Compliance & Verification Access Layer

Compliance interface [1734] provides regulatory access and audit trail export, receiving compliance access from log replication [1728], outputting verification access to verification API [1740], and distributing to report generation [1736] and regulators [1738]. Report generation [1736] creates compliance reports, while regulators [1738] receive audit requests and output to external auditors.

Verification API [1740] enables third-party access and integrity checking, receiving verification access from compliance interface [1734] and distributing to third-party validation [1742] and log integrity [1744]. This API implements third-party validation [1742] of log integrity [1744] per Claims 13(b), 22, providing cryptographic proof enforcement decisions followed stated policies. Financial compliance [1748] maintains regulatory requirements and audit standards, receiving compliance data from retention system supporting extended retention [1746] for financial compliance [1748].

Layer annotations: CRYPTOGRAPHIC SIGNING & VERIFICATION LAYER contains Ed25519 signing [1702], digital signatures [1704], system events [1706], timestamp [1708], event type [1710], actor identity [1712], Merkle tree builder [1714], event chaining [1716], SHA-256 [1718], tamper-evident structure [1720], event source, and audit output. IMMUTABLE STORAGE & REPLICATION LAYER contains append-only logs [1722], event storage [1724], no deletion capability [1726], log replication [1728], log copies [1730], availability zones [1732], and retention system. COMPLIANCE & VERIFICATION ACCESS LAYER contains compliance interface [1734], report generation [1736], regulators [1738], verification API [1740], third-party validation [1742], log integrity [1744], financial compliance [1748], and external auditors. The COMPREHENSIVE AUDIT CRYPTOGRAPHY & COMPLIANCE FRAMEWORK annotation spans entire system [1700].

Audit architecture [1700] implements verified transaction logging system comprising immutable ledger [138]. Ed25519 signing [1702] generating digital signatures [1704] implements aspects of embodiments of the present invention for all system events [1706] including timestamp [1708], event type [1710], and actor identity [1712]. Merkle tree builder [1714] with event chaining [1716] using SHA-256 [1718] implements aspects of embodiments of the present invention creating tamper-evident structure [1720] wherein any modification invalidates cryptographic chain. Append-only logs [1722] with event storage [1724], no deletion capability [1726], and log replication [1728] across availability zones [1732] implements immutable storage with hierarchical ledger partitioning. Compliance interface [1734] with report generation [1736] for regulators [1738] implements aspects of embodiments of the present invention. Verification API [1740] enabling third-party validation [1742] of log integrity [1744] implements aspects of embodiments of the present invention providing cryptographic proof enforcement decisions followed stated policies. Extended retention supporting financial compliance [1748] demonstrates regulatory audit capability. The architecture creates comprehensive audit trail enabling forensic analysis, regulatory compliance, and third-party verification of all enforcement decisions within the BQS Unity Framework.

Referring now to FIG. 18, a fallback and graceful degradation subsystem [1800], is shown according to aspects of embodiments of the present invention. Resilience subsystem [1800] comprises twenty-eight (28) elements organized in three layers implementing cached decision paths, circuit breakers, progressive degradation, and recovery protocols ensuring enforcement continuity during infrastructure failures.

### Failure Detection & Cache Response Layer

Cached decision paths [1802] maintain recent decisions and qualification results for fast retrieval, receiving from system requests [input] and failure signals [input], outputting fallback and failure detection to primary system failure [1808] and cache data to cache lookup [1810], and distributing to recent results [1804] and memory storage [1806]. Primary system failure [1808] detects system failures through failure detection and system monitoring, receiving fallback and failure detection from cached decision paths [1802] and outputting cutover request to cache lookup [1810].

Cache lookup [1810] provides fast response and decision retrieval, receiving cache data from cached decision paths [1802] and cutover request from primary system failure [1808], outputting response to fast response [1812]. This cached response path implements rapid fallback during primary system failure [1808], maintaining enforcement continuity through cached decision paths [1802] with recent results [1804].

### Circuit Protection & Degradation Management Layer

Circuit breakers [1814] implement failure pattern detection with traffic management and system protection, outputting redirect response and cache override to backup systems [1820], and distributing to failure patterns [1816] and traffic redirect [1818]. Failure patterns [1816] identify systemic issues, while traffic redirect [1818] routes traffic outputting degraded output to degraded service [output]. Backup systems [1820] provide secondary processing with standby resources, receiving redirect response and cache override from circuit breakers [1814], outputting backup response to system responses [output] and backup output to backup responses [output], implementing automatic failover.

Progressive degradation [1822] implements feature prioritization with service reduction and graceful shutdown, receiving from health status [input], outputting final fallback to static rules fallback [1828], and distributing to ML scoring disable [1824] and real-time disable [1826]. This progressive feature disabling maintains essential enforcement: ML scoring [1824] and real-time processing [1826] disable first, while static rules fallback [1828] maintains basic qualification implementing graceful degradation. Static rules fallback [1828] provides basic qualification with rule-based processing, receiving final fallback from progressive degradation [1822] and outputting degradation control to recovery protocols [1830].

### Recovery & Restoration Control Layer

Recovery protocols [1830] implement system restoration with service recovery and gradual reactivation, receiving degradation control from static rules fallback [1828], outputting recovery path to exponential backoff [1832], and distributing to backoff timing [1834-1836] and health checks [1838]. Exponential backoff [1832] prevents thundering herd through progressively delayed reconnection attempts, receiving recovery path from recovery protocols [1830] and outputting load control to recovery control [input] feeding thundering herd prevention [1848].

Health checks [1838] perform periodic testing with system status and availability testing, receiving from recovery protocols [1830], outputting health status to recovery detection [1844], and distributing to check intervals [1840] and system availability [1842]. Recovery detection [1844] verifies system restoration and status verification, receiving health status from health checks [1838] and outputting recovery signal to gradual reactivation [1846]. Gradual reactivation [1846] implements phased restart with load management, receiving recovery signal from recovery detection [1844] and outputting restoring service to normal operation [output], completing recovery cycle preventing cascading failures.

Layer annotations: FAILURE DETECTION & CACHE RESPONSE LAYER contains cached decision paths [1802], recent results [1804], memory storage [1806], primary system failure [1808], cache lookup [1810], fast response [1812], system requests [input], failure signals [input], and health status [input]. CIRCUIT PROTECTION & DEGRADATION MANAGEMENT LAYER contains circuit breakers [1814], failure patterns [1816], traffic redirect [1818], backup systems [1820], progressive degradation [1822], ML scoring disable [1824], real-time disable [1826], static rules fallback [1828], system responses [output], backup responses [output], and degraded service [output]. RECOVERY & RESTORATION CONTROL LAYER contains recovery protocols [1830], exponential backoff [1832], backoff timing [1834-1836], health checks [1838], check intervals [1840], system availability [1842], recovery detection [1844], gradual reactivation [1846], thundering herd prevention [1848], recovery control [input], and normal operation [output]. The COMPREHENSIVE RESILIENCE & GRACEFUL DEGRADATION FRAMEWORK annotation spans entire system [1800].

Resilience subsystem [1800] implements graceful degradation maintaining enforcement continuity during failures. Cached decision paths [1802] with recent results [1804] implement provision of rapid response during primary system failure [1808]. Circuit breakers [1814] detecting failure patterns [1816] with traffic redirect [1818] to backup systems [1820] implement the prevention of cascading failures. Progressive degradation [1822] disabling ML scoring [1824] and real-time processing [1826] while maintaining static rules fallback [1828] implements Definition #25: essential enforcement continues through rule-based qualification even when advanced features fail. Exponential backoff [1832] preventing thundering herd [1848] implements recovery safeguards. Health checks [1838] with gradual reactivation [1846] ensure stable restoration. The subsystem demonstrates system resilience maintaining mandatory pre-spend enforcement even during infrastructure failures: cached decisions, circuit breaker failover, progressive degradation, and controlled recovery ensure qualification gating operates continuously, preventing unqualified requests from reaching auctions regardless of infrastructure state. All degraded decisions are annotated in audit log [1722] enabling later reconciliation through feedback system [1600].

### Alternative Embodiments

The foregoing detailed description presents specific implementations of the closed-loop behavioral verification and reconciliation system. However, those skilled in the art will recognize that numerous alternative embodiments may be implemented without departing from the inventive concepts disclosed herein. This section describes additional exemplary, non-limiting alternative implementations for key system components, demonstrating the breadth of the disclosed invention while maintaining the unified BQS governance framework coordinated through BQS Unity Framework [102].

### Cryptographic Implementation Alternatives

The cryptographic signing mechanisms described throughout this specification employ Ed25519 signing [1702] generating digital signatures [1704] as disclosed in FIGS. 5, 10, 14, 17 and as referenced in Applicant's Claims. Alternative embodiments may employ other elliptic curve cryptography schemes including ECDSA with NIST P-256 or P-384 curves, post-quantum cryptographic algorithms such as CRYSTALS-Dilithium or SPHINCS+, RSA signatures with minimum 2048-bit keys, or combinations thereof. The selection of cryptographic algorithm does not alter the functional role of digital signatures [1704] in creating tamper-evident audit records [136] stored in immutable ledger [138].

The cryptographic hashing implementations utilize SHA-256 hashing [1136], [1718] as disclosed in FIGS. 5, 11, 17 and referenced in Applicant's Claims. Alternative embodiments may employ SHA-3 (Keccak) family algorithms, BLAKE2 or BLAKE3 hash functions, post-quantum hash-based signatures, or domain-specific hash functions optimized for particular deployment environments. Hash function selection affects computational performance but does not alter the creation of tamper-evident record chains through Merkle tree builder [1714] with event chaining [1716] implementing hierarchical hash structures.

The cryptographic nonces [1012] generated through nonce-based cryptographic signing [1014] as disclosed in FIG. 10 and referenced in Applicant's Claims may alternatively employ timestamp-based nonces, counter-based nonces with synchronized state, challenge-response protocols, or hybrid approaches combining multiple nonce generation strategies. Session keys [1016] derived from enforcement tokens [1018] may alternatively use Diffie-Hellman key exchange, pre-shared key derivation, or quantum key distribution protocols in quantum-secure embodiments.

### API Architecture Alternatives

The asynchronous API architecture [300] exposing non-blocking communication endpoints through qualification engine [310] and beacon service [322] as disclosed in FIG. 3 and referenced in Applicant's Claims represents one implementation approach. Alternative embodiments may employ synchronous REST APIs with request-response blocking, GraphQL query interfaces enabling client-specified data retrieval, gRPC with protocol buffer serialization for high-performance inter-service communication, WebSocket connections maintaining persistent bidirectional channels, message queue systems (RabbitMQ, Apache Kafka) with publish-subscribe patterns, or hybrid architectures combining multiple communication paradigms based on latency requirements and deployment constraints.

Correlation identifiers [330] maintaining end-to-end request tracing as disclosed in FIG. 3 may alternatively employ distributed tracing frameworks (OpenTelemetry, Jaeger, Zipkin), context propagation through HTTP headers or message metadata, or application-layer correlation using domain-specific identifiers. Circuit breaker mechanisms [1814] detecting failure patterns [1816] as disclosed in FIGS. 9, 18 and referenced in Applicant's Claims may alternatively implement Netflix Hystrix patterns, Istio service mesh circuit breakers, custom threshold-based breakers, or adaptive circuit breakers learning failure patterns through reinforcement learning [1612].

### Machine Learning Algorithm Alternatives

Fraud scoring engine [512] employing ensemble methods comprising isolation forest [514], gradient boosting [516], and neural networks [518] as disclosed in FIGS. 5, 9 and referenced in Applicant's Claims represents one machine learning approach. Alternative embodiments may employ support vector machines (SVM) for binary fraud classification, random forest classifiers aggregating decision tree predictions, XGBoost or LightGBM gradient boosting implementations, convolutional neural networks (CNN) for spatial pattern recognition in behavioral sequences, recurrent neural networks (RNN) or long short-term memory (LSTM) networks for temporal fraud pattern detection, transformer architectures for attention-based behavioral analysis, or AutoML systems automatically selecting optimal algorithm configurations.

The reinforcement learning [1612] with policy gradient methods [1614] and Q-learning algorithm [1230] as disclosed in FIGS. 12, 16 and referenced in Applicant's Claims may alternatively employ deep Q-networks (DQN), actor-critic methods, proximal policy optimization (PPO), trust region policy optimization (TRPO), or multi-armed bandit algorithms for parameter optimization. The ensemble methods [1222] combining rules-based assessment [1224] and ML-based assessment [1226] as disclosed in FIG. 12 and referenced in Applicant's Claims may alternatively implement stacking ensembles, blending techniques, or Bayesian model averaging.

### Similarity Metric Alternatives

The similarity metrics [1114] comprising cosine distance [1116] and Jaccard index [1118] as disclosed in FIG. 11 and referenced in Applicant's Claims represent specific mathematical approaches for behavioral fingerprint [1102] matching. Alternative embodiments may employ Euclidean distance measurements in normalized behavioral space, Manhattan (L1) distance for sparse behavioral vectors, Hamming distance for binary behavioral representations, edit distance (Levenshtein) for sequential behavioral patterns, Mahalanobis distance accounting for behavioral covariance, locality-sensitive hashing (LSH) for approximate nearest-neighbor matching, MinHash for set similarity with probabilistic guarantees, or learned similarity functions trained through metric learning approaches.

The beacon correlation matrix [1126] tracking multiple conversion paths [1128] implementing multi-touch attribution [1130] as disclosed in FIG. 11 and referenced in Applicant's Claims may alternatively employ graph-based attribution models, Markov chain attribution, Shapley value game-theoretic attribution, time-decay models with configurable decay functions, position-based attribution weighting first and last touches, or data-driven attribution learning optimal credit assignment from historical conversion data.

### Data Structure Alternatives

The interval-tree structure [710] enabling efficient conflict detection [712] as disclosed in FIG. 7 and referenced in Applicant's Claims represents one approach to temporal constraint management. Alternative embodiments may employ segment trees for range query operations, B-trees or B+ trees for disk-based sorted storage, R-trees for multidimensional spatial-temporal queries, skip lists providing probabilistic balanced search, or hash-based partitioning for distributed temporal constraint evaluation.

The Merkle tree structure [1134] creating hierarchical hash structures as disclosed in FIGS. 11, 17 and referenced in Applicant's Claims may alternatively employ Patricia tries for space-efficient prefix trees, sparse Merkle trees for efficient proof generation with missing leaves, authenticated data structures providing verifiable query results, or blockchain-style hash chains with distributed consensus mechanisms. Cache storage [1112] providing performance optimization as disclosed in FIGS. 11, 12 and referenced in Applicant's Claims may alternatively implement Redis distributed caching, Memcached memory caching, Ehcache Java caching, or custom application-level caches with domain-specific eviction policies.

The tenant data stores [806] with row-level security [808] as disclosed in FIG. 8 and referenced in Applicant's Claims may alternatively employ column-family databases (Cassandra, HBase), document stores (MongoDB, Couchbase), graph databases (Neo4j, Amazon Neptune) for relationship-intensive data, time-series databases (InfluxDB, TimescaleDB) optimized for temporal behavioral data, or NewSQL databases (CockroachDB, Google Spanner) providing ACID guarantees with horizontal scalability.

### Privacy-Preserving Technique Alternatives

The differential privacy [820] with privacy budget manager [822] as disclosed in FIGS. 8, 9 and referenced in Applicant's Claims represents one privacy-preserving approach. Alternative embodiments may employ k-anonymity ensuring each record is indistinguishable from at least k−1 other records, 1-diversity providing diversity within equivalence classes, t-closeness limiting distance between attribute distributions, secure multi-party computation (MPC) enabling joint computation without revealing individual inputs, homomorphic encryption allowing computation on encrypted data, or federated learning [816] with model gradient exchange [818] as disclosed in FIG. 8 and referenced in Applicant's Claims using secure aggregation protocols.

The privacy-preserving techniques for non-PII matching through beacon correlation matrix [1126] as disclosed in FIG. 11 may alternatively employ zero-knowledge proofs demonstrating properties without revealing underlying data, private set intersection protocols identifying common elements without exposing non-overlapping sets, trusted execution environments (Intel SGX, AMD SEV) providing hardware-isolated computation, or synthetic data generation creating privacy-preserving behavioral proxies.

### Federated Learning Implementation Alternatives

The federated learning [816] with model gradient exchange [818] implementing shared learning as disclosed in FIG. 8 and referenced in Applicant's Claims may alternatively employ federated averaging (FedAvg) aggregating model weights rather than gradients, secure aggregation protocols using cryptographic techniques to prevent gradient inspection, split learning partitioning model computation between client and server, federated transfer learning leveraging pre-trained models, or vertical federated learning for scenarios where different parties hold different features for the same users.

The differential privacy [820] mechanisms applied to federated learning may alternatively use local differential privacy where noise is added client-side before aggregation, central differential privacy with server-side noise injection, or adaptive privacy budgets adjusting based on model convergence. The privacy budget manager [822] implementing epsilon control may alternatively employ Renyi differential privacy providing tighter composition bounds, zero-concentrated differential privacy (zCDP) enabling better utility-privacy tradeoffs, or privacy amplification through subsampling and shuffling.

### Storage System Alternatives

The append-only logs [1722] with event storage [1724] and no deletion capability [1726] as disclosed in FIG. 17 and referenced in [0319] may alternatively employ write-ahead logs (WAL) ensuring durability, log-structured merge trees (LSM) optimizing write throughput, event sourcing systems capturing state changes as immutable events, or distributed ledger technologies (Hyperledger Fabric, Corda) providing permissioned blockchain capabilities. Log replication [1728] distributing log copies [1730] across availability zones [1732] may alternatively implement Raft consensus protocols, Paxos-based replication, multi-master replication with conflict resolution, or chain replication providing strong consistency with high read throughput.

The immutable ledger [138] creating cryptographically verifiable audit trails may alternatively employ permissioned blockchain networks, hash-based time-stamping services, certificate transparency logs, or hybrid approaches combining traditional databases with blockchain anchoring for periodic integrity proofs. The verification API [1740] enabling third-party validation [1742] of log integrity [1744] as disclosed in FIG. 17 and referenced in Applicant's Claims may alternatively expose Merkle proof endpoints, blockchain transaction verification, or cryptographic accumulator queries.

### Deployment Architecture Alternatives

The multi-tenant orchestration engine [800] with cryptographically isolated pipelines [802A-C] as disclosed in FIG. 8 represents one deployment approach. Alternative embodiments may employ container orchestration (Kubernetes) with namespace isolation, serverless function deployments (AWS Lambda, Azure Functions) with event-driven invocation, microservices architectures with service mesh (Istio, Linkerd) providing observability and security, or monolithic deployments with logical tenant separation through application-layer controls.

The distributed fraud detection infrastructure [900] with detection nodes [902A-N]processing subset streams [904A-N] as disclosed in FIG. 9 and referenced in Applicant's Claims may alternatively employ stream processing frameworks (Apache Flink, Apache Storm, Apache Kafka Streams), batch processing systems (Apache Spark) with micro-batch windowing, lambda architectures combining batch and stream processing, or kappa architectures using stream processing for all computation paths.

### Beacon Deployment Method Alternatives

The client-side integration [1002] providing JavaScript tags [1004], mobile SDKs [1006], and server postbacks [1008] as disclosed in FIG. 10 and referenced in Applicant's Claims represents one beacon deployment approach. Alternative embodiments may employ browser extensions with direct DOM access, service workers intercepting network requests, pixel tracking through transparent images, server-side rendering with injected beacons, mobile application frameworks (React Native, Flutter) with native beacon implementations, or hybrid approaches combining multiple deployment methods based on platform capabilities and privacy constraints.

The asynchronous transmission [1030] with exponential backoff [1042] handling failed transmissions [1040] as disclosed in FIG. 10 and referenced in Applicant's Claims may alternatively employ fixed retry intervals, jittered exponential backoff preventing synchronized retries, circuit breaker patterns preventing cascade failures, or adaptive retry strategies learning optimal retry timing from historical success rates.

### Optional Embodiment Variations

The sponsorship matching system [600] disclosed in FIG. 6 represents an optional embodiment demonstrating platform extensibility. When implemented, alternative matching algorithms may employ collaborative filtering predicting sponsor preferences from similar users, content-based filtering matching sponsor attributes to user profiles, hybrid recommender systems combining multiple approaches, matrix factorization discovering latent factors, or deep learning embedding models learning optimal matching representations.

The conflict avoidance system [700] disclosed in FIG. 7 represents another optional embodiment for multi-sponsor environments. When implemented, alternative conflict resolution strategies may employ auction-based priority assignment, weighted lottery systems providing probabilistic fairness, time-based scheduling with guaranteed delivery windows, or dynamic programming approaches optimizing long-term sponsor satisfaction rather than immediate conflict resolution.

### System Integration Alternatives

The BQS Unity Coordination Engine [102] managing BQS Unity Score [104] and BQS Weighting Factors [110] as disclosed in FIG. 1 coordinates all system operations through a single unified metric. Alternative implementations may employ different scoring formulas maintaining functional equivalence, hierarchical scoring with sub-metrics aggregating into unified BQS, or adaptive scoring functions learning optimal combinations through meta-learning approaches. Regardless of implementation details, the fundamental architecture remains: pre-spend qualification through compliance gateway [126], signature-based reconciliation through reconciliation engine [1100], cryptographic audit through immutable ledger [138], and closed-loop feedback through feedback system [1600] all orchestrated through unified BQS governance.

The closed-loop feedback system [1600] with BQS Unity Optimizer [1634] coordinating BQS enforcement weight [1636], efficiency factor [1638], enforcement level [1640], and unity balance [1642] as disclosed in FIG. 16 and referenced in Claims 23(d), 27, 31, 33(l), 43(l) may alternatively employ gradient-free optimization (Nelder-Mead, genetic algorithms), Bayesian optimization with Gaussian process surrogates, evolutionary strategies, or multi-objective optimization balancing competing objectives (false positives vs. false negatives, security vs. friction) through Pareto efficiency.

The foregoing alternative embodiments demonstrate the broad applicability of the disclosed closed-loop behavioral verification and reconciliation system across diverse technical implementations. The selection of specific cryptographic algorithms, machine learning models, data structures, API architectures, and deployment approaches represents engineering choices that do not alter the fundamental inventive concept: pre-spend behavioral qualification preventing digital advertising waste through mandatory compliance gating [126], signature-based reconciliation [1100], cryptographically-attested audit trails [138], and recursive policy optimization [1600], all orchestrated through the unified BQS framework [102] coordinating between the Omnibus Application qualification and Parent 2 enforcement applications.

Those skilled in the art will recognize that the disclosed system provides numerous advantages over prior art post-spend detection systems regardless of specific implementation choices: (1) waste prevention occurs before budget commitment through pre-spend gating rather than after economic damage, (2) cryptographic immutability through digital signatures [1704] and hash chaining [1716] creates mathematically verifiable proof that cannot be disputed, (3) privacy-native operation using ephemeral behavioral fingerprints [1102] complies with global privacy regulations through consent module [1500], (4) real-time adaptation through closed-loop feedback [1600] enables the system to respond to emerging fraud patterns without manual intervention, and (5) unified scoring through BQS Unity Framework [102] eliminates complexity of managing multiple independent variables while maintaining sophisticated multi-dimensional optimization.

All equivalents, modifications, and variations falling within the scope of the claims are intended to be covered by this disclosure. The true spirit and scope of the invention are defined by the following claims as coordinated through the BQS Unity Framework [102] spanning the Omnibus Application (qualification) and Parent 2 (enforcement) applications, wherein all system decisions—from initial behavioral scoring through enforcement, verification, reconciliation, and optimization—are orchestrated through the single unified BQS metric implementing pre-spend waste prevention in digital advertising.

1. A closed-loop behavioral verification and reconciliation system for digital advertising, comprising:
a signature-based reconciliation engine;
a qualified attribution score generator configured to: detect deviations between pre-qualification scores and post-engagement outcomes received from said signature-based reconciliation engine, and generate feedback signals for qualification refinement;
a non-PII matching system; and
engagement verification beacons, wherein said system is configured to validate engagements against pre-qualification requirements and propagates said feedback signals through a feedback loop to update said pre-qualification scores and enforces qualification requirements based on updated pre-qualification scores, thereby achieving continuous improvement through deterministic recalibration.

2. The system of claim 1, wherein said signature-based reconciliation engine is configured to receive engagement verification data comprising behavioral interaction patterns captured without any one of: personally identifiable information, device identifiers, persistent cookies.

3. The system of claim 1, wherein said signature-based reconciliation engine is configured to generate behavioral fingerprints using one-way hash functions, wherein said one-way hash functions comprise any one of: SHA-256 hashing, SHA-3 algorithms, BLAKE2 algorithms.

4. The system of claim 1, wherein said signature-based reconciliation engine is configured to compare generated behavioral fingerprints against cohort signatures stored in cache storage using similarity metrics, wherein said similarity metrics comprise of any one of: cosine distance calculations, Jaccard index calculations, Euclidean distance measurements, weighted combinations.

5. The system of claim 1, wherein said signature-based reconciliation engine is configured to generate behavioral fingerprints, wherein said behavioral fingerprints are configured to capture normalized engagement sequences comprising any one or combinations of: scroll depth patterns, dwell time distributions, interaction velocities, gesture classifications.

6. The system of claim 1, wherein said qualified attribution score generator is further configured to apply any one of: fraud-weighted adjustments receiving multiplicative factors proportional to fraud probability, temporal consistency validation analyzing timing patterns between pre-qualification and engagement events, contextual coherence verification assessing alignment between expected context and actual engagement environment.

7. The system of claim 1, wherein said engagement verification beacons are configured to be implemented through client-side integration comprising any one of: JavaScript tags embedded within web-based advertising content, mobile software development kits integrated within native applications, server postbacks transmitting engagement confirmations through API endpoints.

8. The system of claim 1, wherein said engagement verification beacons are configured to perform any one of: event batching aggregating multiple interaction events before network transmission, exponential backoff retry mechanisms handling failed transmissions through progressively delayed retry attempts, session key derivation generating encryption keys from enforcement tokens.

9. The system of claim 1, wherein said non-PII matching system is configured to implement any one of: differential privacy mechanisms with a privacy budget manager adding calibrated statistical noise to aggregated behavioral patterns, k-anonymity enforcement suppressing reporting of behavioral cohorts containing fewer than a minimum threshold number of users, ephemeral identifier expiration removing correlation capability after predefined retention windows.

10. The system of claim 1, wherein said signature-based reconciliation engine is configured to store reconciliation events in event chaining through Merkle tree structure with SHA-256 hashing.

11. The system of claim 1, wherein said feedback signals generated through said feedback loop comprise any one of: BQS weighting factor adjustments indicating changes to relative importance of behavioral signal dimensions, threshold calibration recommendations through qualification thresholds indicating modifications to minimum qualification requirements, fraud detection sensitivity adjustments indicating changes to anomaly detection parameters.

12. The system of claim 1, wherein said signature-based reconciliation engine is configured to receive engagement verification data from beacon data systems, wherein said engagement verification data comprises multi-touch interaction sequences tracked through a beacon correlation matrix across multiple advertising exposures without maintaining persistent identifiers between sessions.

13. A pre-spend enforcement and audit infrastructure system for digital advertising operating in conjunction with a behavioral qualification system, comprising:
an enforcement proxy gateway comprising a compliance gateway configured to receive behavioral qualification scores from said behavioral qualification system:
a verified transaction logging system;
an enhanced fraud detection system; and
a real-time consent and privacy management engine,
wherein said pre-spend enforcement and audit infrastructure system prevents advertising waste before budget commitment through mandatory enforcement of said behavioral qualification scores via said compliance gateway and creates immutable audit trails through cryptographic audit records demonstrating regulatory compliance.

14. The system of claim 13, wherein said compliance gateway is configured to generate cryptographically signed authorization tokens, wherein said cryptographic authorization tokens comprise any one or combinations of: transaction hashes generated using SHA-256 cryptographic hashing, digital signatures generated using Ed25519 signing elliptic curve cryptography, expiration timestamps limiting token validity periods.

15. The system of claim 13, wherein said enforcement proxy gateway is configured to implement any one of: a policy rules engine maintaining advertiser-defined thresholds and brand safety requirements, a fraud signal interface receiving real-time fraud scores from fraud detection clusters, a gating logic processor executing parallel evaluation through a decision tree with a BQS threshold check, fraud score validation and policy compliance verification, an in-memory rule caching system storing frequently accessed policy configurations.

16. The system of claim 13, wherein said verified transaction logging system comprising said immutable ledger is configured to implement any one of: Ed25519 digital signature generation with key rotation schedules, Merkle tree construction creating hierarchical hash structures with SHA-256, multi-zone replication through log replication distributing log copies across geographically separated availability zones, append-only storage with no deletion capability.

17. The system of claim 13, wherein said enhanced fraud detection system is configured to employ ensemble methods through a fraud scoring engine comprising any one of: isolation forest code configured to detect anomalous behavioral patterns, gradient boosting classifiers identifying fraud through iterative refinement, neural network pattern recognizers configured to detect complex fraud signatures, combinations aggregating predictions from multiple detection code.

18. The system of claim 13, wherein said enhanced fraud detection system is configured to implement distributed fraud detection infrastructure comprising any one of: multiple detection nodes configured to process subset streams in parallel, a cohorting engine configured to form fraud cohorts through clustering analysis based on behavioral similarity, cross-tenant analytics wherein said cross-tenant analytics identify fraud patterns spanning multiple advertiser accounts through differential privacy.

19. The system of claim 13, wherein said real-time consent and privacy management engine is configured to implement operation of any one of: opt-in flow processors capturing granular consent by data categories, opt-out flow processors providing immediate revocation with cascade deletion capabilities, jurisdiction detection logic determining applicable privacy regulations based on user location, or multi-stage policy enforcement applying privacy constraints across data ingestion, processing, and output stages.

20. The system of claim 13, wherein said enforcement proxy gateway comprising said compliance gateway is configured to implement graduated enforcement through a suppression controller comprising any one of: complete bid blocking for requests with qualification scores below minimum acceptance thresholds, proportional rate limiting for requests with marginal qualification scores, bid value reduction for borderline requests.

21. The system of claim 13, wherein all enforcement decisions, fraud detection events, and consent management actions are configured to generate audit records through conflict event logging and audit trail comprising administrative user identifiers from actor identity, timestamps, event types, and digital signatures.

22. The system of claim 13, further comprising compliance reporting interfaces configured to perform any one of: generating regulatory audit reports through report generation demonstrating adherence to compliance requirements, exporting audit data to external auditors in standardized formats, providing third-party verification APIs enabling independent auditors to validate system operation through third-party validation.

23. A performance-optimized machine learning system for closed-loop behavioral qualification in digital advertising, comprising:
an asynchronous API architecture;
high-performance data structures;
a machine learning behavioral analysis system; and
a closed-loop feedback pipeline; wherein said system maintains operational responsiveness while continuously improving qualification accuracy through closed-loop learning and optimization framework achieving continuous improvement.

24. The system of claim 23, wherein said asynchronous API architecture is configured to implement any one of: service mesh integration through orchestration layer providing mutual TLS authentication between services, rate limiting mechanisms through weighted fair queuing enforcing per-tenant request quotas, API versioning strategies supporting backward-compatible endpoint evolution, automatic service discovery with resource manager allocating compute resources and load balancing.

25. The system of claim 23, wherein said high-performance data structures comprise any one of; hash tables, interval trees, bloom filters, sparse vector representations, ring buffers.

26. The system of claim 23, wherein said machine learning behavioral analysis system is configured to implement any one of: reinforcement learning, Q-learning code, ensemble model updating through ensemble methods, neural network architectures.

27. The system of claim 23, wherein said closed-loop feedback pipeline is configured to implement any one of: model updater modules, threshold recalibration logic analyzing false positive and false negative rates through qualification thresholds, fraud model retraining pipelines, federated learning coordination aggregating model gradients through differential privacy from multiple gateway instances.

28. The system of claim 23, wherein said high-performance data structures are configured to implement multi-tier cache hierarchies comprising any one of: first-level caches maintaining frequently accessed qualification scores in processor cache memory, second-level caches storing broader qualification score sets through cache storage in application memory, distributed cache clusters replicating qualification data through log replication across multiple nodes, or persistent storage backing caches through tenant data stores with durable qualification score records.

29. The system of claim 23, wherein said asynchronous API architecture is configured to implement graceful degradation through a resilience subsystem comprising any one of: cached decision paths with recent results returning pre-computed enforcement decisions during primary system failure, circuit breakers detecting failure patterns and automatically redirecting traffic to backup systems, or progressive degradation disabling ML scoring and real-time processing while maintaining static rules fallback.

30. The system of claim 23, wherein said machine learning behavioral analysis system is configured to receive inputs from any one of: signature-based reconciliation engines providing match results, qualified attribution score generators providing attribution confidence assessments, fraud detection systems providing fraud scores and anomaly detection signals from detection nodes, or consent management engines providing consent status compliance status.

31. The system of claim 23, wherein said closed-loop feedback pipeline comprising feedback system is configured to implement convergent optimization through an optimization cycle wherein said cycle enables any one of: parameter adjustments through model parameters stabilized within bounded iteration counts, local optimizations in individual system components propagate through real-time adaptation to achieve global performance improvements, or boundary condition enforcement through BQS threshold control prevents extreme parameter values that would destabilize system operation.

32. The system of claim 23, further comprising performance monitoring subsystems comprising SLA management configured to perform any one of: tracking processing latency through current load across all system components, identifying performance bottlenecks through distributed tracing using correlation identifiers, or triggering automatic optimization responses through resource manager when latency approaches operational thresholds.

33. A computer-implemented method for closed-loop behavioral qualification and enforcement in digital advertising, comprising, executing, on at least one processor configured to perform a predefined set of basic operations in response to receiving a corresponding basic computer executable instruction selected from a predefined native instruction set of codes, steps of:
executing signature-based reconciliation through a reconciliation system;
computing qualified attribution scores through a QAS generator;
performing non-PII matching by correlating engagement events;
capturing engagement verification through beacons; and
enforcing pre-spend qualification through compliance gateway.

34. The computer-implemented method of claim 33, wherein said computer-implemented method enables any one or more of: engagement validation against pre-qualification requirements, advertising waste prevention before budget commitment, creation of immutable audit trail, maintenance of operational responsiveness while continuously improving qualification accuracy.

35. The computer-implemented method of claim 34, further comprising steps of:
logging verified transactions through an immutable ledger;
detecting fraud through fraud enforcement architecture;
managing consent and privacy through consent module;
implementing asynchronous API processing;
optimizing data structure performance;
executing machine learning behavioral analysis; and
optimizing through closed-loop feedback system.

36. The computer-implemented method of claim 35, wherein said verified transactions are logged through an immutable ledger by any one or a combination of: recording enforcement decisions in append-only logs, generating digital signatures through Ed25519 signing, creating tamper-evident chains through a Merkle tree builder with event chaining, exposing verification interfaces through a verification API.

37. The computer-implemented method of claim 35, wherein said fraud detection through fraud architecture may be implemented by any one or a combination of: aggregating behavioral signals from a behavioral analysis module, performing anomaly detection through a pattern recognizer, computing fraud probability scores, generating suppression signals through a suppression controller, executing multi-vector analysis through a fraud scoring engine wherein said analysis employs isolation forest, gradient boosting, and neural networks.

38. The computer-implemented method of claim 35, wherein said consent and privacy management is implemented by any one or a combination of: enforcing jurisdiction-specific policies through jurisdiction-specific logic, managing consent through opt-in flows and opt-out mechanisms, implementing consent-gated qualification through policy enforcement, executing cascade deletion processes.

39. The computer-implemented method of claim 35, wherein said API processing is implemented through any one or a combination of: API interaction sequence by exposing non-blocking endpoints through a qualification engine and beacon service, processing requests asynchronously, maintaining correlation identifiers, providing circuit breaker mechanisms.

40. The computer-implemented method of claim 35, wherein said data structure performance optimization is implemented by any one or a combination of: storing qualification state in tenant data stores, implementing distributed caching through weighted fair queuing, utilizing interval-tree structure for policy access, maintaining event buffers through event batching.

41. The computer-implemented method of claim 35, wherein said machine learning behavioral analysis is implemented by any one or a combination of: analyzing reconciliation outcomes from reconciliation outputs to identify qualification errors within policy-defined tolerance thresholds, computing recalibration recommendations through a recalibration trigger subject to governance constraints, applying reinforcement learning through reinforcement updater and Q-learning bounded by advertiser-defined policy rules, updating fraud models through retraining constrained by regulatory compliance requirements.

42. The computer-implemented method of claim 35, wherein said closed-loop feedback system optimization is implemented by any one or a combination of: collecting verified outcome data from reconciliation outputs, computing performance metrics through model updates, generating parameter adjustments through a BQS Unity Optimizer, propagating updated parameters through model parameters.

43. The computer-implemented method of claim 33, wherein said signature-based reconciliation execution is by use of one-way hash functions, wherein said one-way hash functions comprise any one of: SHA-256 hashing, SHA-3 algorithms, or BLAKE2 algorithms.

44. The computer-implemented method of claim 33, wherein said signature-based reconciliation execution is by comparing generated behavioral fingerprints against cohort signatures using similarity metrics, wherein said similarity metrics comprise any one of: cosine distance, Jaccard index, Euclidean distance measurements, or weighted combinations thereof.

45. The computer-implemented method of claim 33, wherein said step of enforcing pre-spend qualification through compliance gateway is implemented by authorizing qualified requests through a token generator generating cryptographic authorization tokens, wherein said cryptographic authorization tokens comprise any one or a combination of: transaction hashes using SHA-256, digital signatures using Ed25519 signing, expiration timestamps.

46. The computer-implemented method of claim 37, wherein said executed multi-vector analysis through said fraud scoring engine comprises computer-implemented ensemble methods which comprise of any one of or combinations of: isolation forest code, gradient boosting classifiers, neural network pattern recognizers.

47. The computer-implemented method of claim 35, wherein said privacy-preserving techniques comprise any one of: differential privacy mechanisms with a privacy budget manager, k-anonymity enforcement, or ephemeral identifier expiration.

48. The computer-implemented method of claim 33, further comprising policy-constrained reinforcement learning computer-implemented steps, wherein said reinforcement learning computer-implemented steps comprise of any one of computer-implemented steps directed to: policy gradient methods operating within advertiser-defined optimization boundaries, Q-learning functionality with scoring parameters bounded by governance rules, or ensemble model updating through ensemble methods subject to regulatory compliance constraints.

49. The computer-implemented method of claim 40, wherein said distributed caching comprises multi-tier cache hierarchies with cache storage, log replication across availability zones, and tenant data stores.

50. The computer-implemented method of claim 35, wherein feedback signals through said feedback loop comprise any one of: BQS weighting factors adjustments, qualification thresholds calibration recommendations, or fraud detection sensitivity adjustments.

51. The computer-implemented method of claim 33, wherein said pre-spend qualification enforcement through said compliance gateway comprises graduated enforcement through a suppression controller, wherein said graduated enforcement comprises any one of: bid blocking, rate limiting, or value reduction.

52. A computer program product comprising a non-transitory computer readable medium having computer executable instructions stored therein to perform operations for closed-loop behavioral qualification and enforcement in digital advertising comprising executing, on at least one processor configured to perform a predefined set of basic operations in response to receiving a corresponding basic computer executable instruction selected from a predefined native instruction set of codes, computer readable program code for:
executing signature-based reconciliation through a reconciliation system;
computing qualified attribution scores through a QAS generator;
performing non-PII matching by correlating engagement events;
capturing engagement verification through beacons; and
enforcing pre-spend qualification through compliance gateway.

53. The computer program product of claim 52, wherein said computer program product further comprises computer readable program code for enabling any one or more of: engagement validation against pre-qualification requirements, advertising waste prevention before budget commitment, creation of immutable audit trail, maintenance of operational responsiveness while continuously improving qualification accuracy.

54. The computer program product of claim 53, further comprising computer readable program code for:
logging verified transactions through an immutable ledger;
detecting fraud through fraud enforcement architecture;
managing consent and privacy through consent module;
implementing asynchronous API processing;
optimizing data structure performance;
executing machine learning behavioral analysis; and
optimizing through closed-loop feedback system.

55. The computer program product of claim 54, wherein said verified transactions are logged through an immutable ledger by any one or a combination of: recording enforcement decisions in append-only logs, generating digital signatures through Ed25519 signing, creating tamper-evident chains through a Merkle tree builder with event chaining, exposing verification interfaces through a verification API.

56. The computer program product of claim 54, wherein said computer readable program code for fraud detection comprises of computer readable program code for any one or a combination of: aggregating behavioral signals from a behavioral analysis module, performing anomaly detection through a pattern recognizer, computing fraud probability scores, generating suppression signals through a suppression controller, executing multi-vector analysis through a fraud scoring engine wherein said analysis employs isolation forest, gradient boosting, and neural networks.

57. The computer program product of claim 54, wherein said computer readable program code for consent and privacy management comprises of computer readable program code for any one or a combination of: enforcing jurisdiction-specific policies through jurisdiction-specific logic, managing consent through opt-in flows and opt-out mechanisms, implementing consent-gated qualification through policy enforcement, executing cascade deletion processes.

58. The computer program product of claim 54, wherein said computer readable program code for API processing comprises of computer readable program code for any one or a combination of: API interaction sequence by exposing non-blocking endpoints through a qualification engine and beacon service, processing requests asynchronously, maintaining correlation identifiers, providing circuit breaker mechanisms.

59. The computer program product of claim 54, wherein said computer readable program code for data structure performance optimization comprises of computer readable program code for any one or a combination of: storing qualification state in tenant data stores, implementing distributed caching through weighted fair queuing, utilizing interval-tree structure for policy access, maintaining event buffers through event batching.

60. The computer program product of claim 54, wherein said computer readable program code for machine learning behavioral analysis comprises computer readable program code for any one or a combination of: analyzing reconciliation outcomes from reconciliation outputs to identify qualification errors within policy-defined tolerance thresholds, computing recalibration recommendations through a recalibration trigger subject to governance constraints, applying reinforcement learning through reinforcement updater and Q-learning bounded by advertiser-defined policy rules, updating fraud models through retraining constrained by regulatory compliance requirements.

61. The computer program product of claim 54, wherein said computer readable program code for closed-loop feedback system optimization comprises of computer readable program code for any one or a combination of: collecting verified outcome data from reconciliation outputs, computing performance metrics through model updates, generating parameter adjustments through a BQS Unity Optimizer, propagating updated parameters through model parameters.

62. The computer program product of claim 52, wherein said computer readable program code for signature-based reconciliation execution comprises of computer readable program code for one-way hash functions, wherein said one-way hash functions comprise any one of: SHA-256 hashing, SHA-3 algorithms, or BLAKE2 algorithms.

63. The computer program product of claim 52, wherein said computer readable program code for signature-based reconciliation execution comprises of computer readable program code for comparing generated behavioral fingerprints against cohort signatures using similarity metrics, wherein said similarity metrics comprise any one of: cosine distance, Jaccard index, Euclidean distance measurements, or weighted combinations thereof.

64. The computer program product of claim 52, wherein said computer readable program code for enforcing pre-spend qualification through compliance gateway comprises of computer readable program code for authorizing qualified requests through a token generator generating cryptographic authorization tokens, wherein said cryptographic authorization tokens comprise any one or a combination of: transaction hashes using SHA-256, digital signatures using Ed25519 signing, expiration timestamps.

65. The computer program product of claim 56, wherein said computer readable program code for executing multi-vector analysis comprises of computer readable program code for implementing ensemble methods which comprise of any one of or combinations of: isolation forest code, gradient boosting classifiers, neural network pattern recognizers.

66. The computer program product of claim 57, wherein said computer readable program code for privacy management comprise computer readable program code for any one of: differential privacy mechanisms with a privacy budget manager, k-anonymity enforcement, ephemeral identifier expiration.

67. The computer program product of claim 52, further comprising policy-constrained reinforcement learning computer readable program code, wherein said reinforcement learning code comprises code directed to any one of: policy gradient methods operating within advertiser-defined optimization boundaries, Q-learning functionality with scoring parameters bounded by governance rules, or ensemble model updating through ensemble methods subject to regulatory compliance constraints.

68. The computer program product of claim 59, wherein said computer readable program code for distributed caching comprises computer readable program code for multi-tier cache hierarchies with cache storage, log replication across availability zones, and tenant data stores.

69. The computer program product of claim 54, wherein said computer readable program code for feedback signals through said feedback loop comprises computer readable program code for any one of: BQS weighting factors adjustments, qualification thresholds calibration recommendations, or fraud detection sensitivity adjustments.

70. The computer program product of claim 52, wherein said computer readable program code for pre-spend qualification enforcement comprises computer readable program code for graduated enforcement through a suppression controller, wherein said graduated enforcement comprises any one of: bid blocking, rate limiting, or value reduction.
